(19) United States
(12) Patent Application Publication
(10) Pub. No.: US 2025/0277066 A1
(43) Pub. Date: Sep. 4, 2025

(54) Substituted Pyridine-2,6-Bis(Phenylenephenolate) Complexes with Enhanced Solubility that are Useful as Catalyst Components for Olefin Polymerization

(71) Applicant: ExxonMobil Chemical Patents Inc., Baytown, TX (US)

(72) Inventors: Irene C. Cai, Webster, TX (US); Jo Ann M. Canich, Houston, TX (US); Alexander Z. Voskoboynikov, Moscow (RU); Gregory J. Smith-Karahalis, Houston, TX (US); Hua Zhou, Missouri City, TX (US); Peijun Jiang, Katy, TX (US); Georgy P. Goryunov, Moscow (RU); Mikhail I. Sharikov, Moscow (RU); Andrei N. Iashin, Moscow (RU); Catherine A. Faler, Houston, TX (US); Dmitry V. Uborsky, Moscow (RU)

(21) Appl. No.: 18/862,695

(22) PCT Filed: Apr. 27, 2023
(86) PCT No.: PCT/US2023/066306

§ 371 Date: Nov. 4, 2024

Related U.S. Application Data
(60) Provisional application No. 63/338,167, filed on May 4, 2022.

(51) Int. Cl. C08F 4/64; C08F 210/02; C08F 210/06

(52) U.S. Cl. CPC C08F 4/64158; C08F 210/02; C08F 210/06

(57) ABSTRACT

The present disclosure relates to bis(aryl phenolate) Lewis base transition metal complexes, catalyst systems including bis(aryl phenolate) Lewis base transition metal complexes, and polymerization processes to produce polyolefin polymers such as polyethylene based polymers and polypropylene based polymers.

### CROSS REFERENCE TO RELATED APPLICATIONS

This application claims the benefit of and priority to U.S. Provisional Application No. 63/338,167 filed May 4, 2022, the disclosure of which is incorporated herein by reference.

### FIELD

The present disclosure relates to bis(aryl phenolate) Lewis base transition metal complexes, catalyst systems including bis(aryl phenolate) Lewis base transition metal complexes, and polymerization processes to produce polyolefin polymers such as polyethylene based polymers and polypropylene based polymers.

### BACKGROUND

Polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those using a Ziegler-Natta catalyst, a chromium based catalyst, or a metallocene catalyst.

Additionally, pre-catalysts (neutral, unactivated complexes) should be thermally stable at and above ambient temperature, as they are often stored for weeks before being used. The performance of a given catalyst is closely influenced by the reaction conditions, such as the monomer concentrations and temperature. For instance, the solution process, which benefits from being run at temperatures above 120° C., is particularly challenging for catalyst development. At such high reactor temperatures, it is often difficult to maintain high catalyst activity and high molecular weight capability as both attributes quite consistently decline with an increase of reactor temperature. With a wide range of polyolefin products desired, from high density polyethylene (HDPE) to elastomers (e.g., thermoplastic elastomers (TPE); ethylene-propylene-diene (EPDM)), many different catalyst systems may be needed, as it is unlikely that a single catalyst will be able to address all the needs for the production of these various polyolefin products. The strict set of requirements needed for the development and production of new polyolefin products makes the identification of suitable catalysts for a given product and production process a highly challenging endeavor.

Aromatic solvents are typically used to dissolve catalyst components in industrial olefin polymerization processes. However, typically it is challenging to replace aromatic solvents with non-aromatic solvents, such as isohexane, due to poor solubility of catalyst components in non-aromatic solvents.

Further information regarding the general state of the art for non-metallocene olefin polymerization catalysts can be found in Baier, M. C. (2014) “Post-Metallocenes in the Industrial Production of Poly-olefins,” Angew. Chem. Int. Ed., v. 53, pp. 9722-9744, the entire contents of which are hereby incorporated by reference.

Further information regarding complexes can be found in: Goryunov, G. P. et al. (2021) “Rigid Postmetallocene Catalysts for Propylene Polymerization: Ligand Design Prevents the Temperature-Dependent Loss of Stereo- and Regioselectivities,” ACS Catalysis, v. 11(13), pp. 8079-8086; US2020/0255556; US2020/0255555; US 2020/0254431; and US 2020/0255553, the entirety of each of which is hereby incorporated by reference.

### SUMMARY

A catalyst compound represented by Formula (I):

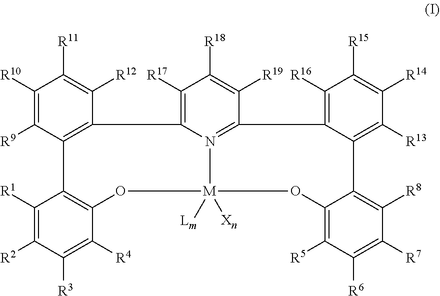

wherein:
M is a group 3, 4, or 5 metal;
L is a Lewis base;
X is an anionic ligand;
n is 1, 2, or 3;
m is 0, 1, or 2;
n+m is not greater than 4;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R¹⁵, and R¹⁶ is independently hydrogen, C₁-C₄₀ hydrocarbyl, C₁-C₄₀ substituted hydrocarbyl, a heteroatom or a heteroatom-containing group, or one or more of R¹³ and R⁴, R⁴ and R⁵, or R⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups are optionally joined together to form a bidentate Lewis base;
an X group are optionally joined to an L group to form a monoanionic bidentate group; and
any two X groups are optionally joined together to form a dianionic ligand group, with the proviso that at least one of R¹⁷, R¹⁸, and R¹⁹ contains at least two or more saturated or unsaturated carbon atoms.

A homogeneous solution, comprising: an aliphatic hydrocarbon solvent; and at least one complex of Formula (I), with a concentration of the complex being 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater).

A process for the production of a propylene based polymer comprising: polymerizing propylene by contacting the propylene with a catalyst system made from Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

A process for the production of an ethylene based polymer comprising: polymerizing ethylene by contacting the ethylene with the catalyst system made from Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

### DETAILED DESCRIPTION

Exemplary embodiments of the present technological advancement include pyridine-2,6-bis(phenylenephenolate) complexes that are useful as catalyst components for olefin polymerization and have improved solubility in non-aromatic hydrocarbons (e.g. isohexane). The improved solubility of these complexes was accomplished by the modification of the ligand framework at a specific position that led to improved solubility, but did not adversely affect the performance of the complex when used as a catalyst for olefin polymerizations.

For the purposes of the present disclosure, the numbering scheme for the Periodic Table Groups is used as described in Chemical and Engineering News, v. 63(5), pg. 27 (1985). Therefore, a “group 4 metal” is an element from group 4 of the Periodic Table, e.g., Hf, Ti, or Zr.

The following abbreviations may be used herein: Me is methyl, Et is ethyl, Ph is phenyl, tBu is tertiary butyl, MAO is methylalumoxane, NMR is nuclear magnetic resonance, t is time, s is second, h is hour, psi is pounds per square inch, psig is pounds per square inch gauge, equiv is equivalent, RPM is rotation per minute.

The specification describes transition metal complexes. The term complex is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization or oligomerization function using an activator which, without being bound by theory, is believed to create a cation as a result of the removal of an anionic group, often referred to as a leaving group, from the transition metal.

The terms “substituent,” “radical,” “group,” and “moiety” may be used interchangeably.

“Conversion” is the amount of monomer that is converted to polymer product, and is reported as mol % and is calculated based on the polymer yield and the amount of monomer fed into the reactor.

“Catalyst activity” is a measure of how active the catalyst is and is reported as the grams of product polymer (P) produced per millimole of catalyst (cat) used per hour (gP·mmolcat⁻¹·h⁻¹).

The term “heteroatom” refers to any group 13-17 element, excluding carbon. A heteroatom may include B, Si, Ge, Sn, N, P, As, O, S, Se, Te, F, Cl, Br, and I. The term “heteroatom” may include the aforementioned elements with hydrogens attached, such as BH, BH₂, SiH₂, OH, NH, NH₂, etc. The term “substituted heteroatom” describes a heteroatom that has one or more of these hydrogen atoms replaced by a hydrocarbyl or substituted hydrocarbyl group(s).

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

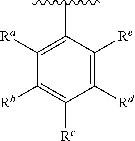

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is not H), or two or more of R^{a}, R^{b}, R^{c}, R^{d}, and R^{e} can be joined together to form a C₄-C₆₂ cyclic or polycyclic hydrocarbyl ring structure, or a combination thereof.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The term “substituted carbazole,” means a carbazolyl group having 1 or more hydrogen groups replaced by a hydrocarbyl, substituted hydrocarbyl, heteroatom or heteroatom containing group.

The term “substituted naphthyl,” means a naphthyl group having 1 or more hydrogen groups replaced by a hydrocarbyl, substituted hydrocarbyl, heteroatom or heteroatom containing group.

The term “substituted anthracenyl,” means an anthracenyl group having 1 or more hydrogen groups replaced by a hydrocarbyl, substituted hydrocarbyl, heteroatom or heteroatom containing group.

The term “substituted fluorenyl” means a fluorenyl group having 1 or more hydrogen groups replaced by a hydrocarbyl, substituted hydrocarbyl, heteroatom or heteroatom containing group.

The terms trihydrocarbylsilyl and trihydrocarbylgermyl means a silyl or germyl group bound to three hydrocarbyl groups. Examples of suitable trihydrocarbylsilyl and trihydrocarbylgermyl groups can include trimethylsilyl, trimethylgermyl, triethylsilyl, triethylgermyl, and all isomers of tripropylsilyl, tripropylgermyl, tributylsilyl, tributylgermyl, tripentylsilyl, tripentylgermyl, trihexylsilyl, butyldimethylsilyl, butyldimethygermyl, dimethyloctylsilyl, dimethyloctylgermyl, and the like.

The terms dihydrocarbylamino and dihydrocarbylphosphino mean a nitrogen or phosphorus group bonded to two hydrocarbyl groups, which may be optionally joined. Examples of suitable dihydrocarbylamino and dihydrocarbylphosphino groups can include dimethylamino, dimethylphosphino, diethylamino, N-pyrrolidinyl, diethylphosphino, and all isomers of dipropylamino, dipropylphosphino, dibutylamino, dibutylphosphino, and the like.

The term “substituted adamantanyl” means an adamantanyl group having 1 or more hydrogen groups replaced by a hydrocarbyl, substituted hydrocarbyl, heteroatom or heteroatom containing group.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl (also referred to as a hydrocarbyloxy group). The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxy.

The term “thiolate” means an alkyl or aryl group bound to a sulfur atom, such as an alkyl thioether or aryl thioether group/radical containing a sulfur atom and can include those where the alkyl/aryl group is a C₁ to C₁₀ hydrocarbyl (also referred to as a hydrocarbylthiolate group). The alkyl group may be straight chain, branched, or cyclic. The alkyl group may be saturated or unsaturated. Examples of suitable thiolate radicals can include methanethiolate, ethanethiolate, n-propanethiolate, iso-propanethiolate, n-butanethiolate, iso-butanethiolate, sec-butanethiolate, tert-butanethiolate, benzenethiolate.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

The terms “hydrocarbyl radical,” “hydrocarbyl group,” or “hydrocarbyl” may be used interchangeably and are defined to mean a group consisting of hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl) hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and aryl groups, such as phenyl, benzyl, and naphthyl.

The term “adamantyl” and “adamantanyl” may be used interchangeably.

Unless otherwise indicated, a “Cₘ-C_{y}” moiety refers to the corresponding moiety including carbon atoms at a total number thereof from m to y. Thus, examples of a “C₂-C₄₀ substituted hydrocarbyl”, without further specification, can include a C₁ hydrocarbyl group that is further substituted with one or more heteroatom-containing groups containing additional carbons (such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃), such that the resulting substituted hydrocarbyl moiety includes carbon atoms at a total number from 2 to 40.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

Unless otherwise indicated, as used herein, “high molecular weight” is defined as a number average molecular weight (Mn) value of 100,000 g/mol or more. “Low molecular weight” is defined as an Mn value of less than 100,000 g/mol.

Unless otherwise noted all melting points (Tm) are differential scanning calorimetry (DSC) second melt.

A “catalyst system” is a combination of at least one catalyst compound, at least one activator, an optional coactivator, and an optional support material. The terms “catalyst compound”, “catalyst complex”, “transition metal complex”, “transition metal compound”, “precatalyst compound”, and “precatalyst complex” are used interchangeably. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The transition metal compound may be neutral as in a precatalyst, or a charged species with a counter ion as in an activated catalyst system. For the purposes of the present disclosure and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. A “Lewis base” is a neutrally charged ligand which donates one or more pairs of electrons to a metal ion. Examples of Lewis bases include diethylether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, and furan. The bis(aryl phenolate) Lewis base ligands are tridentate ligands that bind to the metal via two anionic donors (phenolates) and one heterocyclic Lewis base donor (e.g., pyridinyl group). The bis(aryl phenolate)heterocycle ligands are tridentate ligands that bind to the metal via two anionic donors (phenolates) and one heterocyclic Lewis base donor.

The term “continuous” means a system that operates without interruption or cessation. For example a continuous process to produce a polymer would be one where the reactants are continually introduced into one or more reactors and polymer product is continually withdrawn.

### Transition Metal Complexes

In at least one embodiment, the catalyst compound represented by Formula (I) is as follows.

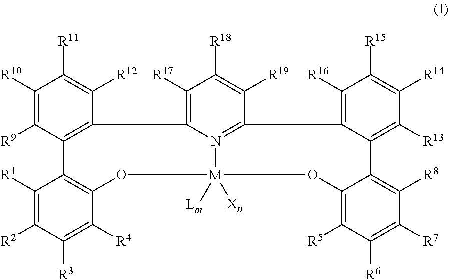

wherein:
M is a group 3, 4, or 5 metal;
L is a Lewis base;
X is an anionic ligand;
n is 1, 2, or 3;
m is 0, 1, or 2;
n+m is not greater than 4;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R, and R¹⁶ is independently hydrogen, C₁-C₄₀ hydrocarbyl, C₁-C₄₀ substituted hydrocarbyl, a heteroatom or a heteroatom-containing group, or one or more of R¹³ and R¹⁴, R¹⁴ and R¹⁵, or R¹⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups are optionally joined together to form a bidentate Lewis base;
an X group are optionally joined to an L group to form a monoanionic bidentate group; and
any two X groups are optionally joined together to form a dianionic ligand group, with the proviso that at least one of R¹⁷, R¹⁸, and R¹⁹ contains at least two or more saturated or unsaturated carbon atoms.

For example, M of Formula (I) can be a group 3, 4 or 5 metal, such as M can be a group 4 metal. Group 4 metals may include zirconium, titanium, and hafnium. In at least one embodiment, M is zirconium or hafnium.

Each L of Formula (I) can be independently selected from ethers, amines, phosphines, thioethers, esters, Et₂O, MeOtBu, Et₃N, PhNMe₂, MePh₂N, tetrahydrofuran, and dimethylsulfide, and each X can be independently selected from methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido. In at least one embodiment, n of Formula (I) is 2 and each X is independently chloro, benzyl or methyl.

Each of R¹, R², R³, R⁴, R⁵, R⁶, R⁷, R⁸ of Formula (I) can be independently selected from hydrogen, C₁-C₄₀ hydrocarbyl, C₁-C₄₀ substituted hydrocarbyl, hydrocarbyloxy, trihydrocarbylsilyl, trihydrocarbylgermyl, dihydrocarbylamino, dihydrocarbylphosphino, or halogen, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms.

For example, R⁴ and R⁵ of Formula (I) can be independently C₁-C₂₀ alkyl, such as R⁴ and R⁵ can be tert-butyl, or adamantanyl. In at least one embodiment, R⁴ and R⁵ are independently selected from unsubstituted phenyl, substituted phenyl, unsubstituted carbazole, substituted carbazole, unsubstituted naphthyl, substituted naphthyl, unsubstituted anthracenyl, substituted anthracenyl, unsubstituted fluorenyl, or substituted fluorenyl, a heteroatom or a heteroatom-containing group, such as R⁴ and R⁵ can be independently unsubstituted phenyl or 3,5-di-tert-butylbenzyl. Furthermore, either (1) R⁴ can be C₁-C₂₀ alkyl (e.g., R⁴ can be tert-butyl) and R⁵ can be an aryl, or (2) R⁵ can be C₁-C₂₀ alkyl (e.g., R⁵ can be tert-butyl) and R⁴ can be an aryl. Alternately, R⁴ and/or R⁵ can be independently a heteroatom, such as R⁴ and R⁵ can be a halogen atom (such as Br, Cl, F, or I). Alternately, R⁴ and/or R⁵ can be independently a silyl group, such as R⁴ and R⁵ can be a trialkylsilyl or triarylsilyl group, where the alkyl is a C₁ to C₃₀ alkyl (such methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl), hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and the aryl is a C₆ to C₃₀ aryl (such as phenyl, benzyl, and naphthyl). Usefully R⁴ and R⁵ can be triethylsilyl.

In some embodiments, each of R⁴ and R⁵ is independently a C₁-C₄₀ hydrocarbyl, a C₁-C₄₀ substituted hydrocarbyl, more preferably, each R⁴ and R⁵ is independently selected from a tertiary hydrocarbyl groups (such as tert-butyl, tert-pentyl, tert-hexyl, tert-heptyl, tert-octyl, tert-nonyl, tert-decyl, tert-undecyl, tert-dodecyl) and cyclic tertiary hydrocarbyl groups (such as such as 1-methylcyclohexyl, 1-norbornyl,1-adamantanyl, or substituted 1-adamantanyl).

In some embodiments, each of R⁴ and R⁵ is independently a C₁-C₄₀ hydrocarbyl, a C₁-C₄₀ substituted hydrocarbyl, more preferably, each of R⁴ and R⁵ is independently a non-aromatic cyclic alkyl group (such as cyclohexyl, cyclooctyl, cyclodecyl, cyclododecyl, adamantanyl, norbornyl, or 1-methylcyclohexyl, or substituted adamantanyl), most preferably a non-aromatic cyclic tertiary alkyl group (such as 1-methylcyclohexyl, 1-adamantanyl, substituted 1-adamantanyl, or 1-norbornyl). In some embodiments, R⁴ and R⁵ are admantanyl.

The identity of R⁴ and R⁵ can be used to control the molecular weight of the polymer products. For example, when one or both of R⁴ and R⁵ are tert-butyl, the catalyst compound may provide high molecular weight polymers. In contrast, when R⁴, R⁵, or R⁴ and R⁵ are phenyl, the catalyst compound may provide low molecular weight polymers.

In at least one embodiment, each of R² and R⁷ of Formula (I) is independently C₁-C₁₀ alkyl, such as R² and R⁷ are independently methyl, ethyl, propyl, butyl, pentyl, hexyl, heptyl, octyl, nonyl, decyl, dimethyl-pentyl, tert-butyl, isopropyl, or isomers thereof.

Each of R¹, R³, R⁶, R⁸, R⁹, R¹¹, R¹², R¹³, R¹⁵, R¹⁶, R¹⁷, R¹⁸, and R¹⁹ of Formula (I) can be independently hydrogen or C₁-C₁₀ alkyl, such as R¹, R³, R⁶, R⁸, R⁹, R¹¹, R¹², R¹³, R¹⁵, R¹⁶, R¹⁷, R¹⁸, and R¹⁹ can be independently hydrogen, methyl, ethyl, propyl, or isopropyl. In at least one embodiment, R¹, R³, R⁶, R⁸, R⁹, R¹¹, R¹², R¹³, R¹⁵ and R¹⁶ are hydrogen. Alternately, each of R¹, R³, R⁶, R⁸, R⁹, R¹¹, R¹², R¹³, R¹⁵, and R¹⁶ of Formula (I) can be independently hydrogen, phenyl, cyclohexyl, fluoro, chloro, methoxy, ethoxy, phenoxy, or trimethylsilyl.

In some embodiments, at least one of R¹⁷, R¹⁸, or R¹⁹ is a C₂-C₄₀ hydrocarbyl, C₂-C₄₀ substituted hydrocarbyl, or a C₂-C₄₀ heteroatom-containing group containing one or more heteroatoms.

In some embodiments, at least one of R¹⁷, R¹⁸, or R¹⁹ is independently a C₂-C₄₀ hydrocarbyl, C₂-C₄₀ substituted hydrocarbyl, or a C₂-C₄₀ heteroatom-containing group containing one or more heteroatoms, and at least one of R¹⁷, R¹⁸, or R¹⁹ is hydrogen.

In some embodiments, one of R¹⁷, R¹⁸, or R¹⁹ is a C₂-C₄₀ hydrocarbyl, C₂-C₄₀ substituted hydrocarbyl, or a C₂-C₄₀ heteroatom-containing group containing one or more heteroatoms, and two of R¹⁷, R¹⁸, or R¹⁹ are hydrogen.

In some embodiments, R¹⁸ is a C₂-C₄₀ hydrocarbyl, C₂-C₄₀ substituted hydrocarbyl, or a C₂-C₄₀ heteroatom-containing group containing one or more heteroatoms, and R¹⁷ and R¹⁹ are hydrogen.

In some embodiments, one of R¹⁷ or R¹⁹ is a C₂-C₄₀ hydrocarbyl, C₂-C₄₀ substituted hydrocarbyl, or a C₂-C₄₀ heteroatom-containing group containing one or more heteroatoms, R¹⁸ is hydrogen, and one of R¹⁷ or R¹⁹ is hydrogen.

In some embodiments, R¹⁷ and R¹⁹ are independently a C₂-C₄₀ hydrocarbyl, C₂-C₄₀ substituted hydrocarbyl, or a C₂-C₄₀ heteroatom-containing group containing one or more heteroatoms, and R¹⁸ is hydrogen.

In some embodiments, at least one of R¹⁷, R¹⁸, or R¹⁹ is a moiety that contains at least two or more saturated or unsaturated carbon atoms, such as a C₂-C₄₀ hydrocarbyl (such as ethyl, ethenyl, propyl (such as n-propyl, isopropyl, cyclopropyl), propenyl, propynyl, butyl (such as n-butyl, isobutyl, sec-butyl, tert-butyl, cyclobutyl), butenyl, butynyl, pentyl (such as iso-amyl, cyclopentyl), pentenyl, pentynyl, hexyl (such as cyclohexyl), hexenyl, hexynyl, heptyl, hepentyl, heptynyl, octyl (such as cyclooctyl), octenyl, octynyl, nonyl, nonenyl, nonynyl, decyl (such as adamantanyl), decenyl, decynyl, undecyl, undecenyl, undecynyl, dodecyl, dodecenyl, dodecynyl, tridecyl, tridecenyl, tridecynyl, tetradecyl, tetradecenyl, tetradecynyl, pentadecyl, pentadecenyl, pentadecynyl, hexadecyl, hexadecenyl, hexadecynyl, heptadecyl, heptadecenyl, heptadecynyl, octadecyl, octadecenyl, octadecynyl, nonadecyl, nonadecenyl, nonadecynyl, icosyl, henicosyl, docosyl, tricosyl, tetracosyl, pentacosyl, hexacosyl, heptacosyl, octacosyl, nonacosyl, tricontyl, and isomers thereof), C₂-C₄₀ substituted hydrocarbyl, or a C₂-C₄₀ heteroatom-containing group containing one or more heteroatoms (such as hydrocarbyloxy, trihydrocarbylsilyl, trihydrocarbylgermyl, dihydrocarbylamino, dihydrocarbylphosphino).

In some embodiments, at least one of R¹⁷, R¹⁸, and R¹⁹, containing at least two or more saturated or unsaturated carbon atoms, is a moiety that contains at least three or more non-hydrogen atoms, such as a C₃-C₄₀ hydrocarbyl (such as propyl (such as n-propyl, isopropyl, cyclopropyl), propenyl, propynyl, butyl (such as n-butyl, isobutyl, sec-butyl, tert-butyl, cyclobutyl), butenyl, butynyl, pentyl (such as iso-amyl, cyclopentyl), pentenyl, pentynyl, hexyl (such as cyclohexyl), hexenyl, hexynyl, heptyl, hepentyl, heptynyl, octyl (such as cyclooctyl), octenyl, octynyl, nonyl, nonenyl, nonynyl, decyl (such as adamantanyl), decenyl, decynyl, undecyl, undecenyl, undecynyl, dodecyl, dodecenyl, dodecynyl, tridecyl, tridecenyl, tridecynyl, tetradecyl, tetradecenyl, tetradecynyl, pentadecyl, pentadecenyl, pentadecynyl, hexadecyl, hexadecenyl, hexadecynyl, heptadecyl, heptadecenyl, heptadecynyl, octadecyl, octadecenyl, octadecynyl, nonadecyl, nonadecenyl, nonadecynyl, icosyl, henicosyl, docosyl, tricosyl, tetracosyl, pentacosyl, hexacosyl, heptacosyl, octacosyl, nonacosyl, tricontyl, and isomers thereof), C₂-C₄₀ substituted hydrocarbyl (such as hydrocarbylenetrihydrocarbylsilane, hydrocarbylenetrihydrocarbylgermane, (dihydrocarbylamino)hydrocarbylene, (dihydrocarbylphosphino)hydrocarbylene, (hydrocarbyloxy)hydrocarbylene, (hydrocarbylthio)hydrocarbylene), or a C₂-C₄₀ heteroatom-containing group containing one or more heteroatoms (such as hydrocarbyloxy, trihydrocarbylsilyl, trihydrocarbylgermyl, dihydrocarbylamino, dihydrocarbylphosphino).

In some embodiments, at least one of R¹⁷, R¹⁸, or R¹⁹ is a moiety that contains at least two or more saturated carbon atoms, such as propyl (such as n-propyl, isopropyl, cyclopropyl), butyl (such as n-butyl, isobutyl, sec-butyl, tert-butyl, cyclobutyl), pentyl (such as iso-amyl, cyclopentyl), hexyl (such as cyclohexyl), heptyl, octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, tricontyl, and isomers thereof).

In some embodiments, at least one of R¹⁷, R¹⁸, or R¹⁹ is a moiety that contains at least two or more partially unsaturated carbon atoms, such as propenyl (such as n-propenyl), butenyl (such as n-butenyl), pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, icosenyl, henicosenyl, docosenyl, tricosenyl, tetracosenyl, pentacosenyl, hexacosenyl, heptacosenyl, octacosenyl, nonacosenyl, tricontenyl, propynyl (such as n-propynyl), butynyl (such as n-butynyl), pentynyl, hexynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, icosynyl, henicosynyl, docosynyl, tricosynyl, tetracosynyl, pentacosynyl, hexacosynyl, heptacosynyl, octacosynyl, nonacosynyl, tricontynyl, butadienyl, pentadienyl, hexadienyl, heptadienyl, octadienyl, nonadienyl, decadienyl, undecadienyl, dodecdienyl, substituted phenyls (such as methylphenyl, ethylphenyl, propyphenyl, butylphenyl, pentylphenyl, hexylphenyl, heptylphenyl, octylphenyl, nonylphenyl, decyphenyl, undecylphenyl, and dodecylphenyl), and isomers thereof.

In some embodiments, at least one of R¹⁷, R¹⁸, or R¹⁹ is C₂-C₄₀ substituted hydrocarbyl including but not limited to hydrocarbylenetrihydrocarbylsilane (such as methylenetrimethylsilane, methylenetriethylsilane, methylenetripropylsilane, methylenetributylsilane, methylenetripentylsilane, methylenetrihexylsilane, methylenedimethylbutylsilane, ethylenetrimethylsilane, ethylenetriethylsilane, ethylenetripropylsilane, ethylenetributylsilane, ethylenetripentylsilane, ethylenetrihexylsilane, ethylenedimethylbutylsilane and isomers thereof), hydrocarbylenetrihydrocarbylgermane (such as methylenetrimethylgermane, methylenetriethylgermane, methylenetripropylgermane, methylenetributylgermane, methylenetripentylgermane, methylenetrihexylgermane, methylenedimethylbutylgermane, ethylenetrimethylgermane, ethylenetriethylgermane, ethylenetripropylgermane, ethylenetributylgermane, ethylenetripentylgermane, ethylenetrihexylgermane, ethylenedimethylbutylgermane, and isomers thereof), (dihydrocarbylamino)hydrocarbylene (such as (dimethylamino)methylene, (diethylamino)methylene, (dipropylamino)methylene, (dibutylamino)methylene, (dipentylamino)methylene, (dihexylamino)methylene, (diheptylamino)methylene, (dioctylamino)methylene, (dinonylamino)methylene, (didecylamino)methylene, (diundecylamino)methylene, (didodecylamino)methylene, (methyethylamino)methylene, (dimethylamino)ethylene, (diethylamino)ethylene, (dipropylamino)ethylene, (dibutylamino)ethylene, (dipentylamino)ethylene, (dihexylamino)ethylene, (diheptylamino)ethylene, (dioctylamino)ethylene, (dinonylamino)ethylene, (didecylamino)ethylene, (diundecylamino)ethylene, (didodecylamino)ethylene, (methyethylamino)ethylene, imidazolidin-1-yl, imidazole-1-yl, 1,5-diazabicyclo[3.2.1]octan-8-yl, and isomers thereof), (dihydrocarbylphosphino)hydrocarbylene (such as (dimethylphosphino)methylene, (diethylphosphino)methylene, (dipropylphosphino)methylene, (dibutylphosphino)methylene, (dipentyl)phosphinomethylene, (dihexylphosphino)methylene, (diheptylphosphino)methylene, (dioctyphosphino)methylene, (dinonylphosphino)methylene, (didecylphosphino)methylene, (diundecylphosphino)methylene, (didodecylphosphino)methylene, (dimethylphosphino)ethylene, (diethylphosphino)ethylene, (dipropylphosphino)ethylene, (dibutylphosphino)ethylene, (dipentyl)phosphinoethylene, (dihexylphosphino)ethylene, (diheptylphosphino)ethylene, (dioctyphosphino)ethylene, (dinonylphosphino)ethylene, (didecylphosphino)methylene, (diundecylphosphino)ethylene, (didodecylphosphino)ethylene, and isomers thereof), (hydrocarbyloxy)hydrocarbylene (such as methoxymethylene, ethoxymethylene, propoxymethylene, butoxymethylene, pentoxymethylene, hexoxymethylene, heptoxymethylene, octoxymethylene, nonoxymethylene, decoxymethylene, undecoxymethylene, dodecoxymethylene, methoxyethylene, ethoxyethylene, propoxyethylene, butoxyethylene, pentoxyethylene, hexoxyethylene, heptoxyethylene, octoxyethylene, nonoxyethylene, decoxyethylene, undecoxyethylene, dodecoxyethylene, (phenoxy)methylene, (tolyloxy)methylene, (ethylphenoxy)methylene, (propylphenoxy)methylene, (butylphenoxy)methylene, (pentylphenoxy)methylene, (hexylphenoxy)methylene), 2,6,7-trioxabicyclo[2.2.2]octan-1-yl, 4-methyl-2,6,7-trioxabicyclo[2.2.2]octan-1-yl and isomers thereof), (hydrocarbylthio)hydrocarbylene (such as (methylthio)methylene, (ethylthio)methylene, (propylthio)methylene, (butylthio)methylene, (pentylthio)methylene, (hexylthio)methylene, (heptylthio)methylene, (octylthio)methylene, (nonylthio)methylene, (decylthio)methylene, (dodeceylthio)methylene, (methylthio)ethylene, (ethylthio)ethylene, (propylthio)ethylene, (butylthio)ethylene, (pentylthio)ethylene, (hexylthio)ethylene, (heptylthio)ethylene, (octylthio)ethylene, (nonylthio)ethylene, (decylthio)ethylene, (dodeceylthio)ethylene, and isomers thereof).

In some embodiments, at least one of R¹⁷, R¹⁸, or R¹⁹ is a C₂-C₄₀ heteroatom-containing group containing one or more heteroatoms including but not limited to hydrocarbyloxy (such as ethoxy, propoxy, butoxy, pentoxy, hexoxy, heptoxy, octoxy, nonoxy, decoxy, undecoxy, dodecoxy, phenoxy and substituted phenoxy such as phenoxy-4-(2,4,4-trimethylpentan-2-yl), and (1R,2S,5R)-2-isopropyl-5-methylcyclohexan-1-oxy and isomers thereof), hydrocarbylthio (such as ethylthio, propylthio, butylthio, pentylthio, hexylthio, heptylthio, octylthio, nonylthio, decylthio, undecylthio, dodeceylthio, phenylthio, substituted phenylthio and isomers thereof), trihydrocarbylsilyl (such as trimethylsilyl, triethylsilyl, tripropylsilyl, tributylsilyl, trihexylsilyl, triheptylsilyl, trioctylsilyl, trinonylsilyls, tridecylsilyl, dimethyloctylsilyl, butyldimethylsilyl (including tert-butyldimethylsilyl, n-butyldimethylsilyl) and isomers thereof), trihydrocarbylgermyl (such as trimethylgermyl, triethylgermyl, tripropylgermyl, tributylgermyl, trihexylgermyl, triheptylgermyl, trioctylgermyl, trinonylgermyl, tridecylgermyl, dimethyloctylgermyl, butyldimethylgermyl and isomers thereof), dihydrocarbylamino (such as dimethylamino, diethylamino, dipropylamino, dibutylamino, dipentylamino, dihexylamino, methylethylamino, pyrrolidinyl, piperidinyl and isomers thereof), and dihydrocarbylphosphino (such as dimethylphosphino, diethylphosphino, dipropylphosphino, dibutylphosphino, dipentylphosphino, dihexylphosphino, methylethylphosphino, phospholanyl, phosphinanyl and isomers thereof).

In some embodiments of Formula (I), R⁴ and R⁵ can be adamantanyl or substituted adamantanyl, R² and R⁷ can be C₁-C₂₀ hydrocarbyl, and R¹, R³, R⁶, R⁸, R⁹, R¹¹, R¹², R¹³, R¹⁵, R¹⁶, R¹⁷ and R¹⁹ are hydrogen, and R¹⁸ is a C₂-C₄₀ hydrocarbyl, C₂-C₄₀ substituted hydrocarbyl, or a C₂-C₄₀ heteroatom-containing group containing one or more heteroatoms.

In some embodiments of Formula (I), R⁴ and R⁵ can be adamantanyl or substituted adamantanyl, R² and R⁷ can be C₁-C₂₀ hydrocarbyl, and R¹, R³, R⁶, R⁸, R⁹, R¹¹, R¹², R¹³, R¹⁵, R¹⁶, and R¹⁸ are hydrogen, and one of R¹⁸ and R¹⁹ is a C₂-C₄₀ hydrocarbyl, C₂-C₄₀ substituted hydrocarbyl, or a C₂-C₄₀ heteroatom-containing group containing one or more heteroatoms, and the other of R¹⁸ and R¹⁹ is hydrogen.

In some embodiments of Formula (I), R⁴ and R⁵ can be adamantanyl or substituted adamantanyl, R² and R⁷ can be C₁-C₂₀ hydrocarbyl, and R¹, R³, R⁶, R⁸, R⁹, R¹¹, R¹², R¹³, R¹⁵, R¹⁶, and R¹⁸ are hydrogen, and R¹⁸ and R¹⁹ are independently a C₂-C₄₀ hydrocarbyl, C₂-C₄₀ substituted hydrocarbyl, or a C₂-C₄₀ heteroatom-containing group containing one or more heteroatoms.

In some embodiments, R¹⁸ is a C₂-C₄₀ hydrocarbyl, C₂-C₄₀ substituted hydrocarbyl, or a C₂-C₄₀ heteroatom-containing group containing one or more heteroatoms.

In some embodiments, R¹⁸ contains a linear chain that is at least three non-hydrogen atoms in length and terminally bound to pyridine.

In some embodiments, R¹⁷ is a C₂-C₄₀ hydrocarbyl, C₂-C₄₀ substituted hydrocarbyl, or a C₂-C₄₀ heteroatom-containing group containing one or more heteroatoms.

In some embodiments, R¹⁷ contains a linear chain that is at least three non-hydrogen atoms in length and terminally bound to pyridine.

In some embodiments, R¹⁹ is a C₂-C₄₀ hydrocarbyl, C₂-C₄₀ substituted hydrocarbyl, or a C₂-C₄₀ heteroatom-containing group containing one or more heteroatoms.

In some embodiments, R¹⁹ contains a linear chain that is at least three non-hydrogen atoms in length and terminally bound to pyridine.

In some embodiments, R¹⁸ is not methyl, methoxy, or trifluoromethyl.

In at least one embodiment, the catalyst compound is one or more of:

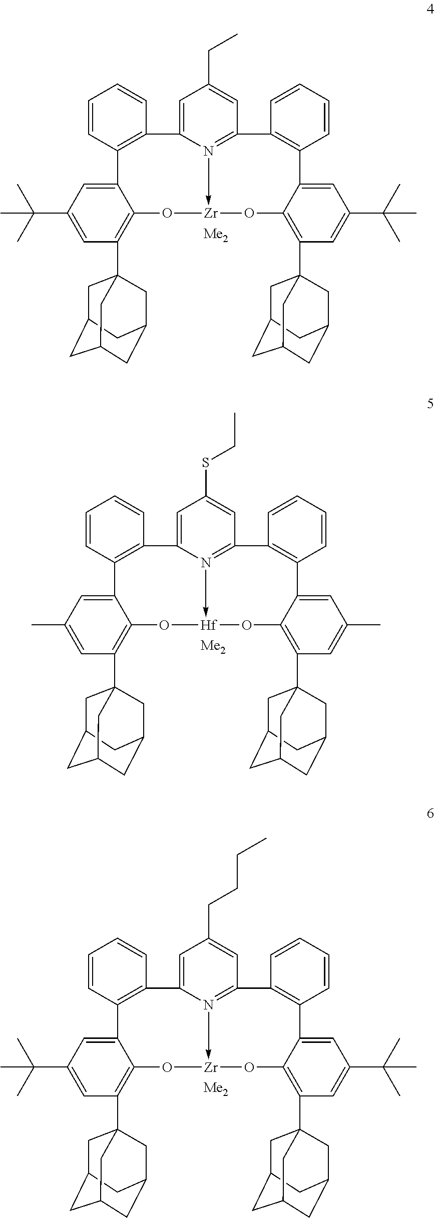

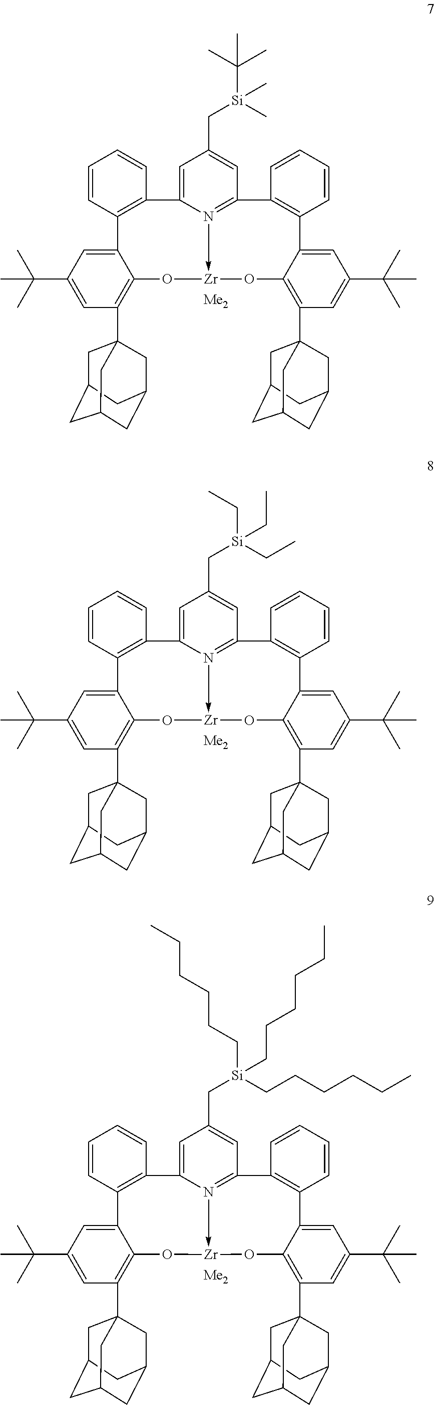

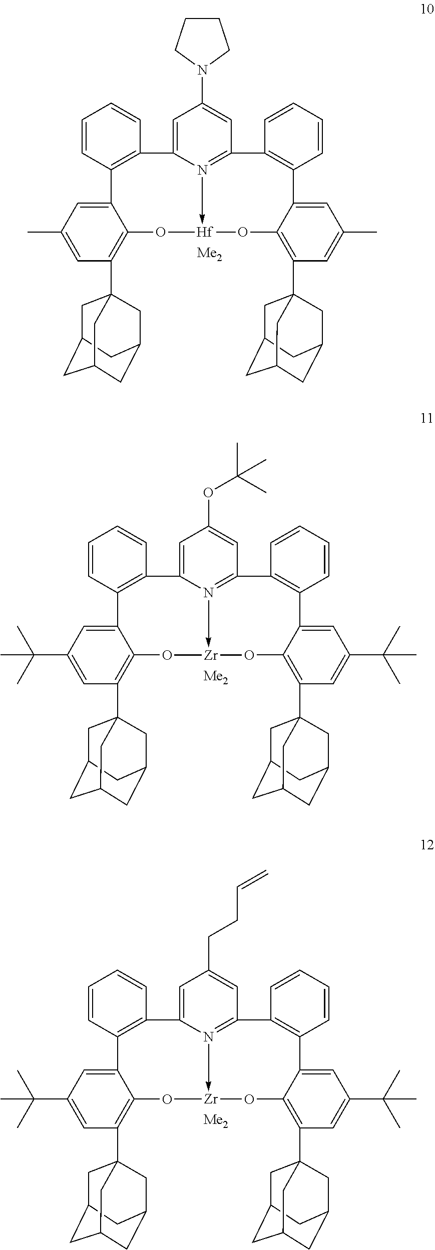

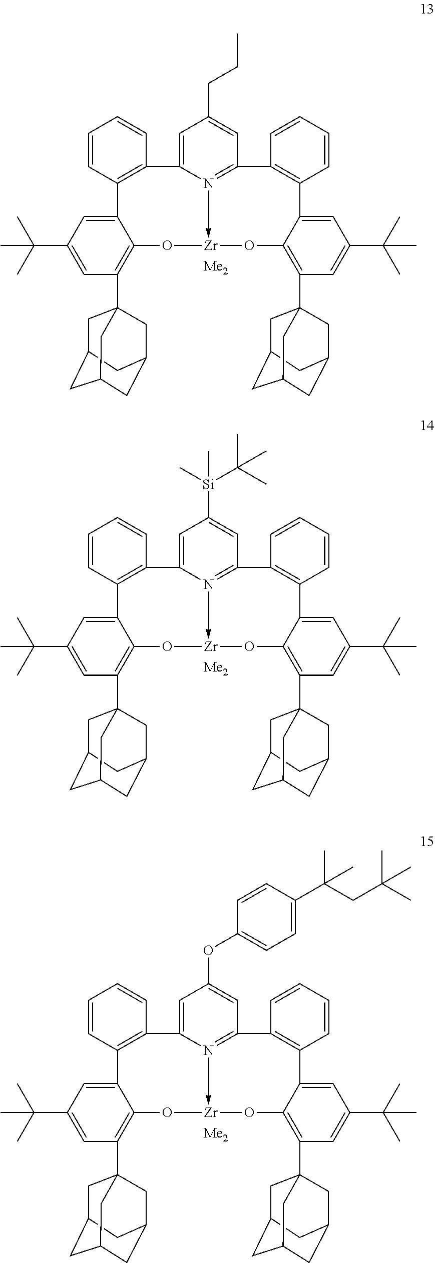

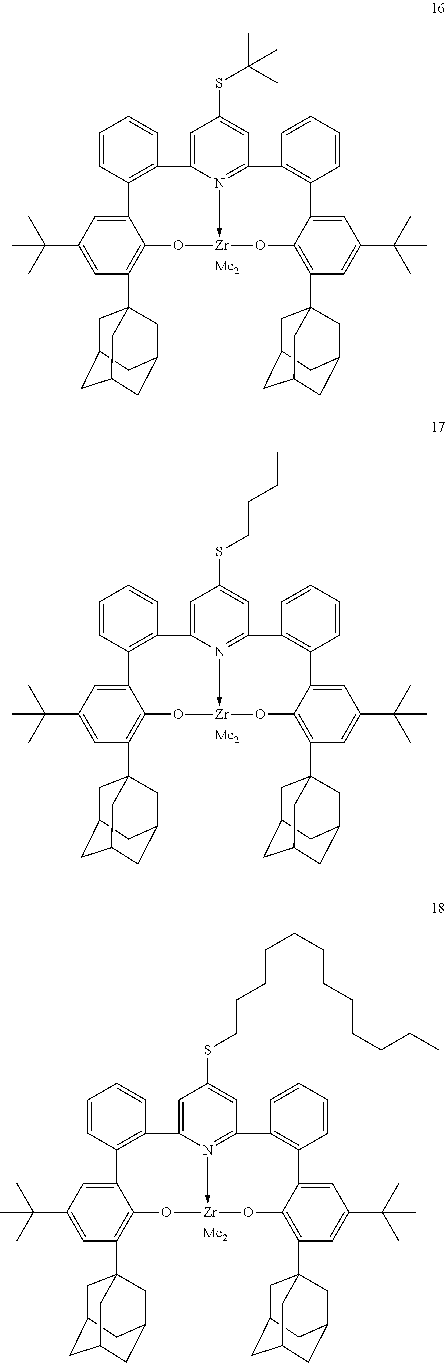

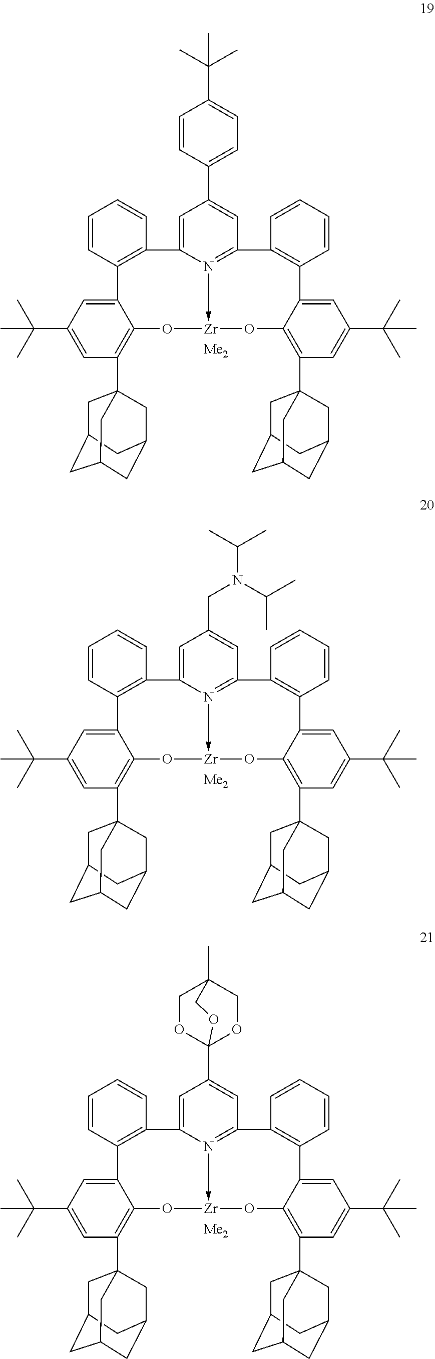

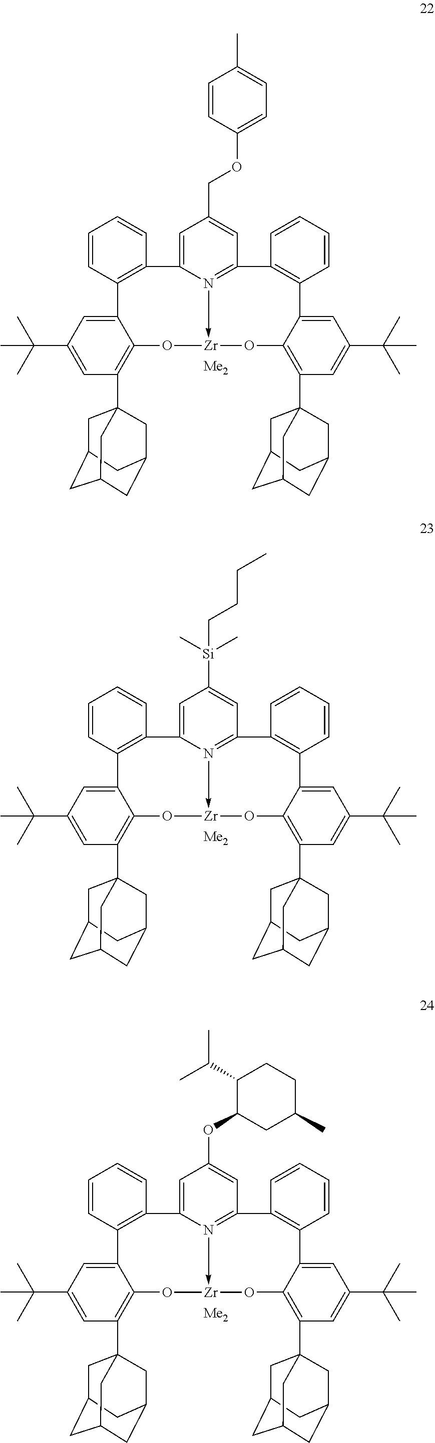

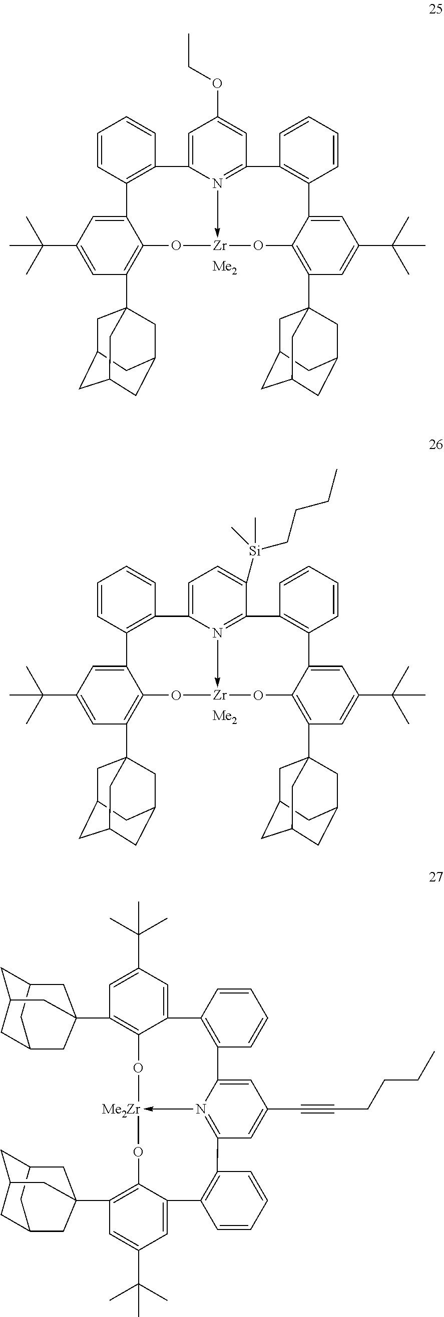

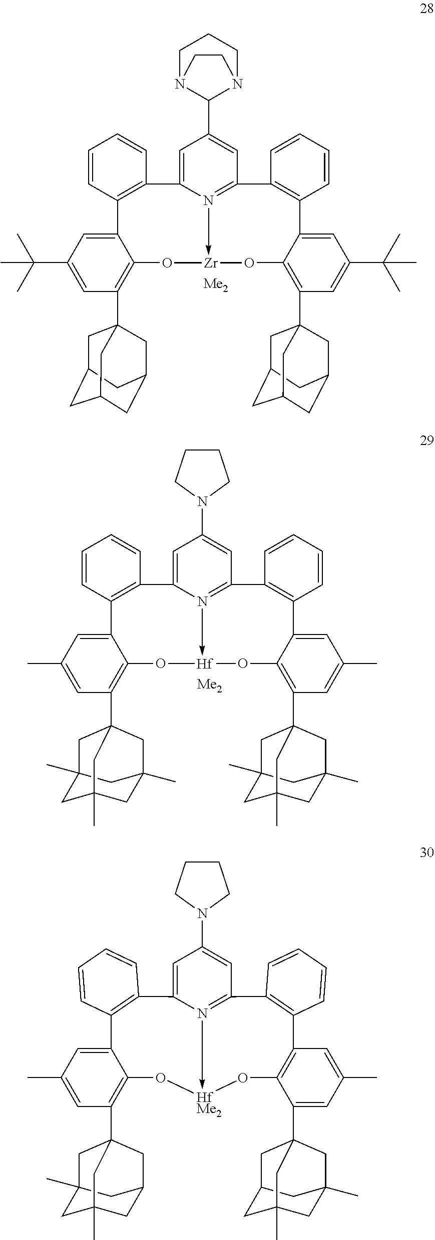

In at least one embodiment, one or more different catalyst compounds are present in a catalyst system. One or more different catalyst compounds can be present in the reaction zone where the process(es) described herein occur. The same activator can be used for the transition metal compounds, however, two different activators, such as a non-coordinating anion activator and an alumoxane, can be used in combination.

Further exemplary embodiments of the present technological advancement include the following. Composition of Formula (I), with R⁴ and R⁵ being adamantanyl, and R¹⁸ being a C₂-C₄₀ hydrocarbyl, C₂-C₄₀ substituted hydrocarbyl, or a C₂-C₄₀ heteroatom-containing group containing one or more heteroatoms. Composition of Formula (I), with R⁴ and R⁵ being adamantanyl, and R¹⁸ containing a linear chain that is at least three non-hydrogen atoms in length and terminally bound to pyridine. Composition of Formula (I), with R⁴ and R⁵ being adamantanyl, and R¹⁸ containing a silyl or germyl group of the formula A(R^{a})(R^{b})(R^{c}), where A is Si or Ge and each of R^{a}, R^{b}, and R^{c} is independently C₁-C₄₀ hydrocarbyl or C₁-C₄₀ substituted hydrocarbyl, or one or more of R^{a} and R^{b}, R^{a} and R^{c}, or R^{b} and R^{c} may be joined to form one or more substituted hydrocarbyl rings or unsubstituted hydrocarbyl rings.

Exemplary embodiments of the present technological advancement can also be homogeneous solutions that include an aliphatic hydrocarbon solvent and complexes of Formula (I), with a concentration of the complex 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater). Without intending to be bound by theory, it is believed that the presence of at least two or more saturated or unsaturated carbon atoms in at least one of R¹⁷, R¹⁸, and R¹⁹, alone or in combination with the R⁴ and R⁵ substituents and/or R² and R⁷ substituents, aids in the solubility of complexes of Formula (I) in aliphatic solvents.

Another exemplary embodiment of the present technological advancement includes a process for the production of a propylene based polymer comprising: polymerizing propylene and one or more optional C₃-C₄₀ olefins by contacting the propylene and the one or more optional C₃-C₄₀ olefins with a catalyst system including a composition of Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

Another exemplary embodiment of the present technological advancement includes a process for the production of an ethylene based polymer comprising: polymerizing ethylene and one or more optional C₄-C₄₀ olefins by contacting ethylene and the one or more optional C₄-C₄₀ olefins with a catalyst system including a composition of Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene or ethylene based polymer.

### Methods to Prepare the Transition Metal Complexes

U.S. patent application Ser. No. 16/787,909 (publication number US 2020/255553) describes general methods to prepare bis(phenolate) ligands and bis(phenolate) complexes useable with the present technological advancement.

### Synthesis of Substituted Pyridine Precursors

Preparation of substituted pyridine precursors may include, but are not limited to, methods shown in Scheme 1. Such substituted pyridine precursors may be subsequently used in methods to prepare bis(phenolate) ligands as described in U.S. patent application Ser. No. 16/787,909 (publication number US 2020/255553).

The formation of compound B (method 1) may be accomplished by deprotonation of compound A with a strong base such as lithium diisopropyl amide (LDA), followed by addition of a primary or secondary alkyl halide (R—X).

The formation of compound D or E (method 2) may be accomplished by the addition of M-OR′ or M-SR′, respectively, to compound C, wherein M′ is a group 1 element such as Na and R′ is a hydrocarbyl.

The formation of compound G (method 3) may be accomplished by the addition of Turbo Grinard (such as isopropylmagnesium chloride lithium chloride complex), followed by the addition of trihydrocarbylsilyl halide (R*₃Si—X).

The formation of compound I (method 4), wherein “aryl” refers to a substituted aryl moiety, by the coupling of compound G with a substituted aryl lithium compound (“aryl lithium”), may be accomplished by known Pd-catalyzed couplings, such as Negishi couplings.

The formation of compound J (method 5) may be accomplished by the addition of a nucleophile (such as diisopropylamide, substituted aryloxide) to compound I.

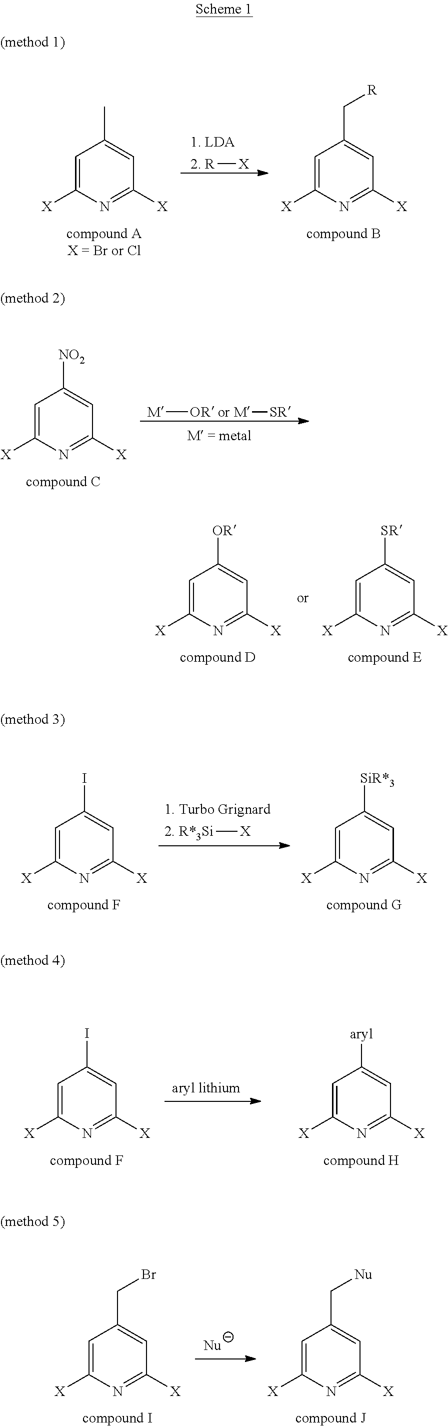

### Activators, and Optional Scavengers, Co-Activators, and Chain Transfer Agents

U.S. patent application Ser. No. 16/788,088 (publication number US 2020/254431) describes activators, optional scavengers, optional co-activators, and optional chain transfer agents useable with the present technological advancement. Particularly useful activators are also described in PCT Application number US2020/044865 (publication number WO2021/086467), U.S. patent application Ser. No. 16/394,174 (published as US2019/0330394) and PCT Application number US2019/029056 (published as WO2019/210026) describing non-aromatic-hydrocarbon soluble activator compounds such as N-methyl-4-nonadecyl-N-octadecylanilinium [tetrakis(pentafluorophenyl)borate], N-methyl-4-nonadecyl-N-octadecylanilinium [tetrakis(heptafluoronaphthalenyl)borate], N-methyl-N-octadecyl-4-(octadecyloxy)anilinium [tetrakis(pentafluorophenyl)borate)], N-methyl-N-octadecyl-4-(octadecyloxy)anilinium [tetrakis(heptafluoronaphthalenyl) borate], N,N-di(hydrogenated tallow)methylammonium [tetrakis(pentafluorophenyl)borate], N,N-di(hydrogenated tallow)methylammonium [tetrakis(heptafluoronaphthalenyl)borate], N,N-di(octadecyl)methylammonium [tetrakis(pentafluorophenyl)borate], N,N-di(octadecyl)methylammonium [tetrakis(heptafluoronaphthalenyl)borate], N,N-di(hexadecyl)methylammonium [tetrakis(pentafluorophenyl)borate], N,N-di(hexadecyl)methylammonium [tetrakis(heptafluoronaphthalenyl)borate], N-octadecyl-N-hexadecylmethylammonium [tetrakis(pentafluorophenyl)borate], and N-octadecyl-N-hexadecylmethylammonium [tetrakis(heptafluoronaphthalenyl)borate].

While it is preferred to use an activator that is soluble in a non-aromatic hydrocarbon solvent, activators that are poorly soluble or not soluble in non-aromatic hydrocarbon solvents can be used. When used, these activators can be fed into the reactor via a slurry or as a solid. Particularly useful activators in this class include triphenylcarbenium tetrakis(pentafluorophenyl)borate, triphenylcarbenium tetrakis(perfluoronaphthyl)borate, N,N-dimethylanilinium tetrakis(pentafluorophenyl)borate, N,N-dimethylanilinium tetrakis(perfluoronaphthyl)borate, and the like.

The typical activator-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 1:10.

Particularly useful optional scavengers or co-activators or chain transfer agents include, for example tri-alkyl aluminum such as triisobutylaluminum, tri-n-hexylaluminum, tri-n-octylaluminum, and dialkyl zinc, such as diethyl zinc. Additionally, toluene-free hydrocarbon soluble alumoxanes and modified alumoxanes, including trimethylaluminum “free” alumoxanes can or may be used.

Moreover, those of ordinary skill in the art are capable of selecting a suitable known activator(s) and optional scavengers or co-activators or chain transfer agents for their particular purpose without undue experimentation. Combinations of multiple activators may be used. Similarly, combinations of multiple optional scavengers or co-activators or chain transfer agents may be used.

### Solvents

While it is possible to use the catalyst components of the present technological advancement with an aromatic solvent, such as toluene, preferably they are absent when using the catalysts components in a polymerization process. Solvents useful for solubilizing the catalyst compound, the activator compound, or for combining the catalyst compound and activator, and/or for introducing the catalyst system or any component thereof into the reactor, and/or for use in the polymerization process include, but are not limited to, aliphatic hydrocarbon solvents, such as butanes, pentanes, hexanes, heptanes, octanes, nonanes, decanes, undecanes, dodecanes, tridecanes, tetradecanes, pentadecanes, hexadecanes, or a combination thereof; preferable solvents can include normal paraffins (such as Norpar™ solvents available from ExxonMobil Chemical Company in Houston, TX), isoparaffin solvents (such as Isoparrvi solvents available from ExxonMobil Chemical Company in Houston, TX), non-aromatic cyclic solvents (such as Nappar, N solvents available from ExxonMobil Chemical Company in Houston, TX) and combinations thereof.

Preferably the aliphatic hydrocarbon solvent is selected from C₄ to C₁₀ linear, branched or cyclic alkanes, alternatively from C₅ to C₈ linear, branched or cyclic alkanes.

Preferably the aliphatic hydrocarbon solvent is essentially free of all aromatic solvents. Preferably the solvent is essentially free of toluene. Free of all aromatic solvents, such as toluene, means that the solvent is essentially free of aromatic solvents (e.g., present at zero mol %, alternately present at less than 1 mol %, preferably the polymerization reaction and/or the polymer produced are free of “detectable aromatic hydrocarbon solvent,” such as toluene.

Preferred aliphatic hydrocarbon solvents include isohexane, cyclohexane, methylcyclohexane, pentane, isopentane, heptane, and combinations thereof, in addition to commercially available solvent mixtures such as Nappar6™, and IsoparE™. However, those of ordinary skill in the art can select other suitable non-aromatic hydrocarbon solvents without undue experimentation.

Highly preferred aliphatic hydrocarbon solvents include isohexane, methylcyclohexane, and commercially available solvent mixtures such as Nappar6™, and IsoparE™.

For compound solubility testing, preferred solvents include isohexane and methylcyclohexane.

### Optional Support Materials

In embodiments herein, the catalyst system may include an inert support material. The supported material can be a porous support material, for example, talc, and inorganic oxides. U.S. patent application Ser. No. 16/788,088 (publication number US 2020/0254431) describes optional support materials useable with the present technological advancement. Moreover, those of ordinary skill in the art are capable of selecting a suitable known support for their particular purpose without undue experimentation.

### Polymerization Processes

The present disclosure relates to polymerization processes where monomer (e.g., ethylene; propylene), and optionally one or more comonomer (such as C₂ to C₂₀ alpha olefins, C₄ to C₄₀ cyclic olefins, C₅ to C₂₀ non-conjugated dienes) are contacted with a catalyst system including an activator and at least one catalyst compound, as described above. The catalyst compound and activator may be combined in any order. The catalyst compound and activator may be combined prior to contacting with the monomer. Alternatively, the catalyst compound and activator may be introduced into the polymerization reactor separately, wherein they subsequently react to form the active catalyst.

U.S. patent application Ser. No. 16/788,088 (publication number US 2020/0254431) describes monomers useable with the present technological advancement and describes polymerization processes useable with the present technological advancement.

Additionally, catalysts that are highly soluble in aliphatic hydrocarbon solvents maybe used as trim catalysts in well-known polymerization processes as described for example in WO2015/123177 and WO2020/092587.

### Blends and Films

Polymers made with the present technological advancement can be used to make blends and films as described in U.S. patent application Ser. No. 16/788,088 (publication number US 2020/0254431), without undue experimentation.

### EXAMPLES

### General Considerations for Synthesis

The following chemicals may be abbreviated as indicated in either lower case or capital letters: 1,2-dimethoxyethane (dme), ethyl ether (ether), tetrahydrofuran (thf), diatomaceous earth (Celite), methylcyclohexane (MeCy), 1,4-dioxane (dioxane), hexamethyldisiloxane (hmdso), N,N-dimethylformamide (DMF), N-bromosuccinimide (NBS), n-butyl lithium (BuLi). Room temperature is 23° C. unless otherwise noted.

Complexes 1, 2, and 3 (shown below) are comparative complexes. The following chemicals may be abbreviated as indicated in either lower case or capital letters: 1,2-dimethoxyethane (dme), ethyl ether (ether), tetrahydrofuran (thf), diatomaceous earth (Celite), methylcyclohexane (MeCy), 1,4-dioxane (dioxane), hexamethyldisiloxane (hmdso).

Complexes 1 (dimethylzirconium[2′,2′″-(pyridine-2,6-diyl)bis(3-adamantan-1-yl)-5-methyl-[1,1′-biphenyl]-2-olate)]) and 2 (dimethylzirconium[2′,2′″-(pyridine-2,6-diyl)bis(3-adamantan-1-yl)-5-(tert-butyl)-[1,1′-biphenyl]-2-olate)]) were prepared as described in US patent application US 2020/0255553 A1.

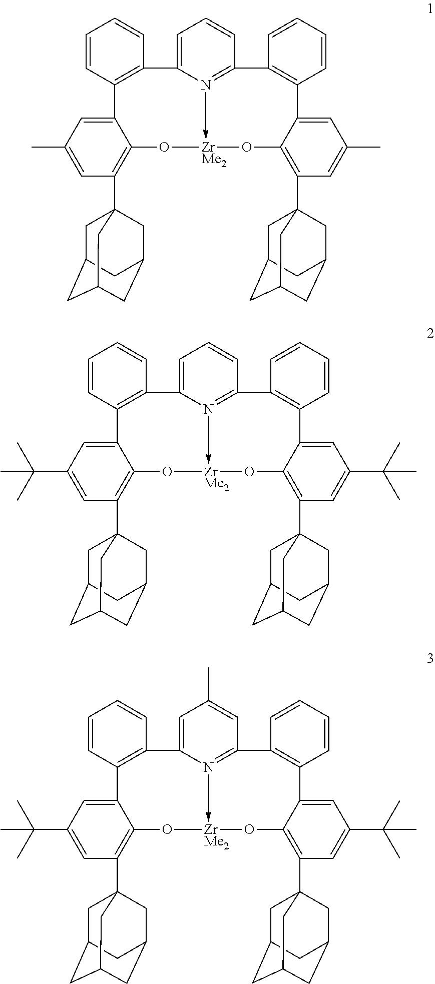

All reagents were purchased from commercial vendors (Sigma Aldrich, Fisher Scientific, Oakwood Chemical or Combi-Blocks) and used as received unless otherwise noted. Solvents were sparged with N₂ and dried over 3 Å molecular sieves. Lithium diisopropylamide (LDA) was prepared as described in Org. Synth. 1986, v. 64, 68. 2,6-Dibromo-4-nitropyridine and 2,6-dibromo-4-(pyrrolidin-1-yl)pyridine were prepared as described in [Organic Letters, 2010, v. 12(22), p. 5242-5245]. All chemical manipulations were performed in a nitrogen environment unless otherwise stated. Flash column chromatography was carried out with Sigma Aldrich silica gel 60 Å (70 Mesh-230 Mesh) using solvent systems specified. All anhydrous solvents were purchased from Fisher Chemical and were degassed and dried over molecular sieves prior to use. Deutrated solvents were purchased from Cambridge Isotope Laboratories and were degassed and dried over molecular sieves prior to use. ¹H NMR spectroscopic data were acquired at 250 MHz, 400 MHz, or 500 MHz using solutions prepared by dissolving approximately 10 mg of a sample in either C₆D₆, CD₂Cl₂, CDCl₃, D₈-toluene, or other deuterated solvent. The chemical shifts (6) presented are relative to the residual protium in the deuterated solvent at 7.15 ppm, 5.32 ppm, 7.24 ppm, and 2.09 ppm for C₆D₆, CD₂Cl₂, CDCl₃, D₈-toluene, respectively.

### Preparation of Catalyst Precursors and Ligands

ZrCl₄(ether)₂. Dichloromethane (100 mL) and ZrCl₄ (10.0 g, 42.9 mmol) were combined to form a slurry. Ether (9.54 g, 129 mmol) was added dropwise over 60 minutes. The mixture was stirred for 1 hour. The undissolved solids were allowed to settle, then the supernatant was decanted and filtered through Celite on a fritted disk. The filtrate was evaporated to near dryness to afford a slurry. Isohexane (60 mL) was added to the slurry and the mixture was stirred thoroughly. The resulting off-white solid was collected on a frit, washed with isohexane, and dried under reduced pressure. Yield: 12.5 g, 76.6%.

### 2-(2-(1-adamantanyl)-4-tert-butylphenoxy)tetrahydro-2H-pyran

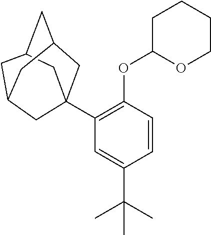 [SMILES: CC(C)(C)c1ccc(OC2CCCCO2)c(C23CC4CC(CC(C4)C2)C3)c1]

To a solution of 2-(1-adamantanyl)-4-(tert-butyl)phenol (38.0 g, 133 mmol) and 3,4-dihydro-2H-pyran (22.5 g, 267 mmol) in dichloromethane (300 mL) at −10° C., p-toluenesulfonic acid monohydrate (203 mg, 1.07 mmol) was added. The reaction mixture was slowly warmed to ambient temperature and stirred, while monitoring the reaction by thin layer chromatography (TLC). Upon full conversion of the starting material (indicated by TLC, approximately 5 minute at ambient temperature), sodium tert-butoxide (128 mg, 1.33 mmol) was added immediately. The resulting mixture was filtered through a silica gel plug, which was then washed with a 1:1 dichloromethane:hexane solution. The combined filtrate was concentrated to afford the product as a white solid (46.30 g, 94%). ¹H NMR (400 MHz, CDCl₃) δ 7.26 (s, 1H), 7.17-7.08 (m, 2H), 5.46 (s, 1H), 3.92 (t, J=10.8 Hz, 1H), 3.65 (d, J=11.8 Hz, 1H), 2.28-2.00 (m, 10H), 1.99-1.84 (m, 2H), 1.84-1.56 (m, 9H), 1.30 (s, 9H).

### (3-(1-adamantanyl)-5-(tert-butyl)-2-((tetrahydro-2H-pyran-2-yl)oxy)phenyl)lithium Etherate

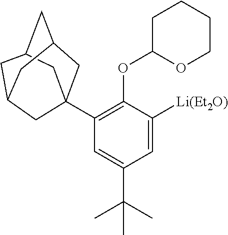

To a solution of 2-(2-(1-adamantanyl)-4-tert-butylphenoxy)tetrahydro-2H-pyran (46.3 g, 126 mmol) in diethyl ether (100 mL) at ambient temperature, n-butyllithium in hexanes (1.6 M, 82.4 mL, 132 mmol) was added. The solution was stirred for 1 hour, then concentrated to dryness. The crude product was slurried into pentane (30 mL) and stirred for 30 minutes. The product was isolated by filtration as a white solid (40.0 g, 71%). ¹H NMR (400 MHz, THF-d₈) δ 7.73 (s, 1H), 6.86 (s, 1H), 6.59 (br, 1H), 3.91 (t, J=11.7 Hz, 1H), 3.55-3.43 (m, 1H), 2.27 (q, J=12.4 Hz, 7H), 2.04 (d, J=18.1 Hz, 5H), 1.80 (td, J=23.8, 13.1 Hz, 9H), 1.32 (s, 9H).

### 2-((3-(1-adamantanyl)-2′-bromo-5-(tert-butyl)-[1,1′-biphenyl]-2-yl)oxy)tetrahydro-2H-pyran

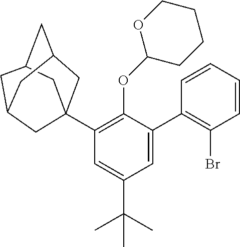 [SMILES: CC(C)(C)c1cc(-c2ccccc2Br)c(OC2CCCCO2)c(C23CC4CC(CC(C4)C2)C3)c1]

(3-(1-adamantanyl)-5-(tert-butyl)-2-((tetrahydro-2H-pyran-2-yl)oxy)phenyl)lithium etherate (20.1 g, 44.8 mmol) was dissolved in THF (100 mL) and hexanes (100 mL). To the resulting solution at 60° C., 2-bromochlorobenzene (9.44 g, 49.4 mmol) in hexane (50 mL) was added dropwise. The reaction was stirred for 1 hour at 60° C. After allowing the reaction to cool to room temperature, water (100 mL) was added and the resulting mixture was stirred for 10 minutes. After separating the two phases, the aqueous phase was extracted with diethyl ether. The combined organic extracts were dried over MgSO₄, then concentrated under vacuum. The product was then precipitated from a minimal amount of pentane as a white solid, which was collected by filtration. Additional product remaining in the filtrate was purified by flash chromatography on silica gel (30% dichloromethane in hexane). The combined yield was 87% (20.5 g). ¹H NMR (400 MHz, CDCl₃) δ 7.68 (dd, J=30.1, 8.0 Hz, 1H), 7.53-7.13 (m, 4H), 7.01 (dd, J=59.7, 2.3 Hz, 1H), 4.31 (dd, J=8.1, 2.3 Hz, 1H), 3.79 (dd, J=39.7, 12.0 Hz, 1H), 2.99 (dt, J=97.6, 11.2 Hz, 1H), 2.26 (dt, J=22.7, 12.8 Hz, 6H), 2.11 (s, 3H), 1.86-1.50 (m, 8H), 1.47-1.23 (m, 12H), 1.20-1.01 (m, 1H).

### 4-(1-adamantanyl)-2-(tert-butyl)-6-isopropoxy-6H-dibenzo[c,e][1,2]oxaborinine

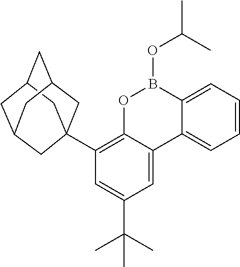 [SMILES: CC(C)OB1Oc2c(cc(C(C)(C)C)cc2C23CC4CC(CC(C4)C2)C3)-c2ccccc21]

To a solution of 2-((3-(1-adamantanyl)-2′-bromo-5-(tert-butyl)-[1,1′-biphenyl]-2-yl)oxy)tetrahydro-2H-pyran (23.5 g, 44.9 mmol) in THF (200 mL) at −78° C., n-butyllithium in hexanes (1.6 M, 33.4 mL, 53.5 mmol) was added dropwise over 20 minutes. The reaction mixture was stirred for 1 hour at −78° C., followed by addition of 2-isopropoxy-4,4,5,5-tetramethyl-1,3,2-dioxaborolane (11.8 g, 63.1 mmol). The resulting suspension was stirred for 1 hour at ambient temperature, then poured into 100 mL of water. The resulting mixture was extracted with hexane (100 mL). After separating the two phases, the aqueous phase was extracted with dichloromethane (2×50 mL). The combined organic extracts were dried over MgSO₄, then concentrated to dryness.

To the resulting residue, isopropanol (150 mL) was added, and the resulting solution was refluxed for 16 hours. After allowing the reaction to cool to ambient temperature, the reaction was concentrated and cooled to −20° C. for 1 hour, to afford the product as a white solid (16.6 g, 80%), which was isolated by filtration. ¹H NMR (400 MHz, CDCl₃) δ 8.17 (d, J=8.2 Hz, 1H), 8.09-8.02 (m, 2H), 7.65 (t, J=8.0 Hz, 1H), 7.45-7.40 (m, 2H), 5.24 (p, J=6.1 Hz, 1H), 2.30 (br, 6H), 2.16 (br, 3H), 1.84 (br, 6H), 1.43-1.39 (m, 15H).

### 2′,2′″-(Pyridine-2,6-diyl)bis((3-adamantan-1-yl)-5-(tert-butyl)-[1,1′-biphenyl]-2-ol

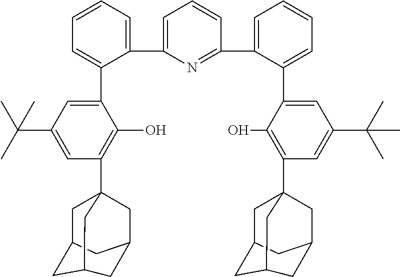 [SMILES: CC(C)(C)c1cc(-c2ccccc2-c2cccc(-c3ccccc3-c3cc(C(C)(C)C)cc(C45CC6CC(CC(C6)C4)C5)c3O)n2)c(O)c(C23CC4CC(CC(C4)C2)C3)c1]

To a solution of 4-(1-adamantanyl)-2-(tert-butyl)-6-isopropoxy-6H-dibenzo[c,e][1,2]oxaborinine (3.29 g, 6.91 mmol, 2.1 equiv.) in 1,4-dioxane (6 ml), 2,6-dibromopyridine (0.78 g, 3.29 mmol, 1.0 equiv.), cesium carbonate (2.73 g, 19.8 mmol), Buchwald RuPhos Palladacycle Gen II precatalyst (Strem, CAS 1375325-68-0, 24 mg, 0.03 mmol, 0.01 equiv.), and water (3 ml) were subsequently added. The reaction mixture was stirred for 15 hours at 100° C., then cooled to ambient temperature, and diluted with water (10 mL). The resulting mixture was diluted with dichloromethane (20 mL). After separating the two phases, the aqueous phase was extracted with dichloromethane (2×10 mL). The combined organic extracts were dried over MgSO₄, then concentrated to dryness. The crude product was dissolved into hot absolute ethanol, which was slowly cooled down to ambient temperature and then placed under −20° C. for 1 hour. The solid was then filtered to afford the product as a mixture of two isomers (1.65 g, 63%).

### 2′,2′″-(4-methylpyridine-2,6-diyl)bis(3-(1-adamantanyl)-5-(tert-butyl)-[1,1′-biphenyl]-2-ol)

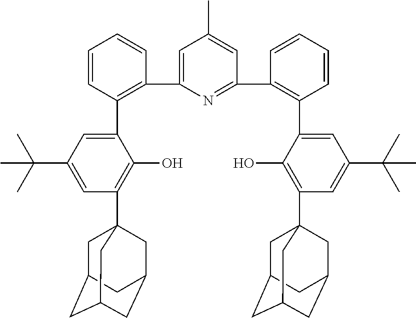 [SMILES: Cc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2] oxaborinine (0.555 g, 1.30 mmol) in 1,4-dioxane (4 mL), 2,6-dichloro-4-methylpyridine (0.100 g, 0.62 mmol), potassium carbonate (0.51 g, 3.70 mmol), Buchwald RuPhos Palladacycle Gen I precatalyst (Strem, CAS 1028206-60-1, 22.5 mg, 0.03 mmol,), and water (2 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×20 mL). The combined organic extracts were dried over MgSO₄, then concentrated to dryness. Purification by flash chromatography on silica gel (30% dichloromethane in hexane) afforded the product (0.46 g, 92%) as a mixture of two isomers. ¹H NMR (400 MHz, CDCl₃) δ 8.27 (s, 2H in A), 7.56-7.34 (m, 8H), 7.07 (s, 2H), 6.97 (s, 1H in B), 6.92 (s, 1H in B), 6.81 (s, 1H in B), 6.78 (s, 1H in B), 6.74 (s, 2H in A), 6.52 (s, 2H in A), 2.13-1.87 (m, 21H), 1.66 (br, 12H), 1.16 (s, 9H in B), 0.99 (s, 9H in A).

### 2,6-dibromo-4-ethylpyridine

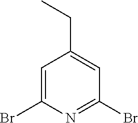

Solutions of 2,6-dibromo-4-methylpyridine (3.00 g, 12.0 mmol) in THF (5 mL) and freshly prepared LDA (1.28 g, 12.0 mmol) in THF (3 mL) were separately cooled in a cooling bath under −55° C. for 10 minutes. The chilled LDA solution was then slowly added to the solution of 2,6-dibromo-4-methylpyridine, which was stirred at −55° C. for 1 hour. Iodomethane (1.70 g, 12.0 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (30% dichloromethane in hexane) afforded the product in 67% yield (2.11 g,). ¹H NMR (400 MHz, CDCl₃) δ 7.29 (s, 2H), 2.61 (q, J=7.6 Hz, 2H), 1.24 (td, J=7.7, 1.2 Hz, 3H).

### 2′,2′″-(4-ethylpyridine-2,6-diyl)bis(3-(1-adamantanyl)-5-(tert-butyl)-[1,1′-biphenyl]-2-ol)

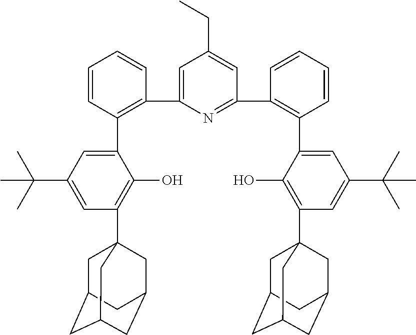 [SMILES: CCc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (2.10 g, 4.91 mmol) in 1,4-dioxane (12 mL), 2,6-bromo-4-ethylpyridine (0.65 g, 2.45 mmol), potassium carbonate (2.03 g, 14.7 mmol), Buchwald RuPhos Palladacycle Gen I precatalyst (Strem, CAS 1028206-60-1, 27.0 mg, 0.04 mmol,), and water (6 mL) were added. The reaction mixture was stirred for 16 hours at 100° C., then cooled to ambient temperature and diluted with water (30 mL). The resulting mixture was diluted with hexane (20 mL). After separating the two phases, the aqueous phase was extracted with dichloromethane (2×50 mL). The combined organic extracts were dried over MgSO₄, then concentrated to dryness. The product was purified by the flash chromatography on silica gel (impurities eluted with 15% dichloromethane in hexane, followed by 25% dichloromethane+2% acetone in hexane to elute the product). The product was isolated (1.59 g, 79%) as a mixture of two isomers. ¹H NMR (400 MHz, CDCl₃) δ 8.29 (s, 2H in A), 7.65-7.34 (m, 8H), 7.14-7.05 (m, 2H), 6.92 (s, 2H in B), 6.81 (s, 2H in B), 6.76 (s, 2H in A), 6.67 (s, 2H in B), 6.53 (s, 2H in A), 2.36 (q, J=7.5 Hz, 2H), 2.13-1.79 (m, 18H), 1.66 (br, 12H), 1.17 (s, 18H in B), 0.99 (s, 18H in A), 0.93-0.69 (m, 3H).

### 2,6-dibromo-4-(ethylthio)pyridine

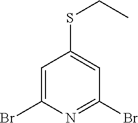

To a suspension of 71 mg of NaH (1.77 mmol, 60% wt. dispersion in mineral oil was washed thoroughly with hexane before use) in 5 mL of THF, 260 ul of ethanethiol (3.54 mmol) was added at 0° C. After that, 500 mg of 2,6-dibromo-4-nitropyridine (1.77 mmol) was added in one portion at 0° C. The reaction mixture was allowed to warm to room temperature, then stirred overnight, and finally cautiously quenched by 5 mL of water. The obtained mixture was extracted with dichloromethane (3×20 mL), the combined organic extract was dried over Na₂SO₄ and then evaporated to dryness. The residue was purified by flash chromatography on silica gel 60 (40-63 um, eluent:hexane-ethyl acetate-dichloromethane=10:1:1, vol.). Yield 310 mg (53%) of a beige solid. ¹H NMR (CDCl₃, 400 MHz): δ 7.22 (s, 2H), 3.01 (q, J=7.4 Hz, 2H), 1.41 (t, J=7.4 Hz, 3H). ¹³C NMR (CDCl₃, 100 MHz) δ 153.2, 140.4, 122.7, 25.2, 13.3.

### 2-(Adamantan-1-yl)-6-bromo-4-methylphenol

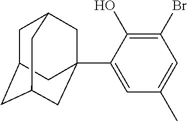 [SMILES: Cc1cc(Br)c(O)c(C23CC4CC(CC(C4)C2)C3)c1]

To a solution of 21.2 g (87.0 mmol) of 2-(adamantan-1-yl)-4-methylphenol in 200 mL of dichloromethane, a solution of 4.50 mL (87.0 mmol) of bromine in 100 mL of dichloromethane was added dropwise for 10 minutes at room temperature. The resulting mixture was diluted with 400 mL of water. The crude product was extracted with dichloromethane (3×70 mL), the combined organic extract was washed with 5% NaHCO₃, dried over Na₂SO₄, and then evaporated to dryness. Yield 21.5 g (77%) of a white solid. ¹H NMR (CDCl₃, 400 MHz): δ 7.17 (s, 1H), 6.98 (s, 1H), 5.65 (s, 1H), 2.27 (s, 3H), 2.10-2.13 (m, 9H), 1.80 (m, 6H), ¹³C NMR (CDCl₃, 100 MHz): δ 148.18, 137.38, 130.24, 129.32, 127.26, 112.08, 40.18, 37.32, 36.98, 28.99, 20.55.

### (1-(3-Bromo-5-methyl-2-(methoxymethoxy)phenyl)adamantine

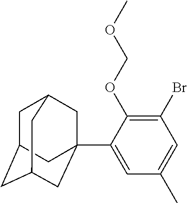 [SMILES: COCOc1c(Br)cc(C)cc1C12CC3CC(CC(C3)C1)C2]

To a solution of 21.3 g (66.4 mmol) of 2-(adamantan-1-yl)-6-bromo-4-methylphenol in 400 mL of THF, 2.79 g (69.7 mmol, 60% wt. in mineral oil) of sodium hydride was added portionwise at room temperature. To the resulting suspension, 5.55 mL (73.0 mmol) of methoxymethyl chloride was added dropwise for 10 minutes at room temperature. The obtained mixture was stirred overnight, then poured into 200 mL of water. Thus obtained mixture was extracted with dichloromethane (3×200 mL), the combined organic extract was washed with 5% NaHCO₃, dried over Na₂SO₄, and then evaporated to dryness. Yield 24.3 g (quant.) of a white solid. ¹H NMR (CDCl₃, 400 MHz): δ 7.24 (d, J=1.5 Hz, 1H), 7.05 (d, J=1.8 Hz, 1H), 5.22 (s, 2H), 3.71 (s, 3H), 2.27 (s, 3H), 2.05-2.12 (m, 9H), 1.78 (m, 6H). ¹³C NMR (CDCl₃, 100 MHz): δ 151.01, 144.92, 134.34, 131.80, 127.44, 117.57, 99.56, 57.75, 41.27, 37.71, 36.82, 29.03, 20.68.

### 2-(3-Adamantan-1-yl)-5-methyl-2-(methoxymethoxy)phenyl)-4,4,5,5-tetramethyl-1,3,2-dioxaborolane

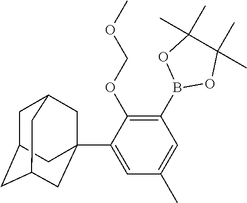 [SMILES: COCOc1c(B2OC(C)(C)C(C)(C)O2)cc(C)cc1C12CC3CC(CC(C3)C1)C2]

To a solution of 20.0 g (55.0 mmol) of (1-(3-bromo-5-methyl-2-(methoxymethoxy)phenyl)adamantine in 400 mL of dry THF, 22.5 mL (56.4 mmol) of 2.5 M ⁿBuLi in hexanes was added dropwise for 20 minutes at −80° C. The reaction mixture was stirred at this temperature for 1 hour, followed by addition of 16.7 mL (82.2 mmol) of 2-isopropoxy-4,4,5,5-tetramethyl-1,3,2-dioxaborolane. The obtained suspension was stirred for 1 hour at room temperature, then poured into 300 mL of water. The crude product was extracted with dichloromethane (3×300 mL), the combined organic extract was dried over Na₂SO₄ and then evaporated to dryness. Yield 22.4 g (99%) of a colorless viscous oil. ¹H NMR (CDCl₃, 400 MHz): δ 7.35 (d, J=2.3 Hz, 1H), 7.18 (d, J=2.3 Hz, 1H), 5.14 (s, 2H), 3.58 (s, 3H), 2.28 (s, 3H), 2.14 (m, 6H), 2.06 (m, 3H), 1.76 (m, 6H), 1.35 (s, 12H). ¹³C NMR (CDCl₃, 100 MHz): δ 159.68, 141.34, 134.58, 131.69, 131.14, 100.96, 83.61, 57.75, 41.25, 37.04, 29.14, 24.79, 20.83.

### 1-(2′-Bromo-5-methyl-2-(methoxymethoxy)-[1,1′-biphenyl]-3-yl)adamantine

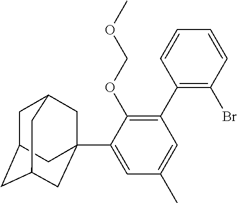 [SMILES: COCOc1c(-c2ccccc2Br)cc(C)cc1C12CC3CC(CC(C3)C1)C2]

To a solution of 10.0 g (24.3 mmol) of 2-(3-adamantan-1-yl)-5-methyl-2-(methoxymethoxy)phenyl)-4,4,5,5-tetramethyl-1,3,2-dioxaborolane in 100 mL of 1,4-dioxane, 7.22 g (25.5 mmol) of 2-bromoiodobenzene, 8.38 g (60.6 mmol) of potassium carbonate, and 50 mL of water were subsequently added. The mixture obtained was purged with argon for 10 minutes, followed by addition of 1.40 g (1.21 mmol) of Pd(PPh₃)₄. This mixture was stirred for 12 hours at 100° C., then cooled to room temperature, and diluted with 100 mL of water. The crude product was extracted with dichloromethane (3×150 mL), the combined organic extract was dried over Na₂SO₄ and then evaporated to dryness. The residue was purified by flash chromatography on silica gel 60 (40-63 um, eluent:hexane-dichloromethane=10:1, vol.). Yield 10.7 g (quant.) of a white solid. ¹H NMR (CDCl₃, 400 MHz): δ 7.72 (d, J=7.9 Hz, 1H), 7.35-7.44 (m, 3H), 7.19-7.26 (m, 1H), 6.94 (m, 1H), 4.53 (dd, J=20.0, 4.6 Hz, 2H), 3.24 (s, 3H), 2.38 (s, 3H), 2.23 (m, 6H), 2.15 (m, 3H), 1.84 (m, 6H). ¹³C NMR (CDCl₃, 100 MHz): δ 151.51, 142.78, 141.11, 134.63, 132.76, 132.16, 132.13, 129.83, 128.57, 127.76, 127.03, 124.05, 98.85, 56.95, 41.21, 37.18, 36.94, 29.07, 21.00.

### 4-((3r,5r,7r)-Adamantan-1-yl)-6-isopropoxy-2-methyl-6H-dibenzo[c,e][1,2]oxaborinine

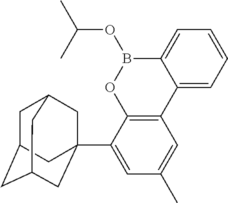 [SMILES: Cc1cc2c(c(C34CC5CC(CC(C5)C3)C4)c1)OB(OC(C)C)c1ccccc1-2]

To a solution of 5.45 g (12.3 mmol) of 1-(2′-bromo-5-methyl-2-(methoxymethoxy)-[1,1′-biphenyl]-3-yl)adamantine in 100 mL of dry THF, 5.92 mL (14.8 mmol) of 2.5 M ⁿBuLi in hexanes was added dropwise for 20 minutes at −80° C. The reaction mixture was stirred for 1 hour at this temperature, followed by addition of 3.78 mL (18.5 mmol) of 2-isopropoxy-4,4,5,5-tetramethyl-1,3,2-dioxaborolane. The obtained suspension was stirred at room temperature for 1 hour, then poured into 300 mL of water. The crude product was extracted with dichloromethane (3×100 mL), the combined organic extract was dried over Na₂SO₄ and then evaporated to dryness. The residue was refluxed in 100 mL of isopropanol for 4 hours. The precipitated crystals were filtered off on a glass frit (G4) and dried in vacuo. Yield 3.75 g (79%) of a white crystalline solid. ¹H NMR (CDCl₃, 400 MHz): δ 8.18 (d, J=8.3 Hz, 1H), 8.12 (dd, J=7.5, 1.1 Hz, 1H), 7.88 (s, 1H), 7.67 (dt, J=7.5, 1.5 Hz, 1H), 7.45 (dt, J=7.4, 0.7 Hz, 1H), 7.21 (d, J=1.8 Hz, 1H), 5.29 (sept, J=6.2 Hz, 1H), 2.48 (s, 3H), 2.30-2.35 (m, 6H), 2.20 (br.s, 3H), 1.85-1.90 (m, 6H), 1.46 (d, J=6.2 Hz, 6H). ¹³C NMR (CDCl₃, 100 MHz): δ 148.4, 140.6, 139.3, 133.0, 131.8, 130.7, 127.5, 126.6, 122.8, 121.9, 121.6, 65.7, 40.7, 37.15, 37.12, 29.1, 24.7, 21.4.

### 2′,2′″-(4-(Ethylthio)pyridine-2,6-diyl)bis(3-((3r,5r,7r)-adamantan-1-yl)-5-methyl-[1,1′-biphenyl]-2-ol)

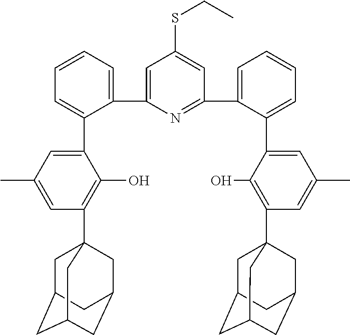

To a solution of 770 mg (2.00 mmol) of 4-((3r,5r,7r)-adamantan-1-yl)-6-isopropoxy-2-methyl-6H-dibenzo[c,e][1,2]oxaborinine in 5 mL of 1,4-dioxane, 290 mg (0.98 mmol) of 2,6-dibromo-4-(ethylthio)pyridine, 1.63 g (5.00 mmol) of cesium carbonate, and 3 mL of water were subsequently added. The mixture obtained was purged with argon for 1 minute, followed by addition of 112 mg (0.10 mmol) of Pd(PPh₃)₄. This mixture was stirred for 12 hours at 100° C., then cooled to room temperature, and diluted with 50 mL of water. Thus obtained mixture was extracted with dichloromethane (3×50 mL), the combined organic extract was dried over Na₂SO₄ and then evaporated to dryness. The residue was purified by flash chromatography on silica gel 60 (40-63 um, eluent:hexane-dichloromethane=1:1, vol.). Yield 580 mg (77%) of a mixture of two isomers as a colorless glassy solid. ¹H NMR (CDCl₃, 400 MHz): δ 7.65 (s, 1H), 7.58-7.62 (m, 2H), 7.45-7.51 (m, 4H), 7.32-7.41 (m, 3H), 6.92 (s, 1H), 6.86-6.88 (m, 2H), 6.79-6.81 (m, 2H), 6.21 (s, 1H), 2.41-2.70 (m, 2H), 2.26 (s, 3H), 2.00 (s, 3H), 1.57-1.98 (m, 30H), 1.14-1.20 (m, 3H). ¹³C NMR (CDCl₃, 100 MHz) (157.3, 157.2, 151.3, 150.3, 150.2, 149.7, 139.5, 138.3, 138.0, 137.9, 137.6, 137.5, 132.4, 131.3, 130.4, 130.2, 130.15, 129.5, 129.0, 128.8, 128.6, 127.83, 127.76, 127.0, 126.7, 119.6, 118.6, 40.5, 40.1, 37.09, 37.03, 36.83, 36.75, 36.5, 29.1, 29.0, 25.0, 24.6, 20.8, 20.6, 13.6, 13.4.

### 2,6-dichloro-4-butylpyridine

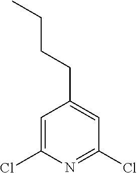

Solutions of 2,6-dichloro-4-methylpyridine (5.00 g, 30.9 mmol) in THF (10 mL) and freshly prepared LDA (3.31 g, 30.9 mmol) in THF (5 mL) were separately cooled in a cooling bath under −55° C. for 10 minutes. The chilled LDA solution was then slowly added to the solution of 2,6-dichloro-4-methylpyridine, which was stirred at −55° C. for 1 hour. 1-bromopropane (3.80 g, 30.9 mmol) was then added to the reaction mixture, which was stirred at ambient temperature for 12 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (20% dichloromethane in hexane) afforded the product in 74% yield (4.63 g). ¹H NMR (400 MHz, CDCl₃) δ 7.08 (s, 2H), 2.59 (t, J=7.8 Hz, 2H), 1.60 (p, J=7.4 Hz, 2H), 1.35 (h, J=7.4 Hz, 2H), 0.93 (td, J=7.3, 1.4 Hz, 3H).

### 2′,2′″-(4-butylpyridine-2,6-diyl)bis(3-(1-adamantanyl)-5-(tert-butyl)-[1,1′-biphenyl]-2-ol)

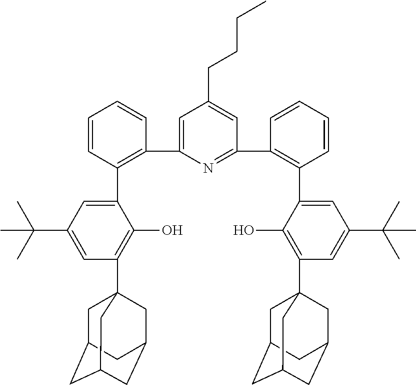 [SMILES: CCCCc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (2.97 g, 6.39 mmol) in 1,4-dioxane (20 mL), 2,6-dichloro-4-butylpyridine (0.69 g, 3.38 mmol), cesium carbonate (6.61 g, 20.2 mmol), Buchwald RuPhos Palladacycle Gen I precatalyst (Strem, CAS 1028206-60-1, 60.0 mg, 0.08 mmol,), and water (10 mL) were subsequently added. The reaction mixture was stirred for 16 hours at 100° C., then cooled to ambient temperature, and diluted with water (30 mL). The resulting mixture was diluted with hexane (20 mL). After separating the two phases, the aqueous phase was extracted with dichloromethane (2×50 mL). The combined organic extracts were dried over MgSO₄ and were filtered on small amount of silica gel, then concentrated to dryness. The crude product was dissolved in hexane, and ethanol (100 mL) was subsequently added. The solution was concentrated under reduced pressure at 40° C., then allowed to cool to ambient temperature. The precipitate was isolated as an ethanol adduct, which was dissolved in toluene and concentrated to dryness to remove all of the ethanol. The product was isolated (1.95 g, 35%) as a mixture of two isomers. ¹H NMR (400 MHz, CDCl₃) δ 8.29 (s, 2H in A), 7.59-7.35 (m, 8H), 6.94 (s, 2H in B), 6.80 (s, 2H in B), 6.75 (m), 6.56-6.53 (s, 2H), 2.35-2.19 (m, 2H), 2.06-1.85 (m, 18H), 1.66 (br, 12H), 1.25-1.17 (m, 4H), 1.17 (s, 9H in B), 1.00 (s, 9H in A), 0.86 (t, J=6.8 Hz, 3H).

### 2,6-dichloro-4-((tert-butyldimethylsilyl)methyl)pyridine

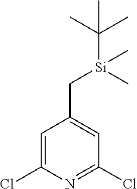 [SMILES: CC(C)(C)[Si](C)(C)Cc1cc(Cl)nc(Cl)c1]

Solutions of 2,6-dichloro-4-methylpyridine (1.00 g, 6.17 mmol) in THF (3 mL) and freshly prepared LDA (0.661 g, 6.17 mmol) in THF (2 mL) were separately cooled in a cooling bath under −55° C. for 10 minutes. The chilled LDA solution was then slowly added to the solution of 2,6-dichloro-4-methylpyridine, which was stirred at −55° C. for 1 hour. tert-butyldimethylsilyl chloride (0.93 g, 6.17 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (20% dichloromethane in hexane) afforded the product in 94% yield (1.61 g). ¹H NMR (400 MHz, CDCl₃) δ 6.89 (s, 2H), 2.10 (s, 2H), 0.92 (d, J=1.5 Hz, 9H), −0.06 (d, J=1.3 Hz, 6H).

### 2′,2′″-(4-((tert-butyldimethylsilyl)methyl)pyridine-2,6-diyl)bis(3-(1-adamantanyl)-5-(tert-butyl)-[1,1′-biphenyl]-2-ol)

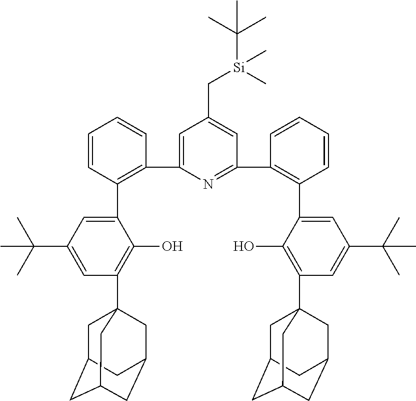 [SMILES: CC(C)(C)c1cc(-c2ccccc2-c2cc(C[Si](C)(C)C(C)(C)C)cc(-c3ccccc3-c3cc(C(C)(C)C)cc(C45CC6CC(CC(C6)C4)C5)c3O)n2)c(O)c(C23CC4CC(CC(C4)C2)C3)c1]

To a solution of 4-(1-adamantanyl)-2-(tert-butyl)-6-isopropoxy-6H-dibenzo[c,e][1,2]oxaborinine (0.62 g, 1.45 mmol) in 1,4-dioxane (4 mL), 2,6-dichloro-4-((tert-butyldimethylsilyl)methyl) pyridine (0.20 g, 0.72 mmol), potassium carbonate (0.600 g, 4.3 mmol), Buchwald RuPhos Palladacycle Gen I precatalyst (Strem, CAS 1028206-60-1, 7.9 mg, 0.01 mmol,), and water (2 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×20 mL). The combined organic extracts were dried over MgSO₄ and were filtered on small amount of silica gel, then concentrated to dryness. The product was purified by flash chromatography on silica gel (impurities eluted with 15% dichloromethane in hexane, followed by 25% dichloromethane+2% acetone in hexane to elute the product) to afford the product in 55% yield (0.31 g). ¹H NMR (400 MHz, CDCl₃) δ 8.21 (s, 2H in A), 7.58-7.30 (m, 8H), 7.09 (d, J=2.4 Hz, 2H), 7.00 (d, J=2.4 Hz, 2H in B), 6.73 (s, 2H in B), 6.67 (s, 2H in B), 6.59 (s, 2H in A), 6.57 (s, 2H in A), 2.16-1.80 (m, 18H), 1.76-1.60 (m, 12H), 1.37-1.23 (m, 2H) 1.18 (s, 18H in B), 1.03 (s, 18H in A), 0.87 (s, 9H), −0.18 (s, 6H in A), −0.23 (s, 6H in B).

### 2,6-dichloro-4-((triethylsilyl)methyl)pyridine

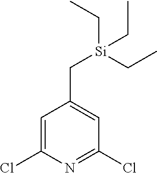 [SMILES: CC[Si](CC)(CC)Cc1cc(Cl)nc(Cl)c1]

Solutions of 2,6-dichloro-4-methylpyridine (1.00 g, 6.17 mmol) in THF (3 mL) and freshly prepared LDA (0.661 g, 6.17 mmol) in THF (2 mL) were separately cooled in a cooling bath under −55° C. for 10 minutes. The chilled LDA solution was then slowly added to the solution of 2,6-dichloro-4-methylpyridine, which was stirred at −55° C. for 1 hour. Triethylsilylchloride (0.93 g, 6.17 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (20% dichloromethane in hexane) afforded the product in 94% yield (1.61 g). ¹H NMR (400 MHz, CDCl₃) δ 6.89 (s, 2H), 2.11 (s, 2H), 0.93 (t, J=7.9 Hz, 9H), 0.54 (q, J=7.9 Hz, 6H).

### 2′,2′″-(4-((triethylsilyl)methyl)pyridine-2,6-diyl)bis(3-(1-adamantanyl)-5-(tert-butyl)-[1,1′-biphenyl]-2-ol)

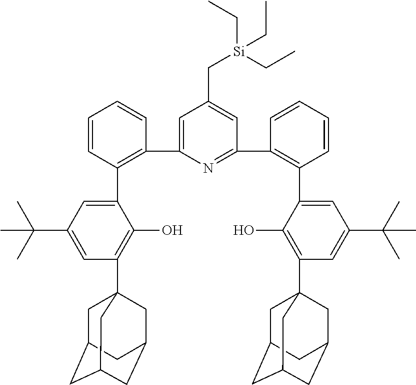 [SMILES: CC[Si](CC)(CC)Cc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.50 g, 1.17 mmol) in 1,4-dioxane (4 mL), 2,6-dichloro-4-((triethylsilyl)methyl) pyridine (0.26 g, 0.58 mmol), potassium carbonate (0.485 g, 3.5 mmol), Buchwald RuPhos Palladacycle Gen I precatalyst (Strem, CAS 1028206-60-1, 4.3 mg, 0.005 mmol,), and water (2 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×20 mL). The combined organic extracts were dried over MgSO₄ and were filtered on small amount of silica gel, then concentrated to dryness. The product was purified by the flash chromatography on silica gel (impurities eluted with 15% dichloromethane in hexane, followed by 25% dichloromethane+2% acetone in hexane to elute the product). The product was isolated (0.46 g, 72%) as a mixture of two isomers. ¹H NMR (400 MHz, CDCl₃) δ 8.28 (s, 2H in A), 7.60-7.31 (m, 8H), 7.07 (s, 2H), 6.80 (s, 1H in B), 6.74 (s, 1H in B), 6.63 (s, 2H in B), 6.61 (s, 2H in A), 6.57 (s, 2H in B), 6.54 (s, 2H in A), 2.26-1.72 (m, 20H), 1.65 (br, 12H), 1.17 (s, 18H in B), 1.01 (s, 18H in A), 0.86 (t, J=7.8 Hz, 9H), 0.42 (q, J=7.9 Hz, 6H).

### 2,6-dichloro-4-((trihexylsilyl)methyl)pyridine

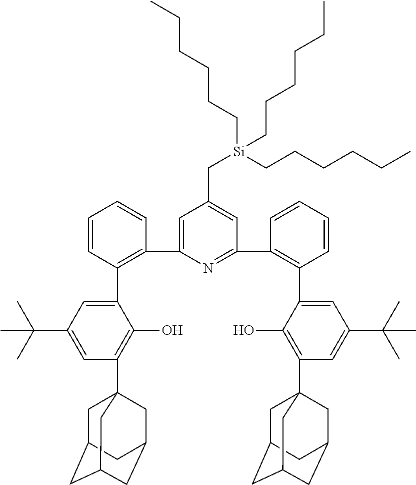 [SMILES: CCCCCC[Si](CCCCCC)(CCCCCC)Cc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

Solutions of 2,6-dichloro-4-methylpyridine (1.00 g, 6.17 mmol) in THF (3 mL) and freshly prepared LDA (0.661 g, 6.17 mmol) in THF (2 mL) were separately cooled in a cooling bath under −55° C. for 10 minutes. The chilled LDA solution was then slowly added to the solution of 2,6-dichloro-4-methylpyridine, which was stirred at −55° C. for 1 hour. Triethylsilylchloride (0.93 g, 6.17 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (20% dichloromethane in hexane) afforded the product in 94% yield (1.61 g). ¹H NMR (400 MHz, CDCl₃) δ 6.87 (s, 2H), 2.10 (s, 2H), 1.26 (d, J=4.6 Hz, 24H), 0.88 (t, J=6.6 Hz, 9H), 0.51 (d, J=10.0 Hz, 6H).

### 2′,2′″-(4-((trihexylsilyl)methyl)pyridine-2,6-diyl)bis(3-(1-adamantanyl)-5-(tert-butyl)-[1,1′-biphenyl]-2-ol)

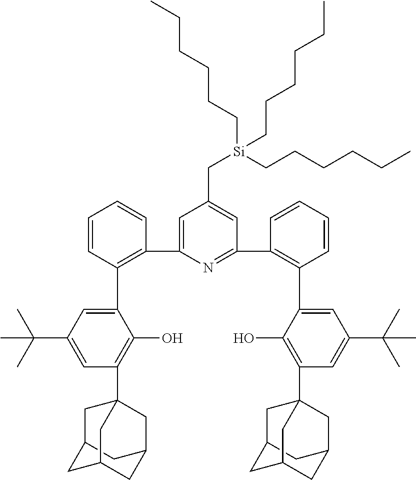 [SMILES: CCCCCC[Si](CCCCCC)(CCCCCC)Cc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.50 g, 1.17 mmol) in 1,4-dioxane (4 mL), 2,6-dichloro-4-((trihexylsilyl)methyl) pyridine (0.26 g, 0.58 mmol), potassium carbonate (0.485 g, 3.5 mmol), Buchwald RuPhos Palladacycle Gen I precatalyst (Strem, CAS 1028206-60-1, 4.3 mg, 0.005 mmol,), and water (2 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×20 mL). The combined organic extracts were dried over MgSO₄ and were filtered on small amount of silica gel, then concentrated to dryness. The product was purified by the flash chromatography on silica gel (impurities eluted with 15% dichloromethane in hexane, followed by 25% dichloromethane+2% acetone in hexane to elute the product). The product was isolated (0.46 g, 72%) as a mixture of two isomers. ¹H NMR (400 MHz, CDCl₃) δ 8.51 (s, 2H in A), 7.62-7.33 (m, 8H), 7.16 (s, 2H), 7.09 (s, 1H in B), 6.88 (s, 1H in B), 6.84 (s, 2H in B), 6.66 (s, 2H in A), 6.60 (s, 2H in A)i, 2.31-1.93 (m, 20H), 1.86 (br, 6H in A), 1.73 (br, 6H in B), 1.31 (br, 24H), 0.1.24 (s, 18H in B), 1.08 (s, 18H in A), 0.93 (t, J=6.6 Hz, 9H), 0.69 (dd, J=9.5, 6.1 Hz, 6H in B), 0.53 (dd, J=10.6, 5.2 Hz, 6H in A).

### 2′,2′″-(4-(Pyrrolidin-1-yl)pyridine-2,6-diyl)bis(3-((3r,5r,7r)-adamantan-1-yl)-5-methyl-[1,1′-biphenyl]-2-ol)

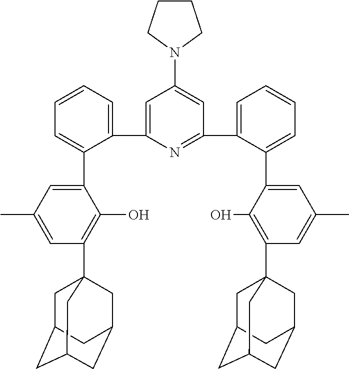

To a solution of 2.00 g (5.18 mmol) of 4-((3r,5r,7r)-adamantan-1-yl)-6-isopropoxy-2-methyl-6H-dibenzo[c,e][1,2]oxaborinine in 13 mL of 1,4-dioxane, 792 mg (2.59 mmol) of 2,6-dibromo-4-(pyrrolydin-1-yl)pyridine, 4.22 g (12.9 mmol) of cesium carbonate, and 7 mL of water were subsequently added. The mixture obtained was purged with argon for 10 minutes, followed by addition of 299 mg (0.260 mmol) of Pd(PPh₃)₄. This mixture was stirred for 12 hours at 100° C., then cooled to room temperature, and diluted with 50 mL of water. Thus obtained mixture was extracted with dichloromethane (3×50 mL), the combined organic extract was dried over Na₂SO₄ and then evaporated to dryness. The residue was purified by flash chromatography on silica gel 60 (40-63 um, eluent:hexane-ethyl acetate=10:1, vol.). The obtained glassy solid was triturated with 30 mL of n-pentane, the precipitate thus obtained was filtered off (G3), washed with 2×10 mL of n-pentane, and dried in vacuo. Yield 990 mg (47%) of a mixture of two isomers as a white powder. ¹H NMR (CDCl₃, 400 MHz): δ 8.65 (br.s, 2H in B), 8.21 (br.s, 2H in A), 7.64-7.66 (m, 2H in A), 7.57-7.59 (m, 2H in B), 7.40-7.49 (m, 4H in A, 4H in B), 7.26-7.34 (m, 2H in A, 2H in B), 6.84-6.89 (m, 3H in A, 3H in B), 6.27 (s, 2H in B), 6.06 (s, 2H in A), 5.99 (s, 2H in A), 2.95-3.10 (m, 4H in A), 2.80-2.93 (m, 4H in B), 2.24 (s, 6H in A), 2.00 (s, 6H in B), 1.50-1.99 (m, 30H in A, 30H in B). ¹³C NMR (CDCl₃, 100 MHz) δ 157.25, 157.18*, 150.6, 150.2*, 140.3*, 139.1, 138.1*, 137.9, 137.7, 137.6*, 132.2, 131.4*, 130.8*, 130.1, 130.0, 129.1, 129.0, 128.98, 128.4*, 128.3 128.2*, 127.5, 127.4*, 126.5, 126.3*, 105.9*, 105.7, 47.0*, 46.7, 40.5*, 40.1, 37.0*, 36.8, 36.7*, 36.4, 29.1, 29.0, 25.33, 25.27, 25.0*, 20.8, 20.6*.

### 2,6-dichloro-4-(tert-butoxy)pyridine

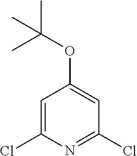

Solutions of sodium tert-butoxide (0.259 g, 2.69 mmol) in THF (3 mL) and solution of 2,6-dichloro-4-nitropyridine (0.500 g, 2.59 mmol) in THF (4 mL) were separately cooled in a cooling bath under 0° C. for 10 minutes. The chilled sodium tert-butoxide solution was then slowly added to the solution of 2,6-dichloro-4-nitropyridine, which was stirred at 0° C. for 10 minutes. The reaction mixture was then allowed to stir at 40° C. for additional 16 hours. After cooling to ambient temperature, the mixture was quenched with sodium bicarbonate aqueous solution (5 mL). The resulting mixture was diluted with hexane (10 mL). After separating the two phases, the aqueous phase was extracted with dichloromethane (2×10 mL). The combined organic extracts were dried over MgSO₄, then concentrated. The crude product was filtered on a silica gel plug. Pure product (0.550 g, 97%) was isolated as white solid after drying on vacuum. ¹H NMR (400 MHz, CDCl₃) δ 6.82 (s, 2H), 1.49 (s, 9H).

### 2′,2′″-(4-(tert-butoxy)pyridine-2,6-diyl)bis(3-(1-adamantanyl)-5-(tert-butyl)-[1,1′-biphenyl]-2-ol)

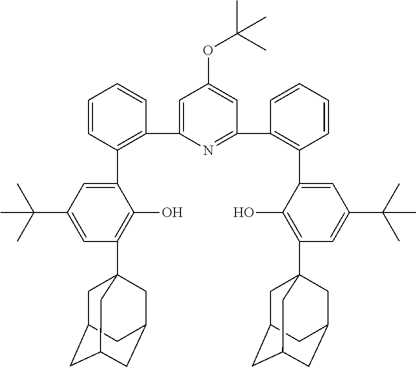 [SMILES: CC(C)(C)Oc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.584 g, 1.36 mmol) in 1,4-dioxane (6 mL), 2,6-dichloro-4-(tert-butoxy)pyridine (0.150 g, 0.68 mmol), cesium carbonate (1.33 g, 4.09 mmol), Buchwald RuPhos Palladacycle Gen II precatalyst (Strem, CAS 1375325-68-0, 7.8 mg, 0.01 mmol), and water (3 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×10 mL). The combined organic extracts were dried over MgSO₄, then concentrated to dryness. Purification by flash chromatography on silica gel (50% dichloromethane in hexane) afforded the product (0.576 g, 97.3%) as a mixture of two isomers. ¹H NMR (400 MHz, CDCl₃) δ 8.40 (s, 2H in A), 7.68-7.31 (m, 8H), 7.09 (s, 2H), 7.00 (s, 2H in B), 6.89 (s, 2H in B), 6.68 (s, 2H in B), 6.66-6.46 (m, 4H), 2.09-1.83 (m, 18H), 1.68 (br, 12H), 1.22 (s, 18H in B), 1.16 (s, 9H), 1.05 (s, 18H in A).

### 2,6-dichloro-4-(3-butenyl)pyridine

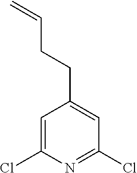

Solutions of 2,6-dichloro-4-methylpyridine (0.700 g, 4.32 mmol) in THF (3 mL) and freshly prepared LDA (0.509 g, 4.75 mmol) in THF (2 mL) were separately cooled in a cooling bath under −55° C. for 10 minutes. The chilled LDA solution was then slowly added to the solution of 2,6-dichloro-4-methylpyridine, which was then stirred at −55° C. for 1 hour. 3-bromoprop-1-ene (0.575 g, 12.0 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (20% dichloromethane in hexane) afforded the product in 70% yield (0.610 g). ¹H NMR (400 MHz, CDCl₃) δ 7.07 (s, 2H), 5.91-5.63 (m, 1H), 5.14-4.83 (m, 2H), 2.67 (t, J=7.7 Hz, 2H), 2.35 (q, J=7.5 Hz, 2H).

### 2′,2′″-(4-(3-butenyl)pyridine-2,6-diyl)bis(3-(1-adamantanyl)-5-(tert-butyl)-[1,1′-biphenyl]-2-ol)

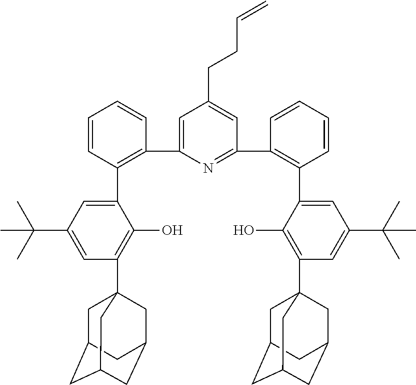 [SMILES: C=CCCc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.848 g, 1.98 mmol) in 1,4-dioxane (6 mL), 2,6-dichloro-4-(3-butenyl)pyridine (0.200 g, 0.99 mmol), cesium carbonate (1.93 g, 5.94 mmol), Buchwald RuPhos Palladacycle Gen I precatalyst (Strem, CAS 1028206-60-1, 28.8 mg, 0.04 mmol,), and water (3 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×20 mL). The combined organic extracts were dried over MgSO₄, then concentrated to dryness. Purification by flash chromatography on silica gel (50% dichloromethane in hexane) afforded the product in 0.36 g (43.4%) as a mixture of two isomers. ¹H NMR (400 MHz, CDCl₃) δ 8.22 (s, 2H in A), 7.64-7.30 (m, 8H), 7.09 (s, 2H), 6.92 (s, 2H in B), 6.81 (s, 2H in B), 6.76 (s, 2H in A), 6.53 (s, 2H), 5.66 (td, J=16.9, 7.0 Hz, 1H), 5.05-4.79 (m, 2H), 2.40 (t, J=8.0 Hz, 2H), 2.06-1.83 (m, 20H), 1.66 (br, 12H), 1.16 (s, 18H in B), 0.99 (s, 18H in A).

### 2,6-dichloro-4-propylpyridine

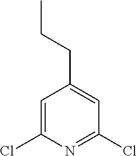

Solutions of 2,6-dichloro-4-methylpyridine (2.00 g, 12.3 mmol) in THF (5 mL) and freshly prepared LDA (1.45 g, 13.6 mmol) in THF (3 mL) were separately cooled in a cooling bath under −55° C. for 10 minutes. The chilled LDA solution was then slowly added to the solution of 2,6-dichloro-4-methylpyridine, which was stirred at −55° C. for 1 hour. Bromoethane (1.48 g, 13.6 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (20% dichloromethane in hexane) afforded the product in 69% yield (1.610 g). ¹H NMR (400 MHz, CDCl₃) δ 7.07 (d, J=1.6 Hz, 2H), 2.56 (t, J=7.7 Hz, 2H), 1.65 (q, J=8.3, 7.7 Hz, 2H), 0.95 (td, J=7.4, 1.6 Hz, 3H).

### 2′,2′″-(4-propylpyridine-2,6-diyl)bis(3-(1-adamantanyl)-5-(tert-butyl)-[1,1′-biphenyl]-2-ol)

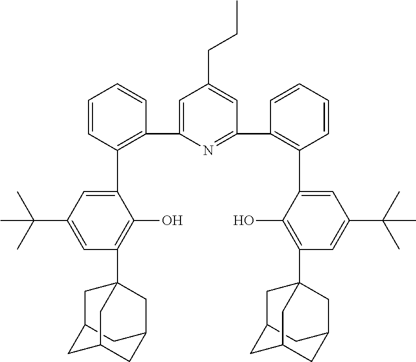 [SMILES: CCCc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.225 g, 0.53 mmol) in 1,4-dioxane (4 mL), 2,6-dichloro-4-propylpyridine (0.050 g, 0.26 mmol), cesium carbonate (0.514 g, 1.58 mmol), Buchwald RuPhos Palladacycle Gen I precatalyst (Strem, CAS 1028206-60-1, 7.8 mg, 0.01 mmol), and water (2 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×10 mL). The combined organic extracts were dried over MgSO₄, then concentrated to dryness. Purification by flash chromatography on silica gel (50% dichloromethane in hexane) afforded the product (0.100 g, 45.4%) as a mixture of two isomers. ¹H NMR (400 MHz, CDCl₃) δ 8.26 (s, 2H in A), 7.64-7.30 (m, 8H), 7.07 (s, 2H), 6.95 (s, 1H in B), 6.92 (s, 1H in B), 6.83 (s, 1H in B), 6.79 (s, 1H in B), 6.75 (s, 2H in A), 6.66 (s, 2H in B) 6.54 (s, 2H in A), 2.28 (t, J=7.8 Hz, 2H), 2.15-1.84 (m, 18H), 1.66 (br, 12H), 1.20 (s, 9H in B), 1.16 (s, 9H in B), 0.99 (s, 18H in A), 0.90-0.82 (m, 2H), 0.78 (t, J=7.1 Hz, 3H).

### 2,6-dichloro-4-(tert-butyldimethylsilyl)pyridine

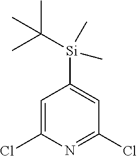

Solutions of iso-propylmagnesium chloride lithium chloride complex in THF (1.3 M, 2.81 mL, 3.65 mmol) and 2,6-dichloro-4-iodopyridine (0.550 g, 3.65 mmol) in THF (5 mL) were separately cooled in a cooling bath under −20° C. for 10 minutes. The chilled iso-propylmagnesium chloride solution was then slowly added to the solution of 2,6-dichloro-4-iodopyridine, which was then stirred at −20° C. for 1 hour. The reaction mixture was then allowed to stir at ambient temperature for an additional 1 hour. tert-butyldimethylsilyl chloride (0.550 g, 3.65 mmol) was then added. The reaction mixture was stirred for 16 hours, then quenched with sodium bicarbonate aqueous solution (5 mL). The resulting mixture was diluted with hexane (10 mL). After separating the two phases, the aqueous phase was extracted with dichloromethane (2×10 mL). The combined organic extracts were dried over MgSO₄, then concentrated. The crude product was dissolved in hot ethanol. Pure product (0.340 g, 36%) was isolated as white solid after recrystallization. ¹H NMR (400 MHz, CDCl₃) δ 7.29 (s, 2H), 0.89 (s, 9H), 0.30 (s, 6H).

### 2′,2′″-(4-(tert-butyldimethylsilyl)pyridine-2,6-diyl)bis(3-(1-adamantanyl)-5-(tert-butyl)-[1,1′-biphenyl]-2-ol)

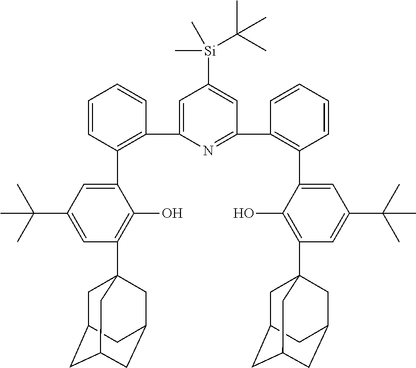 [SMILES: CC(C)(C)c1cc(-c2ccccc2-c2cc([Si](C)(C)C(C)(C)C)cc(-c3ccccc3-c3cc(C(C)(C)C)cc(C45CC6CC(CC(C6)C4)C5)c3O)n2)c(O)c(C23CC4CC(CC(C4)C2)C3)c1]

To a solution of 4-(1-adamantanyl)-2-(tert-butyl)-6-isopropoxy-6H-dibenzo[c,e][1,2]oxaborinine (0.584 g, 1.36 mmol) in 1,4-dioxane (6 mL), 2,6-dichloro-4-(tert-butyldimethylsilyl)pyridine (0.179 g, 0.68 mmol), cesium carbonate (1.33 g, 4.09 mmol), Buchwald RuPhos Palladacycle Gen II precatalyst (Strem, CAS 1375325-68-0, 20.0 mg, 0.03 mmol), and water (3 mL) were subsequently added. The reaction mixture was stirred for 5 hours at 100° C., then cooled to ambient temperature, and diluted with water (10 mL). The resulting mixture was diluted with dichloromethane (20 mL). After separating the two phases, the aqueous phase was extracted with dichloromethane (2×10 mL). The combined organic extracts were dried over MgSO₄, then concentrated to dryness. The crude product was stirred in ethanol at 80° C. until precipitation of a white solid was observed. The resulting mixture was then stored under −20° C. for 1 hour, then filtered to afford the product (0.483 g, 78%) as a mixture of two isomers. ¹H NMR (400 MHz, CDCl₃) δ 7.94 (s, 2H in A), 7.60-7.38 (m, 8H), 7.14 (d, J=2.5 Hz, 2H in B), 7.11-7.08 (m, 2H), 7.07 (s, 2H in A), 7.04 (d, J=2.4 Hz, 2H in B), 6.59 (d, J=2.4 Hz, 2H in A), 6.32 (s, 2H in B), 2.09-1.86 (m, 18H), 1.68 (br, 12H), 1.23 (s, 18H in B), 1.02 (s, 18H in A), 0.76 (s, 9H), 0.07 (s, 3H in A), 0.01 (s, 6H in B), −0.07 (s, 3H in A).

### 2,6-dichloro-4-(4-(2,4,4-trimethylpentan-2-yl)phenoxy)pyridine

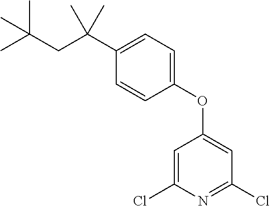 [SMILES: CC(C)(C)CC(C)(C)c1ccc(Oc2cc(Cl)nc(Cl)c2)cc1]

Sodium hydride (0.192 g, 8.00 mmol, 90% pure dry powder) was added to a stirred solution of 4-(1,1,3,3-tetramethylbutyl)phenol (1.50 g, 7.24 mmol) in diethyl ether (10 mL) at 0° C. The mixture was then stirred at ambient temperature for 3 hours. The solvent was removed under vacuum. Sodium 4-(1,1,3,3-tetramethylbutyl)phenoxide (1.65 g, 99%) was recovered as white solid. Solutions of sodium 4-(1,1,3,3-tetramethylbutyl)phenoxide (0.592 g, 2.59 mmol) in THF (3 mL) and 2,6-dichloro-4-nitropyridine (0.500 g, 2.59 mmol) in THF (4 mL) were separately cooled in a cooling bath under 0° C. for 10 minutes. The chilled sodium 4-(1,1,3,3-tetramethylbutyl)phenoxide solution was then slowly added to the solution of 2,6-dichloro-4-nitropyridine, which was stirred at 0° C. for 10 minutes. The reaction mixture was then stirred at 50° C. for additional 16 hours. After cooling to ambient temperature, the reaction mixture was quenched with sodium bicarbonate aqueous solution (5 mL). The resulting mixture was diluted with hexane (10 mL). After separating the two phases, the aqueous phase was extracted with dichloromethane (2×10 mL). The combined organic extracts were dried over MgSO₄, then concentrated to dryness. The crude product was precipitated from methanol and the resulting mixture was placed under −30° C. for 1 hour. Pure product was isolated by filtration as a white solid (0.700 g, 77%). ¹H NMR (400 MHz, CDCl₃) δ 7.47 (d, J=8.8 Hz, 2H), 7.01 (d, J=8.8 Hz, 2H), 6.77 (s, 2H), 1.78 (s, 2H), 1.43 (s, 6H), 0.76 (s, 9H).

### 2′,2′″-(4-(4-(2,4,4-trimethylpentan-2-yl)phenoxy)pyridine-2,6-diyl)bis(3-(1-adamantanyl)-5-(tert-butyl)-[1,1′-biphenyl]-2-ol)

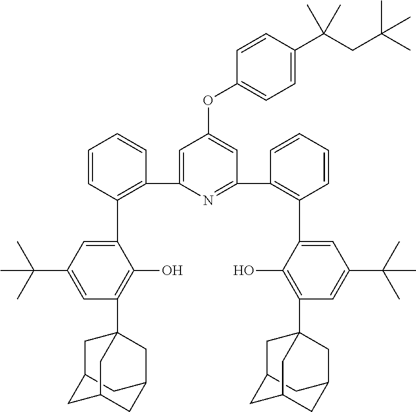 [SMILES: CC(C)(C)CC(C)(C)c1ccc(Oc2cc(-c3ccccc3-c3cc(C(C)(C)C)cc(C45CC6CC(CC(C6)C4)C5)c3O)nc(-c3ccccc3-c3cc(C(C)(C)C)cc(C45CC6CC(CC(C6)C4)C5)c3O)c2)cc1]

To a solution of 4-(1-adamantanyl)-2-(tert-butyl)-6-isopropoxy-6H-dibenzo[c,e][1,2]oxaborinine (0.584 g, 1.36 mmol) in 1,4-dioxane (6 mL), 2,6-dichloro-4-(4-(2,4,4-trimethylpentan-2-yl)phenoxy)pyridine (0.240 g, 0.68 mmol), cesium carbonate (1.33 g, 4.09 mmol), Buchwald RuPhos Palladacycle Gen II precatalyst (Strem, CAS 1375325-68-0, 20.0 mg, 0.03 mmol), and water (3 mL) were subsequently added. The reaction mixture was stirred for 16 hours at 100° C., then cooled to ambient temperature, and diluted with water (10 mL). The resulting mixture was diluted with hexane (10 mL). After separating the two phases, the aqueous phase was extracted with dichloromethane (2×10 mL). The combined organic extracts were dried over MgSO₄, then concentrated to dryness. Purification by flash chromatography on silica gel (50% dichloromethane in hexane) afforded the product in 0.637 g (93.4%) as a mixture of two isomers. ¹H NMR (400 MHz, CDCl₃) δ 8.24 (s, 2H in A), 7.45-7.30 (m, 10H), 7.08 (s, 2H), 6.95 (s, 2H in B), 6.86-6.77 (m, 2H), 6.62 (s, 2H in B), 6.59 (s, 2H in A), 6.54 (s, 2H), 1.97-1.79 (m, 18H), 1.75-1.55 (m, 14H), 1.36 (br, 6H), 1.16 (s, 18H in B), 1.08 (s 18H in A), 0.71 (s, 9H).

### 4-(tert-butyl)thio-2,6-dichloropyridine

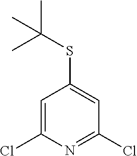

To a precooled, stirring solution of 2,6-dichloro-4-nitro-pyridine (0.300 g, 1.55 mmol) in tetrahydrofuran, sodium 2-methylpropane-2-thiolate (0.180 g, 1.61 mmol, 1.03 equiv.) was added. The reaction was stirred at room temperature for 3 hours. The reaction was allowed to settle, and the supernatant was decanted into a separate vial. The decantate was concentrated under a stream of nitrogen and then under high vacuum. The residue was extracted with pentane (10 mL) and filtered over Celite. The filtrate was concentrated under a stream of nitrogen and then under high vacuum to afford the product as a yellow oil which, upon cooling in a freezer, formed white-to-colorless crystals (0.246 g). The pentane-insoluble solid collected on Celite was extracted with dichloromethane (10 mL). The dichloromethane extract was concentrated under a stream of nitrogen and then under high vacuum to afford another fraction of the product as a pale yellow oil, which solidified once cooled in a freezer (0.053 g; 0.299 g total, 81% yield). ¹H NMR (400 MHz, C₆D₆): δ 6.98 (s, 2H), 0.91 (s, 9H).

### 2′,2′″-(4-tert-butyl)-thiopyridine-2,6-diyl)bis(3-(1-adamantanyl)-5-(tert-butyl)-[1,1′-biphenyl]-2-ol)

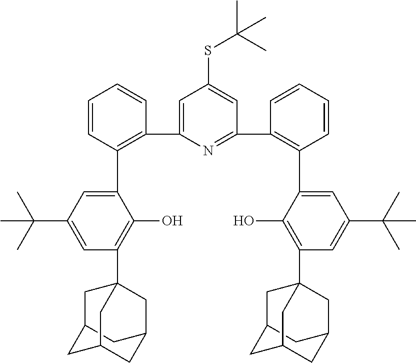 [SMILES: CC(C)(C)Sc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a stirring solution of 4-(tert-butyl)-thio-2,6-dichloropyridine (0.150 g, 0.635 mmol), 4-((1s,3s)-adamantan-1-yl)-2-(tert-butyl)-6-isopropoxy-6H-dibenzo[c,e][1,2]oxaborinine (0.544 g, 1.27 mmol, 2 equiv.), chloro(2-dicyclohexylphosphino-2′,6′-diisopropoxy-1,1′-biphenyl)[2-(2′-amino-1,1′-biphenyl)]palladium(II) (20 mg, 26 mol, 4 mol %), and cesium carbonate (1.24 g, 3.81 mmol, 6 equiv.) in 1,4-dioxane (6 mL), degassed water (3 mL) was added. The reaction was stirred and heated to reflux under nitrogen for 5 hours. The reaction was allowed to cool to room temperature. The reaction was poured into a beaker, washing the contents of the flask into the beaker with water (50 mL) and dichloromethane (50 mL). The contents of the beaker were poured into a separatory funnel, shaken, and the organic layer was extracted. The aqueous phase was further extracted with additional dichloromethane (2×20 mL). The combined organic extracts were washed with water, dried over anhydrous sodium sulfate, and filtered over a short pad of silica. The filtrate was concentrated in vacuo. The residue was stirred in pentane (2 mL) for 30 minutes, during which time a white solid precipitated. The suspension was filtered, and the white solid was collected and concentrated under high vacuum to afford the product as a white solid (0.504 g, 89% yield, mixture of diastereomers). ¹H NMR (400 MHz, C₆D₆), diastereomers integrated as one: δ 7.94 (s, 1H), 7.38-7.18 (m, 10H), 6.81 and 6.47 (d, J=2.3 Hz, and s, respectively, 3H total), 2.44-1.72 (m, 30H), 1.30-0.97 (27H).

### 4-(butylthio)-2,6-dichloropyridine

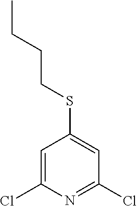

To a precooled, stirring solution of 2,6-dichloro-4-nitropyridine (0.300 g, 1.55 mmol) in tetrahydrofuran (4 mL), a solution of sodium butanethiolate (0.209 g, 95% pure, 1.8 mmol, 1.1 equiv.) in tetrahydrofuran (4 mL) was added. The reaction was stirred at room temperature for 1 hour. The reaction was concentrated under a stream of nitrogen and then under high vacuum. The residue was extracted with pentane (10 mL, then 5 mL) and filtered over Celite. The combined pentane extracts were concentrated under a stream of nitrogen and then under high vacuum to afford the product as a yellow oil (276 mg, 75% yield). ¹H NMR (400 MHz, C₆D₆): δ 6.53 (s, 2H), 2.05 (t, 2H, J=7.2 Hz), 1.17-1.07 (m, 2H), 1.07-0.96 (m, 2H), 0.65 (t, 3H, J=7.2 Hz).

### 2′,2′″-(4-(butylthio)-pyridine-2,6-diyl)bis(3-(1-adamantanyl)-5-(tert-butyl)-[1,1′-biphenyl]-2-ol)

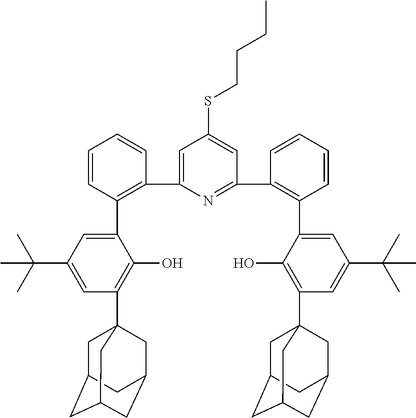 [SMILES: CCCCSc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a stirring mixture of 4-(butylthio)-2,6-dichloropyridine (81 mg, 0.34 mmol), 4-((1s,3s)-adamantan-1-yl)-2-(tert-butyl)-6-isopropoxy-6H-dibenzo[c,e][1,2]oxaborinine (294 mg, 0.69 mmol, 2 equiv.), cesium carbonate (671 mg, 2.06 mmol, 6 equiv.), and chloro(2-dicyclohexylphosphino-2′,6′-diisopropoxy-1,1′-biphenyl)[2-(2′-amino-1,1′-biphenyl)]palladium(II) (11 mg, 14 mol, 4 mol %) in dioxane (5 mL), degassed water (2.5 mL) was added. The reaction was stirred and heated to 100° C. for 5 hours. The reaction was allowed to cool to room temperature. The reaction was partitioned between dichloromethane (40 mL) and water (50 mL) in a separatory funnel. The organic extract was collected, and the aqueous phase was further extracted with additional dichloromethane (20 mL). The combined dichloromethane extracts were washed with water (50 mL), dried over anhydrous magnesium sulfate, and filtered. The filtrate was concentrated in vacuo. The crude solid was purified by silica gel column chromatography to afford the product (311 mg, quantitative yield, mixture of two diastereomers). ¹H NMR (400 MHz, C₆D₆), diastereomers integrated as one: δ 8.25 (s, 2H), 7.39-7.23 (m, 6H), 7.15-7.08 (m, 3H), 6.85-6.68 (m, 3H), 2.48-1.76 (m, 32H), 1.46-1.11 (m, 22H), 0.74 (t, 3H, J=7.3 Hz).

### Lithium Dodecanethiolate

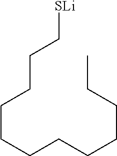

To a precooled, stirring solution of dodecanethiol (1.0 mL, 4.2 mmol) in diethyl ether (10 mL), n-butyllithium (1.6 mL, 2.71 M in hexane, 4.3 mmol, 1 equiv.) was added dropwise. The reaction was stirred at room temperature for 105 minutes. The reaction was filtered over a plastic, fritted funnel. The filtered solid was hexane (2×5 mL), collected, and concentrated under high vacuum to afford the product as a white solid (557 mg, 64% yield). ¹H NMR (400 MHz, C₄D₈O): δ 2.38 (t, 2H, J=7.3 Hz), 1.53-1.42 (m, 2H), 1.42-1.33 (m, 2H), 1.33-1.20 (m, 16H), 0.89 (t, 3H, J=6.6 Hz).

### 2,6-dichloro-4-dodecylthio-pyridine

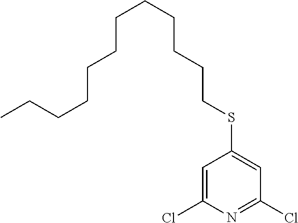 [SMILES: CCCCCCCCCCCCSc1cc(Cl)nc(Cl)c1]

To a precooled, stirring solution of 2,6-dichloro-4-nitropyridine (200 mg, 1.04 mmol) in tetrahydrofuran (10 mL), lithium dodecanethiolate (218 mg, 1.05 mmol, 1 equiv.) was added with additional tetrahydrofuran (5 mL). The reaction was stirred at room temperature for 16.5 hours. The reaction was concentrated under a stream of nitrogen and then under high vacuum. The residue was stirred in pentane (10 mL). The resulting yellow suspension was filtered over a plastic, fritted funnel, extracting further with additional pentane (10 mL). The combined pentane extracts were concentrated under a stream of nitrogen and then under high vacuum. The crude was purified by silica gel column chromatography to afford the product as an orange-red oil (143 mg, 39% yield). ¹H NMR (400 MHz, C₆D₆): δ 6.57 (s, 2H), 2.12 (t, 2H, J=7.3 Hz), 1.40-1.14 (m, 16H), 1.13-1.04 (m, 4H), 0.92 (t, 3H, J=7.0 Hz).

### 2′,2′″-(4-(dodecylthio)-pyridine-2,6-diyl)bis(3-(1-adamantanyl)-5-(tert-butyl)-[1,1′-biphenyl]-2-ol)

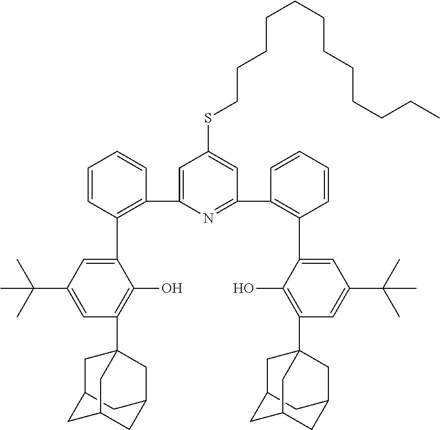 [SMILES: CCCCCCCCCCCCSc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a stirring mixture of 2,6-dichloro-4-(dodecylthio)pyridine (76 mg, 0.22 mmol), 4-((1s,3s)-adamantan-1-yl)-2-(tert-butyl)-6-isopropoxy-6H-dibenzo[c,e][1,2]oxaborinine (187 mg, 0.436 mmol, 2 equiv.), cesium carbonate (426 mg, 1.31 mmol, 6 equiv.), and chloro(2-dicyclohexylphosphino-2′,6′-diisopropoxy-1,1′-biphenyl)[2-(2′-amino-1,1′-biphenyl)]palladium(II) (7 mg, 9 mol, 4 mol %) in dioxane (4 mL), degassed water (2 mL) was added. The reaction was stirred and heated to 100° C. for 19.5 hours. The reaction was allowed to cool to room temperature. The reaction was partitioned between dichloromethane and water. The organic layer was collected, and the aqueous phase was extracted once more with dichloromethane. The combined dichloromethane extracts were dried over anhydrous sodium sulfate and filtered. The filtrate was concentrated in vacuo. The resulting foam was stirred in pentane. The solution was then reconcentrated in vacuo to afford the product as an amber foam (179 mg, 82% yield). ¹H NMR (400 MHz, C₆D₆), diastereomers integrated as one: δ 8.22 (s, 1H), 7.44-7.17 (m, 8H), 7.13-6.73 (m, 5H), 2.44-1.73 (m, 32H), 1.50-1.07 (m, 38H), 0.87 (t, 3H, J=7.1 Hz).

### 4-(4-(tert-butyl)phenyl)-2,6-dichloropyridine

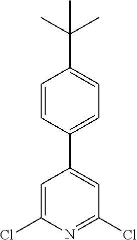 [SMILES: CC(C)(C)c1ccc(-c2cc(Cl)nc(Cl)c2)cc1]

To a solution of 1-bromo-4-tert-butyl-benzene (2.00 g, 9.38 mmol) in diethyl ether (50 mL), 5.86 mL of 1.6 M ⁿBuLi (9.38 mmol) in hexanes was added dropwise at ambient temperature. The reaction mixture was stirred at this temperature for 30 minutes. All volatiles were then removed under vacuo. The intermediate was isolated as a white solid (1.13 g, 8.03 mmol) which was then mixed with anhydrous ZnCl₂ (1.09 g, 8.03 mmol) in THF (10 mL). The mixture was stirred for 10 minutes followed by addition of 2,6-dichloro-4-iodo-pyridine (2.00 g, 7.3 mmol). The mixture was then cooled down to −20° C. After addition of Pd(P^{t}Bu₃)₂ (51.3 mg, 0.07 mmol), the mixture was stirred for 5 hours at 40° C. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (10%-30% dichloromethane in hexane) afforded the product in 40% yield (0.82 g). ¹H NMR (400 MHz, CDCl₃) δ 7.53 (s, 4H), 7.46 (s, 2H), 1.36 (s, 9H).

### 2′,2′″-(4-(4-(tert-butyl)phenyl)pyridine-2,6-diyl)bis(3-(1-adamantanyl)-5-(tert-butyl)-[1,1′-biphenyl]-2-ol)

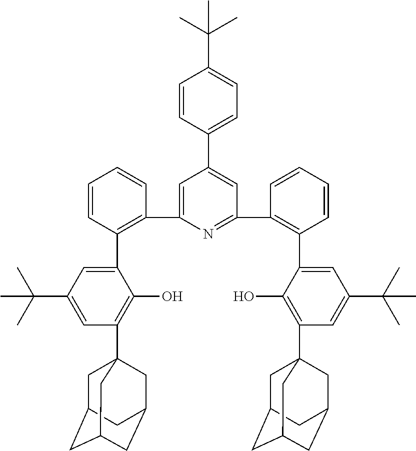 [SMILES: CC(C)(C)c1ccc(-c2cc(-c3ccccc3-c3cc(C(C)(C)C)cc(C45CC6CC(CC(C6)C4)C5)c3O)nc(-c3ccccc3-c3cc(C(C)(C)C)cc(C45CC6CC(CC(C6)C4)C5)c3O)c2)cc1]

To a solution of 4-(1-adamantanyl)-2-(tert-butyl)-6-isopropoxy-6H-dibenzo[c,e][1,2]oxaborinine (0.584 g, 1.36 mmol) in 1,4-dioxane (6 mL), 4-(4-(tert-butyl)phenyl)-2,6-dichloropyridine (0.191 g, 0.68 mmol), cesium carbonate (1.33 g, 4.09 mmol), Buchwald RuPhos Palladacycle Gen II precatalyst (Strem, CAS 1375325-68-0, 20.0 mg, 0.03 mmol), and water (3 mL) were subsequently added. The reaction mixture was stirred for 15 hours at 100° C., then cooled to ambient temperature, and diluted with water (10 mL). The resulting mixture was diluted with dichloromethane (20 mL). After separating the two phases, the aqueous phase was extracted with dichloromethane (2×10 mL). The combined organic extracts were dried over MgSO₄, then concentrated to dryness. The crude product was stirred in methanol until pure product precipitated as a white solid, which was then isolated by filtration to afford the product (0.573 g, 91%) as a mixture of two isomers. ¹H NMR (400 MHz, CDCl₃) δ 8.05 (s, 2H in A), 7.72-7.63 (m, 2H in A), 7.59-7.38 (m, 6H), 7.34 (d, J=8.2 Hz, 2H), 7.18 (s, 2H in B), 7.14 (s, 2H in A), 7.06 (s, 2H), 6.99 (d, J=8.1 Hz, 2H in A), 6.94 (s, 1H in B), 6.92 (s, 1H in B), 6.59 (s, 2H in A), 6.36 (s, 1H in B), 2.16-1.83 (m, 18H), 1.67 (br, 12H), 1.32 (s, 9H), 1.17 (s, 18H in B), 0.97 (s, 18H in A).

### 2,6-dibromoisonicotinic Acid

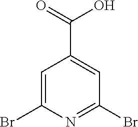 [SMILES: O=C(O)c1cc(Br)nc(Br)c1]

Citrazinic acid (3.0 g, 19.3 mmol) and phosphorus oxybromide (16.3 g, 58.0 mmol) were combined in a sealed round bottom flask and heated at 150° C. for 2 hours. Once cool, water was added and the mixture was stirred overnight. The suspension was extracted three times with ethyl acetate and the combined organic fractions were dried (MgSO₄), filtered, and concentrated to give the product as a tan solid in 83% yield. ¹H NMR (500 MHz, CDCl₃, δ): 8.06 (s, 2H).

### (2,6-dibromopyridin-4-yl)methanol

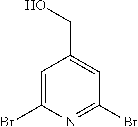

2,6-dibromoisonicotinic acid (1.1 g, 4.0 mmol) was dissolved in 15 mL of THF and cooled to 0° C. Borane-THF (10.1 mL, 1.0 M in THF) was added slowly and the reaction was stirred overnight at ambient temperature. The reaction was quenched with water, made basic with saturated sodium bicarbonate, and extracted with methylene chloride. The organic solution was dried (MgSO₄), filtered, and concentrated to give the product as a white solid in 69% yield. ¹H NMR (500 MHz, CDCl₃, δ): 4.29 (s, 2H), 7.47 (s, 2H).

### 4-(bromomethyl)-2,6-dibromopyridine

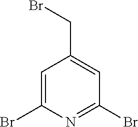

(2,6-dibromopyridin-4-yl)methanol (3.3 g, 12.3 mmol) was dissolved in 200 mL of dioxane. Phosphorus tribromide (2.2 mL, 13.6 mmol) was added, the reaction heated at 40° C. for 30 minutes, then at ambient temperature overnight. The reaction was quenched with saturated sodium bicarbonate and concentrated to remove the dioxane. The solution was extracted with methylene chloride, dried over MgSO₄, filtered, and concentrated to a white solid. ¹H NMR (500 MHz, CDCl₃, δ): 4.29 (s, 2H), 7.47 (s, 2H).

### 4-(N,N-diisopropylaminomethyl)-2,6-dibromopyridine

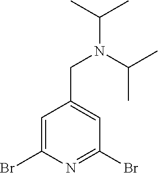 [SMILES: CC(C)N(Cc1cc(Br)nc(Br)c1)C(C)C]

4-(Bromomethyl)-2,6-dibromopyridine (343 mg, 1.0 mmol) and diisopropylamine (0.41 mL, 0.31 mmol) were dissolved in 5 mL of acetonitrile and heated at 60° C. overnight. The mixture was filtered and concentrated under reduced pressure. Pure product was obtained as a pale yellow solid by recyrstallization in isohexane in 82% yield. ¹H NMR (500 MHz, CDCl₃, δ): 1.01 (d, J=7.0 Hz, 12H), 2.99 (m, 2H), 3.58 (s, 2H), 7.48 (s, 2H).

### 2′,2′″-(4-(N,N-diisopropylaminomethyl)pyridine-2,6-diyl)bis(3-(1-adamantanyl)-5-(tert-butyl)-[1,1′-biphenyl]-2-ol)

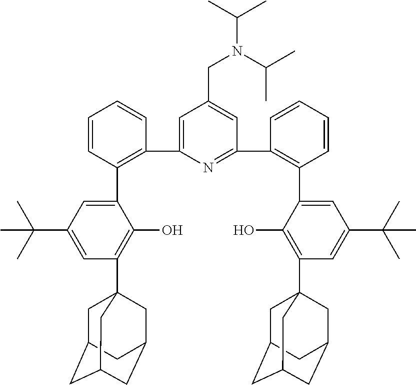 [SMILES: CC(C)N(Cc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1)C(C)C]

To a solution of 4-(1-adamantanyl)-2-(tert-butyl)-6-isopropoxy-6H-dibenzo[c,e][1,2]oxaborinine (0.142 g, 0.33 mmol) in 1,4-dioxane (4 mL), 4-(N,N-diisopropylaminomethyl)-2,6-dibromopyridine (0.058 g, 0.17 mmol), cesium carbonate (0.324 g, 1.00 mmol), Buchwald RuPhos Palladacycle Gen II precatalyst (Strem, CAS 1375325-68-0, 4.8 mg, 0.007 mmol), and water (2 mL) were subsequently added. The reaction mixture was stirred for 15 hours at 100° C., then cooled to ambient temperature, and diluted with water (2 mL). The resulting mixture was diluted with dichloromethane (10 mL). After separating the two phases, the aqueous phase was extracted with dichloromethane (2×5 mL). The combined organic extracts were dried over MgSO₄, then concentrated to dryness. The crude product was stirred in methanol until pure product precipitated as a white solid, which was then isolated by filtration to afford the product (0.121 g, 80%) as a mixture of two isomers. ¹H NMR (400 MHz, CDCl₃) δ 8.29 (s, 2H in A), 7.54-7.32 (m, 8H), 7.12 (s, 2H in B), 7.10-6.95 (m, 4H), 6.69 (s, 2H in B), 6.55 (d, J=2.4 Hz, 2H in A), 3.45-3.25 (m, 2H), 2.89 (tt, J=13.1, 6.5 Hz, 2H), 2.04-1.73 (m, 18H), 1.61 (br, 12H), 1.15 (s, 18H in B), 1.00 (s, 18H in A), 0.91 (q, J=6.5, 6.1 Hz, 12H).

### 2,6-dibromo-4-(4-methyl-2,6,7-trioxabicyclo[2.2.2]octan-1-yl)pyridine

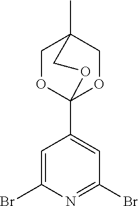 [SMILES: CC12COC(c3cc(Br)nc(Br)c3)(OC1)OC2]

2,6-Dibromoisonicotinic acid (886 mg, 3.1 mmol), (3-methyloxetan-3-yl)methanol (0.31 mL, 3.1 mmol), and dimethylaminopyridine (38 mg, 0.31 mmol) were dissolved in 10 mL of methylene chloride. Dicyclohexylcarbodiimide (715 mg, 3.4 mmol) in 2 mL of methylene chloride was added dropwise. Upon reaction completion as determined by TLC, the mixture was filtered and the filtrate washed with 10% HCl, saturated sodium bicarbonate, and water. It was then dried (MgSO₄), filtered, and concentrated. The crude oxetane ester (513 mg, 1.4 mmol) was redissolved in methylene chloride and cooled to −70° C. Borane trifluoride diethyl etherate (0.34 mL, 0.28 mmol) was added and the reaction stirred overnight. It was quenched with triethylamine (0.77 mL, 0.56 mmol), concentrated, redissolved in ether, then washed with water, dried over MgSO₄, filtered, and concentrated to a yellow solid. The product was obtained in 59% yield. ¹H NMR (500 MHz, CDCl₃, δ): 0.89 (s, 3H), 4.06 (s, 6H), 7.66 (s, 2H).

### 2′,2′″-(4-(4-methyl-2,6,7-trioxabicyclo[2.2.2]octan-1-yl)pyridine-2,6-diyl)bis(3-(1-adamantanyl)-5-(tert-butyl)-[1,1′-biphenyl]-2-ol)

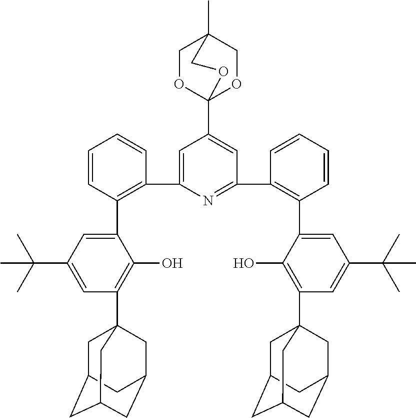 [SMILES: CC12COC(c3cc(-c4ccccc4-c4cc(C(C)(C)C)cc(C56CC7CC(CC(C7)C5)C6)c4O)nc(-c4ccccc4-c4cc(C(C)(C)C)cc(C56CC7CC(CC(C7)C5)C6)c4O)c3)(OC1)OC2]

To a solution of 4-(1-adamantanyl)-2-(tert-butyl)-6-isopropoxy-6H-dibenzo[c,e][1,2]oxaborinine (0.236 g, 0.55 mmol) in 1,4-dioxane (4 mL), 2,6-bromo-4-(4-methyl-2,6,7-trioxabicyclo[2.2.2]octan-1-yl)pyridine (0.100 g, 0.27 mmol), cesium carbonate (0.538 g, 1.64 mmol), Buchwald RuPhos Palladacycle Gen II precatalyst (Strem, CAS 1375325-68-0, 8.0 mg, 0.01 mmol), and water (2 mL) were subsequently added. The reaction mixture was stirred for 15 hours at 100° C., then cooled to ambient temperature, and diluted with water (2 mL). The resulting mixture was diluted with dichloromethane (10 mL). After separating the two phases, the aqueous phase was extracted with dichloromethane (2×5 mL). The combined organic extracts were dried over MgSO₄, then concentrated to dryness. The crude product was stirred in methanol until pure product precipitated as a white solid, which was then isolated by filtration to afford the product (0.211 g, 83%) as a mixture of two isomers. ¹H NMR (400 MHz, CDCl₃) δ 8.18 (s, 2H in A), 7.59-7.37 (m, 8H), 7.33 (s, 2H in B), 7.31 (d, J=2.4 Hz, 2H in B), 7.22 (s, 2H in A), 7.09 (br, 2H), 6.61 (d, J=8.4 Hz, 2H in B), 6.50 (s, 2H in A), 2.16-1.79 (m, 18H), 1.68 (s, 12H), 1.15 (s, 18H in B), 1.02 (s, 18H in A), 0.86 (s, 3H).

### 2,6-dibromo-4-((p-tolyloxy)methyl)pyridine

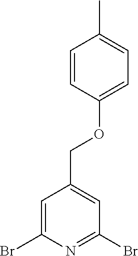 [SMILES: Cc1ccc(OCc2cc(Br)nc(Br)c2)cc1]

4-(Bromomethyl)-2,6-dibromopyridine (300 gm, 0.9 mmol), p-cresol (108 mg, 1.0 mmol), and cesium carbonate (595 mg, 1.8 mmol) were combined in 5 mL of acetonitrile and heated at 60° C. The mixture turned deep blue after 1 hour, but TLC indicated incomplete reaction. An additional portion of p-cresol was added and the reaction stirred at ambient temperature over the weekend. The mixture was filtered and concentrated under reduced pressure. The product was purified by silica gel chromatography (10% acetone/isohexane). ¹H NMR (500 MHz, CDCl₃, δ): 2.37 (s, 3H), 5.00 (s, 2H), 6.81 (m, 2H), 7.11 (m, 2H), 7.53 (s, 2H).

### 2′,2′″-(4-((p-tolyloxy)methyl)pyridine-2,6-diyl)bis(3-(1-adamantanyl)-5-(tert-butyl)-[1,1′-biphenyl]-2-ol)

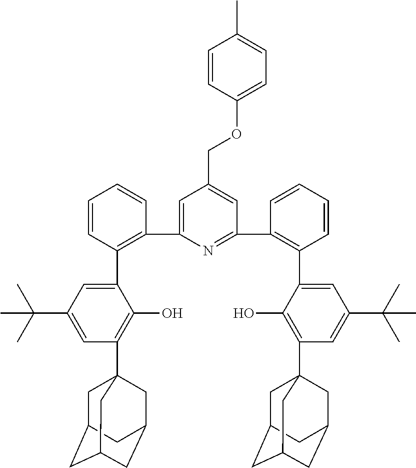 [SMILES: Cc1ccc(OCc2cc(-c3ccccc3-c3cc(C(C)(C)C)cc(C45CC6CC(CC(C6)C4)C5)c3O)nc(-c3ccccc3-c3cc(C(C)(C)C)cc(C45CC6CC(CC(C6)C4)C5)c3O)c2)cc1]

To a solution of 4-(1-adamantanyl)-2-(tert-butyl)-6-isopropoxy-6H-dibenzo[c,e][1,2]oxaborinine (0.236 g, 1.18 mmol) in 1,4-dioxane (4 mL), 2,6-dibromo-4-((p-tolyloxy)methyl) pyridine (0.211 g, 0.59 mmol), cesium carbonate (1.16 g, 3.55 mmol), Buchwald RuPhos Palladacycle Gen II precatalyst (Strem, CAS 1375325-68-0, 8.6 mg, 0.01 mmol), and water (2 mL) were subsequently added. The reaction mixture was stirred for 15 hours at 100° C., then cooled to ambient temperature, and diluted with water (2 mL). The resulting mixture was diluted with dichloromethane (10 mL). After separating the two phases, the aqueous phase was extracted with dichloromethane (2×5 mL). The combined organic extracts were dried over MgSO₄, then concentrated to dryness. The crude product was stirred in methanol until pure product precipitated as a white solid, which was then isolated by filtration to afford the product (0.497 g, 92%) as a mixture of three isomers. ¹H NMR (400 MHz, CDCl₃) δ 8.20 (dd, J=14.7, 8.1 Hz, 2H in C), 8.06 (s, 2H in A), 7.66 (dd, J=6.1, 3.0 Hz, 8H in C), 7.58-7.31 (m, 8H in A and B), 7.18 (d, J=2.5 Hz, 2H in B), 7.14 (d, J=8.2 Hz, 4H in B), 7.11-7.02 (m, 4H in A), 7.00 (s, 2H in A), 6.96 (d, J=8.5 Hz, 4H in C), 6.91 (d, J=2.4 Hz, 2H in B), 6.88 (d, J=2.4 Hz, 2H in C), 6.75-6.69 (m, 2H in A), 6.67 (s, 2H in B), 6.64 (s, 2H in C), 6.53 (d, J=2.3 Hz, 2H in A), 6.50 (s, 2H in B), 6.43 (s, 2H in C), 4.80-4.62 (m, 2H), 2.28 (s, 3H), 2.19-1.76 (m, 18H), 1.77-1.60 (m, 12H), 1.22 (s, 18H in C), 1.14 (s, 18H in B), 1.00 (s, 18H in C).

### 2,6-dichloro-4-(n-butyldimethylsilyl)pyridine

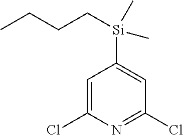

Solutions of iso-propylmagnesium chloride lithium chloride complex in THF (1.3 M, 2.95 mL, 3.83 mmol) and 2,6-dichloro-4-iodopyridine (1.00 g, 3.65 mmol) in THF (5 mL) were separately cooled in a cooling bath under −40° C. for 10 minutes. The chilled solution of iso-propylmagnesium chloride lithium chloride complex was then slowly added to the solution of 2,6-dichloro-4-iodopyridine, which was then stirred at −40° C. for 15 minutes. n-butyldimethylsilyl chloride (0.550 g, 3.65 mmol) was then added. The reaction mixture was stirred at −40° C. for 20 minutes, then stirred at ambient temperature for 16 hours. The reaction was quenched with water (5 mL). The resulting mixture was diluted with hexane (10 mL). After separating the two phases, the aqueous phase was extracted with dichloromethane (2×10 mL). The combined organic extracts were dried over MgSO₄, then concentrated. The crude product was filtered on a silica pad. Pure product (0.780 g, 81%) was isolated as clear oil after solvent removal. ¹H NMR (400 MHz, CDCl₃) δ 7.29 (s, 2H), 1.41-1.18 (m, 4H), 0.87 (t, J=7.1 Hz, 3H), 0.81-0.69 (m, 2H), 0.28 (s, 6H).

### 2′,2′″-(4-(n-butyldimethylsilyl)pyridine-2,6-diyl)bis(3-(1-adamantanyl)-5-(tert-butyl)-[1,1′-biphenyl]-2-ol)

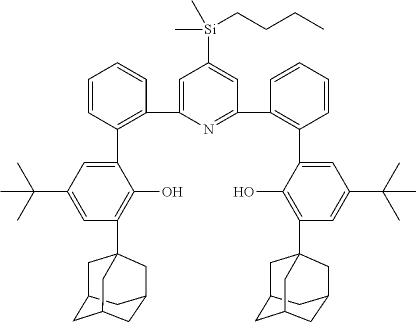 [SMILES: CCCC[Si](C)(C)c1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.653 g, 1.53 mmol) in 1,4-dioxane (6 mL), 2,6-dichloro-4-(n-butyldimethylsilyl)pyridine (0.200 g, 0.76 mmol), cesium carbonate (1.49 g, 4.58 mmol), Buchwald RuPhos Palladacycle Gen II precatalyst (Strem, CAS 1375325-68-0, 22.0 mg, 0.03 mmol), and water (3 mL) were subsequently added. The reaction mixture was stirred for 5 hours at 100° C., then cooled to ambient temperature, and diluted with water (10 mL). The resulting mixture was diluted with dichloromethane (20 mL). After separating the two phases, the aqueous phase was extracted with dichloromethane (2×10 mL). The combined organic extracts were dried over MgSO₄, then concentrated to dryness. The crude product was dissolved in ethanol at 80° C. The resulting solution was then stored under −20° C. for 2 hours, then filtered to afford the product (0.64 g, 92%) as a mixture of two isomers. ¹H NMR (400 MHz, CDCl₃) δ 8.09 (s, 2H in A), 7.60-7.34 (m, 8H), 7.11 (s, 2H in B), 7.07 (s, 2H in A), 7.01 (s, 2H), 6.92 (s, 2H in B), 6.55 (s, 2H in A), 6.41 (s, 2H in B), 2.11-1.79 (m, 18H), 1.65 (br, 12H), 1.38-1.21 (m, 4H), 1.17 (s, 18H in B), 0.98 (s, 18H in A), 0.84 (t, J=7.5 Hz, 3H), 0.50 (d, J=9.0 Hz, 2H), 0.01 (s, 6H in B), −0.03 (s, 6H in A).

### Lithium[(1R,2S,5R)-2-isopropyl-5-methyl-cyclohexan-1-olate]

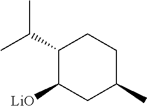

To a precooled, stirring solution of L-menthol (1.057 g, 6.76 mmol) in diethyl ether (50 mL), n-butyllithium (4.2 mL, 1.64 M in hexane, 6.9 mmol, 1 equiv.) was added. The reaction was stirred at room temperature for 3 hours. The reaction was concentrated under a stream of nitrogen and then under high vacuum to afford the product as a white solid (1.117 g, quantitative yield). ¹H NMR (400 MHz, C₄D₈O): δ 3.27 (td, 1H, J=9.7, 4.0 Hz), 2.33 (pd, 1H, J=6.9, 2.3 Hz), 1.89 (dtd, 1H, J=12.2, 3.6, 2.2 Hz), 1.62 (dt, 1H, J=12.4, 3.1 Hz), 1.50 (dq, 1H, J=12.6, 3.2 Hz), 1.45-1.25 (m, 1H), 1.00-0.84 (m, 7H), 0.84-0.71 (m, 6H).

### 2,6-dichloro-4-(((1R,2S,5R)-2-isopropyl-5-methyl-cyclohexyl)oxy)pyridine

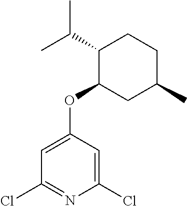 [SMILES: CC(C)[C@@H]1CC[C@@H](C)C[C@H]1Oc1cc(Cl)nc(Cl)c1]

To a precooled, stirring solution of 2,6-dichloro-4-nitropyridine (433 mg, 2.24 mmol, 1 equiv.) in tetrahydrofuran, lithium[(1R,2S,5R)-2-isopropyl-5-methyl-cyclohexan-1-olate](364 mg, 2.24 mmol) was added. The reaction was stirred at room temperature for 3 hours. The reaction was concentrated under a stream of nitrogen and then under high vacuum. The residue was stirred in pentane (15 mL). The resulting suspension was filtered over Celite. The filtrate was concentrated under a stream of nitrogen and then under high vacuum to afford the product as a yellow oil (566 mg, 83% yield). ¹H NMR (400 MHz, C₆D₆): δ 6.53 (s, 2H), 3.62 (td, 1H, J=10.6, 4.3 Hz), 1.91 (heptd, 1H, J=7.0, 2.8 Hz), 1.68 (dtd, 1H, J=12.3, 3.7, 1.8 Hz), 1.44-1.34 (m, 2H), 1.31-1.17 (m, 1H), 0.98-0.85 (m, 1H), 0.79 (d, 3H, J=7.1 Hz), 0.75-0.65 (m, 5H), 0.62-0.54 (m, 4H).

### 2′,2′″-((4-(((1R,2S,5R)-2-isopropyl-5-methylcyclohexyl)oxy)pyridine)-2,6-diyl)bis(3-(1-adamantanyl)-5-(tert-pentyl)-[1,1′-biphenyl]-2-ol)

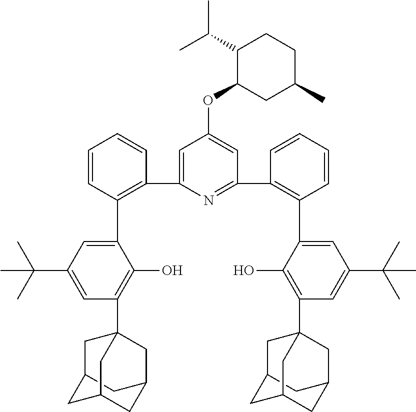

To a stirring mixture of 2,6-dichloro-4-(((1R,2S,5R)-2-isopropyl-5-methyl-cyclohexyl)oxy)pyridine (148 mg, 0.490 mmol), 4-((1s,3s)-adamantan-1-yl)-2-(tert-butyl)-6-isopropoxy-6H-dibenzo[c,e][1,2]oxaborinine (420 mg, 0.979 mmol, 2 equiv.), cesium carbonate (957 mg, 2.94 mmol, 6 equiv.), and chloro(2-dicyclohexylphosphino-2′,6′-diisopropoxy-1,1′-biphenyl)[2-(2′-amino-1,1′-biphenyl)]palladium(II) (15 mg, 19 mol, 4 mol %) in dioxane (5 mL), degassed water (2.5 mL) was added. The reaction was stirred and heated to 100° C. for 4.5 hours. The reaction was allowed to cool to room temperature. The reaction was partitioned between dichloromethane (50 mL) and water (50 mL) in a separatory funnel. The organic phase was collected, and the aqueous phase was extracted further with additional dichloromethane (20 mL). The combined organic phases were filtered over a thin pad of silica. The filtrate was concentrated in vacuo. The crude was stirred with pentane (5 mL), and the resulting solution was concentrated under a stream of nitrogen and then under high vacuum to afford the product (441 mg, 94% yield, mixture of diastereomers). ¹H NMR (400 MHz, C₆D₆), diastereomers integrated as one: δ 8.69-8.53 (m, 1H), 7.47-7.19 (m, 7H), 7.14-7.08 (m, 3H), 6.86-6.53 (m, 3H), 3.92-3.70 (m, 1H), 2.44-1.72 (m, 31H), 1.58-0.96 (m, 24H), 0.95-0.58 (11H).

### 2′,2′″-(4-ethoxypyridine-2,6-diyl)bis(3-(1-adamantanyl)-5-(tert-butyl)-[1,1′-biphenyl]-2-ol)

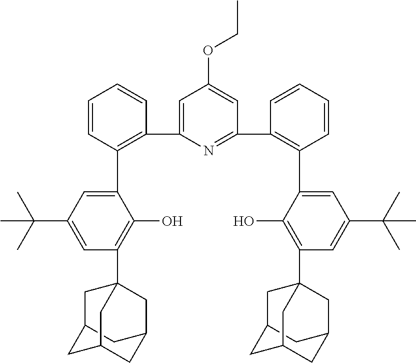 [SMILES: CCOc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a stirring mixture of 2,6-dichloro-4-ethoxy-pyridine (50 mg, 0.26 mmol), 4-((1s,3s)-adamantan-1-yl)-2-(tert-butyl)-6-isopropoxy-6H-dibenzo[c,e][1,2]oxaborinine (223 mg, 0.521 mmol, 2 equiv.), cesium carbonate (509 mg, 1.56 mmol, 6 equiv.), and chloro(2-dicyclohexylphosphino-2′,6′-diisopropoxy-1,1′-biphenyl)[2-(2′-amino-1,1′-biphenyl)]palladium(II) (8 mg, 10 mol, 4 mol %) in 1,4-dioxane (4 mL), degassed water (2 mL) was added. The reaction was stirred and heated to 100° C. for 6 hours. The reaction was allowed to cool to room temperature. The reaction was partitioned between dichloromethane (50 mL) and water (50 mL) in a separatory funnel. The organic extract was collected, and the aqueous phase was further extracted with additional dichloromethane (20 mL). The combined organic extracts were filtered over a thin pad of silica. The filtrate was concentrated in vacuo. The residue was stirred in pentane (5 mL). The resulting solution was then concentrated under a stream of nitrogen and then under high vacuum to afford the product as a white solid (128 mg, 58% yield, mixture of diastereomers). ¹H NMR (400 MHz, C₆D₆), diastereomers integrated as one: δ 8.40 (s, 2H), 7.45-7.10 (m, 8H), 6.81 (d, 2H, J=2.4 Hz), 6.41 (s, 2H), 3.34-3.10 (m, 2H), 2.32-1.97 (m, 18H), 1.88-1.73 (m, 12H), 1.29/1.14 (two singlets, 18H), 0.95 (t, 3H, J=7.0 Hz).

### 2,6-dichloro-3-(n-butyldimethylsilyl)pyridine

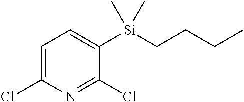

Solutions of iso-propylmagnesium chloride lithium chloride complex in THF (1.3 M, 2.84 mL, 3.70 mmol) and 2,6-dichloro-3-iodopyridine (0.964 g, 3.52 mmol) in THF (5 mL) were separately cooled in a cooling bath under −40° C. for 10 minutes. The chilled solution of iso-propylmagnesium chloride lithium chloride complex was then slowly added to the solution of 2,6-dichloro-3-iodopyridine, which was then stirred at −40° C. for 15 minutes. n-butyldimethylsilyl chloride (0.530 g, 3.52 mmol) was then added. The reaction mixture was stirred at −40° C. for 20 minutes, then stirred at ambient temperature for 16 hours. The reaction was quenched with water (5 mL). The resulting mixture was diluted with hexane (10 mL). After separating the two phases, the aqueous phase was extracted with dichloromethane (2×10 mL). The combined organic extracts were dried over MgSO₄, then concentrated. The crude product was filtered on a silica pad. Pure product (0.910 g, 98%) was isolated as a clear oil after solvent removal. ¹H NMR (400 MHz, CDCl₃) δ 7.68 (d, J=7.7 Hz, 1H), 7.23 (d, J=7.7 Hz, 1H), 1.39-1.15 (m, 4H), 0.95-0.80 (m, 5H), 0.35 (s, 6H).

### 2′,2′″-(3-(n-butyldimethylsilyl)pyridine-2,6-diyl)bis(3-(1-adamantanyl)-5-(tert-butyl)-[1,1′-biphenyl]-2-ol)

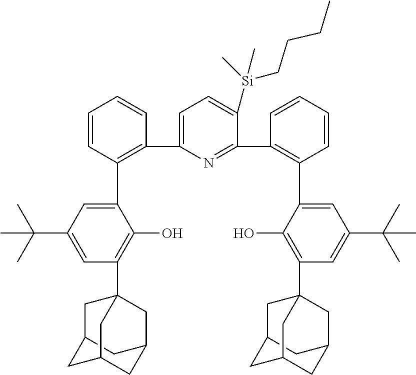 [SMILES: CCCC[Si](C)(C)c1ccc(-c2ccccc2-c2cc(C(C)(C)C)cc(C34CC5CC(CC(C5)C3)C4)c2O)nc1-c1ccccc1-c1cc(C(C)(C)C)cc(C23CC4CC(CC(C4)C2)C3)c1O]

To a solution of 4-(1-adamantanyl)-2-(tert-butyl)-6-isopropoxy-6H-dibenzo[c,e][1,2]oxaborinine (0.653 g, 1.53 mmol) in 1,4-dioxane (6 mL), 2,6-dichloro-3-(n-butyldimethylsilyl)pyridine (0.200 g, 0.76 mmol), cesium carbonate (1.49 g, 4.58 mmol), Buchwald RuPhos Palladacycle Gen II precatalyst (Strem, CAS 1375325-68-0, 22.0 mg, 0.03 mmol), and water (3 mL) were subsequently added. The reaction mixture was stirred for 5 hours at 100° C., then cooled to ambient temperature, and diluted with water (10 mL). The resulting mixture was diluted with dichloromethane (20 mL). After separating the two phases, the aqueous phase was extracted with dichloromethane (2×10 mL). The combined organic extracts were dried over MgSO₄, then concentrated to dryness. The crude product was dissolved in ethanol at 80° C. The resulting solution was then stored under −20° C. for 2 hours, then filtered to afford the product (0.64 g, 92%) as a mixture of two isomers. ¹H NMR (400 MHz, CDCl₃) δ 8.18 (d, J=8.3 Hz, 1H in B), 8.05 (d, J=2.4 Hz, 1H in A), 7.76-7.31 (m, 8H), 7.31-7.22 (m, 1H), 7.18 (d, J=7.9 Hz, 1H), 7.10 (d, J=2.5z Hz, 1H), 6.72 (d, J=2.4 Hz, 1H), 6.12 (d, J=6.7 Hz, 2H), 2.43-1.58 (m, 30H), 1.41 (s, 18H in B), 1.39-1.19 (m, 4H), 1.12 (s, 18H in A), 0.84 (t, J=7.2 Hz, 3H), 0.66-0.43 (m, 2H), −0.01 (d, J=8.4 Hz, 6H).

### 2,6-dichloro-4-(hept-1-yn-1-yl)pyridine

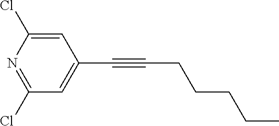

1-Heptyne (0.372 g, 3.87 mmol), diisopropylamine (1.85 g, 18.3 mmol), CuI (0.07 g, 0.37 mmol) and PdCl₂(PPh₃)₂ (0.13 g, 0.18 mmol) were successively added to a stirred solution of 2,6-dichloro-4-iodopyridine (1.00 g, 3.65 mmol) in degassed THF (20 mL). The reaction mixture was stirred for 12 hours at room temperature. The reaction was then quenched with water (1 ml) and the organic phase was filtered through celite. Purification by flash chromatography on silica gel (hexane/DCM 9:1) afforded the product as a yellow oil (0.74 g, 84%). ¹H NMR (400 MHz, CDCl₃) 7.21 (s, 2H), 2.42 (t, J=7.1 Hz, 2H), 1.66-1.52 (m, 2H), 1.47-1.25 (m, 4H), 0.92 (t, J=7.1 Hz, 3H).

### 2′,2′″-(4-(hept-1-yn-1-yl)pyridine-2,6-diyl)bis(3-(1-adamantanyl)-5-(tert-butyl)-[1,1′-biphenyl]-2-ol)

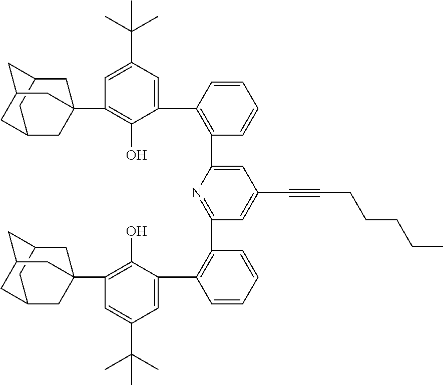 [SMILES: CCCCCC#Cc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2]oxaborinine (0.743 g, 1.73 mmol) in 1,4-dioxane (6 mL), 2,6-dichloro-4-(hept-1-yn-1-yl)pyridine (0.210 g, 0.86 mmol), cesium carbonate (1.70 g, 5.20 mmol), Buchwald RuPhos Palladacycle Gen II precatalyst (Strem, CAS 1375325-68-0, 12.0 mg, 0.02 mmol), and water (3 mL) were subsequently added. The reaction mixture was stirred for 15 hours at 100° C., then cooled to ambient temperature, and diluted with water (10 mL). The resulting mixture was diluted with dichloromethane (20 mL). After separating the two phases, the aqueous phase was extracted with dichloromethane (2×10 mL). The combined organic extracts were dried over MgSO₄, then concentrated to dryness. The crude product was eluted through silica gel by 20% dichlromethane in hexane to afford the product (0.43 g, 56%) as a mixture of two isomers. ¹H NMR (400 MHz, CDCl₃) δ 8.03 (s, 2H in A), 7.59-7.31 (m, 8H), 7.12 (d, J=2.4 Hz, 2H), 7.00 (s, 2H in B), 6.92 (s, 2H), 6.56 (d, J=2.3 Hz, 2H), 2.35 (t, J=7.0 Hz, 2H), 2.09-1.82 (m, 18H), 1.70 (d, J=4.3 Hz, 12H), 1.59-1.52 (m, 2H), 1.44-1.25 (m, 4H), 1.19 (s, 18H in B), 1.05 (s, 18H in A), 0.92 (t, J=6.8 Hz, 3H).

### 2,6-dichloroisonicotinic Acid

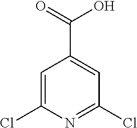 [SMILES: O=C(O)c1cc(Cl)nc(Cl)c1]

Citrazinic acid (10.3 g, 66.7 mmol) and triethylammonium chloride (11.0 g, 66.7 mmol) were dissolved in 20 mL of phosphoroxychloride in a heavy walled round bottom flask. The flask was sealed and heated at 100° C. overnight. Once cool, the mixture was poured onto ice and extracted three times with ethyl acetate. The combined organic layers were washed with brine, dried (MgSO₄), filtered, and concentrated to give a pink solid in 81% yield. Using 0.1 equivalent of triethylammonium chloride gave the product in 69% yield. ¹H NMR (500 MHz, CDCl₃, δ): 7.87 (s, 2H).

### (2,6-dichloropyridin-4-yl)methanol

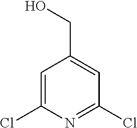

2,6-dichloroisonicotinic acid (8.94 g, 46.5 mmol) was dissolved in 50 mL of THF and cooled to 0° C. Borane-THF (116 mL, 1.0 M in THF) was added slowly and the reaction stirred overnight at ambient temperature. The reaction was quenched with water, made basic with saturated sodium bicarbonate, and extracted with methylene chloride. The organic solution was dried (MgSO₄), filtered, and concentrated to give the product as a white solid in 910% yield.

### 2,6-dichloroisonicotinaldehyde

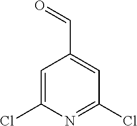

(2,6-dichloropyridin-4-yl)methanol (540 mg, 3.0 mmol) was dissolved in 5 mL of methylene chloride. Dess-Martin Periodinane (1.5 g, 3.6 mmol) was added and the reaction was stirred at ambient temperature for 3 hours. The mixture was concentrated then purified by silica gel column chromatography (30% acetone/isohexane) to give the aldehyde in 70% yield. ¹H NMR (500 MHz, CDCl₃, δ): 7.67 (s, 2H), 10.00 (s, 1H).

### 8-(2,6-dichloropyridin-4-yl)-1,5-diazabicyclo[3.2.1]octane

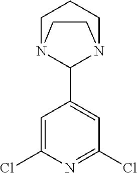 [SMILES: Clc1cc(C2N3CCCN2CC3)cc(Cl)n1]

2,6-dichloroisonicotinaldehyde (240 mg, 1.3 mmol) and 1,4-diazepane (136 mg, 1.3 mmol) were dissolved in 10 mL ethanol and stirred at ambient temperature overnight. The solution was concentrated to an oil, then purified by column chromatography (30% acetone/isohexane). The product was obtained as a white solid in 57% yield. Rf=0.29 (30:70 acetone/isohexane); ¹H NMR (500 MHz, CDCl₃, δ): 1.20 (m, 1H), 1.93 (m, 1H), 2.57 (m, 2H), 2.97 (m, 2H), 3.07 (m, 2H), 3.30 (m, 2H), 4.87 (s, 1H), 7.49 (s, 2H); 13C NMR: 18.4, 49.9 (2C), 55.8 (2C), 86.8, 120.9 (2C), 150.7 (2C), 154.9.

### Prophetic Synthesis of 2′,2′″-(4-(1,5-diazabicyclo[3.2.1]octan-8-yl)pyridine-2,6-diyl)bis(3-(1-adamantanyl)-5-(tert-butyl)-[1,1′-biphenyl]-2-ol)

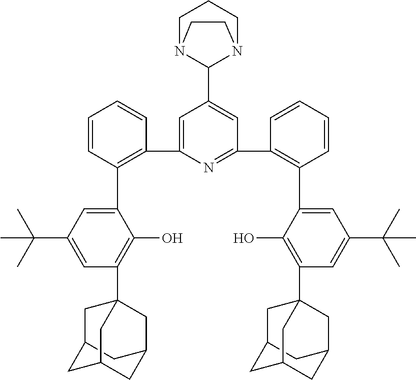 [SMILES: CC(C)(C)c1cc(-c2ccccc2-c2cc(C3N4CCCN3CC4)cc(-c3ccccc3-c3cc(C(C)(C)C)cc(C45CC6CC(CC(C6)C4)C5)c3O)n2)c(O)c(C23CC4CC(CC(C4)C2)C3)c1]

To a solution of 4-(1-adamantanyl)-2-(tert-butyl)-6-isopropoxy-6H-dibenzo[c,e][1,2]oxaborinine (0.236 g, 0.55 mmol) in 1,4-dioxane (4 mL), 8-(2,6-dichloropyridin-4-yl)-1,5-diazabicyclo[3.2.1]octane (0.070 g, 0.27 mmol), cesium carbonate (0.538 g, 1.64 mmol), Buchwald RuPhos Palladacycle Gen II precatalyst (Strem, CAS 1375325-68-0, 8.0 mg, 0.01 mmol), and water (2 mL) are subsequently added. The reaction mixture is stirred for 15 hours at 100° C., then cooled to ambient temperature, and diluted with water (2 mL). The resulting mixture is diluted with dichloromethane (10 mL). After separating the two phases, the aqueous phase is extracted with dichloromethane (2×5 mL). The combined organic extracts are dried over MgSO₄, then concentrated to dryness. The crude product is stirred in methanol until pure product was precipitated as a white solid, which is then filtered to afford the product.

### 1,3,5-Trimethyladamantane

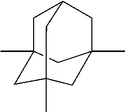

In a Parr pressure reactor, to a solution of 15.0 g (62.0 mmol) of 1-bromo-3,5-dimethyladamantane in 80 ml of diethyl ether, 22.3 ml (64.0 mmol) of 2.9 M MeMgBr in diethyl ether was added in one portion. The resulting solution was heated to 105° C. and stirred overnight at this temperature. After that, the reactor was cooled to room temperature, and pressure was released. Further on, 100 ml of 10% HCl was carefully added. The obtained mixture was extracted with diethyl ether (3×30 ml), the combined organic extract was dried over Na₂SO₄, and then evaporated to dryness. Yield 11.3 g (99%) of a colorless oil. ¹H NMR (CDCl₃, 400 MHz): δ 1.98-2.03 (m, 1H), 1.25-1.28 (m, 6H), 1.00-1.12 (m, 6H), 0.78 (s, 9H). ¹³C NMR (CDCl₃, 100 MHz) δ 51.1, 43.2, 31.4, 30.7, 30.0.

### 3,5,7-Trimethyladamantan-1-ol

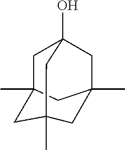

To a solution of 11.3 g (62.0 mmol) of 1,3,5-trimethyladamantane in 70 ml of acetonitrile, 103 ml of water, 70 ml of carbon tetrachloride, 55.0 g (255 mmol) of sodium periodate, and 330 mg (1.28 mmol) of RuCl₃(H₂O)ₓ were subsequently added. The resulting suspension was stirred for 12 hours at 60° C., then cooled to room temperature and diluted with 50 ml of water. The obtained mixture was extracted with dichloromethane (3×50 ml), the combined organic extract was dried over Na₂SO₄, and then evaporated to dryness. The residue was purified using Kugelrohr apparatus (1 mbar, 100° C.). Yield 12.1 g (96%) of a white crystalline solid. ¹H NMR (CDCl₃, 400 MHz): δ 1.44 (br.s, 1H), 1.30 (s, 6H), 0.97-1.15 (m, 6H), 0.88 (s, 9H). ¹³C NMR (CDCl₃, 100 MHz) δ 70.5, 50.7, 49.8, 34.1, 29.5.

### 4-Methyl-2-(3,5,7-trimethyladamantane-1-yl)phenol

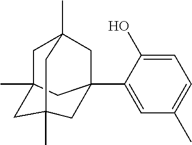

To a solution of 20.8 g (192 mmol) of 4-methylphenol and 18.7 g (96.3 mmol) of 3,5,7-trimethyladamantan-1-ol in 100 ml of dichloromethane, 5.8 ml of sulfuric acid (96%) was added dropwise for 30 minutes at room temperature. The resulting mixture was stirred for 30 minutes at room temperature and then carefully poured into 300 ml of 3% ammonia. The crude product was extracted with dichloromethane (3×50 ml), the combined organic extract was dried over Na₂SO₄, and then evaporated to dryness. The residue was purified using Kugelrohr apparatus (0.3 mbar, 160° C.) yielding 23.1 g (84%) of the title product as a white crystalline solid. ¹H NMR (CDCl₃, 400 MHz): δ 7.04 (d, J=2.1 Hz, 1H), 6.86 (ddd, J=7.9, 2.2, 0.6 Hz, 1H), 6.55 (d, J=7.9 Hz), 4.52 (s, 1H), 2.29 (s, 3H), 1.67 (s, 6H), 1.10-1.18 (m, 6H), 0.90 (s, 9H). ¹³C NMR (CDCl₃, 100 MHz): δ 151.9, 135.2, 129.7, 127.7, 127.0, 116.6, 50.4, 46.1, 39.1, 32.1, 30.6, 20.9.

### 2-Bromo-4-methyl-6-(3,5,7-trimethyladamantan-1-yl)phenol

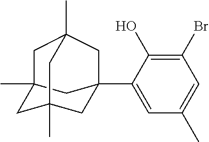

To a solution of 8.97 g (31.5 mmol) of 4-methyl-2-(3,5,7-trimethyladamantan-1-yl)phenol in 90 ml of dichloromethane, 5.04 g (31.5 mmol) of bromine was added dropwise at room temperature. The resulting mixture was stirred for 12 hours at room temperature and then carefully poured into 200 ml of 5% NaHCO₃. The crude product was extracted with dichloromethane (3×50 ml), the combined organic extract was dried over Na₂SO₄, and then evaporated to dryness. Yield 11.4 g (99%) of a white solid. ¹H NMR (CDCl₃, 400 MHz): δ 7.17 (d, J=2.0 Hz, 1H), 6.99 (d, J=2.0 Hz, 1H), 5.65 (s, 1H), 2.28 (s, 3H), 1.67 (s. 6H), 1.10-1.21 (m, 6H), 0.91 (s, 9H). ¹³C NMR (CDCl₃, 100 MHz): δ 148.1, 136.5, 130.3, 129.4, 127.3, 112.1, 50.3, 45.8, 39.9, 32.1, 30.5, 20.6.

### 1-(3-Bromo-2-(methoxymethoxy)-5-methylphenyl)-3,5,7-trimethyladamantane

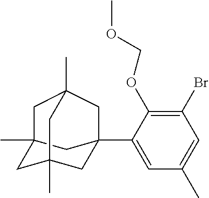

To a solution of 11.4 g (31.4 mmol) of 2-bromo-4-methyl-6-(3,5,7-trimethyladamantan-1-yl)phenol in 100 ml of dry THF, 1.06 g (34.9 mmol, 60% wt. in mineral oil) of sodium hydride was added at room temperature. After that, 2.65 ml (34.9 mmol) of methoxymethyl chloride was added in one portion. The reaction mixture was heated for 24 hours at 60° C. and then poured into 130 ml of cold water. The crude product was extracted with 3×20 ml of dichloromethane. The combined organic extract was dried over Na₂SO₄, and then evaporated to dryness. Yield 11.9 g (91%) of a yellowish solid. ¹H NMR (CDCl₃, 400 MHz): δ 7.25 (d, J=2.0 Hz, 1H), 7.06 (d, J=2.0 Hz, 1H), 5.23 (s, 2H), 3.71 (s, 3H), 2.29 (s, 3H), 1.68 (s, 6H), 1.10-1.21 (m, 6H), 0.92 (s, 9H). ¹³C NMR (CDCl₃, 100 MHz): δ 151.3, 144.0, 134.4, 131.9, 127.4, 117.6, 99.9, 57.8, 50.2, 46.8, 40.3, 32.2, 30.6, 20.7.

### 2-(2-(Methoxymethoxy)-5-methyl-3-(3,5,7-trimethyladamantan-1-yl)phenyl)-4,4,5,5-tetramethyl-1,3,2-dioxaborolane

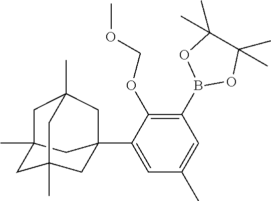

To a solution of 12.4 g (30.5 mmol) of 1-(3-bromo-5-methyl-2-(methoxymethoxy)phenyl)-3,5,7-trimethyladamantane in 200 ml of dry THF 14.6 ml (30.5 mmol) of 2.5 M ⁿBuLi in hexanes was added dropwise for 20 minutes at −80° C. The reaction mixture was stirred at this temperature for 1 hour followed by addition of 9.33 ml (45.7 mmol) of 2-isopropoxy-4,4,5,5-tetramethyl-1,3,2-dioxaborolane. The obtained suspension was stirred for 1 hour at room temperature, then poured into 130 ml of water. The crude product was extracted with dichloromethane (3×40 ml), the combined organic extract was dried over Na₂SO₄, and then evaporated to dryness. Yield 12.9 g (93%) of a white solid. ¹H NMR (CDCl₃, 400 MHz): δ 7.39 (d, J=1.9 Hz, 1H), 7.22 (d, J=1.9 Hz, 1H), 5.16 (s, 2H), 3.61 (s, 3H), 2.31 (s, 3H), 1.72 (s, 6H), 1.38 (s, 12H), 1.09-1.18 (m, 6H), 0.90 (s, 9H). ¹³C NMR (CDCl₃, 100 MHz): δ 159.8, 140.4, 134.7, 131.6, 131.2, 101.2, 83.6, 57.9, 50.4, 46.7, 39.5, 32.2, 30.6, 24.74, 20.8.

### 1-(2′-Bromo-2-(methoxymethoxy)-5-methyl-[1,1′-biphenyl]-3-yl)-3,5,7-trimethyladamantane

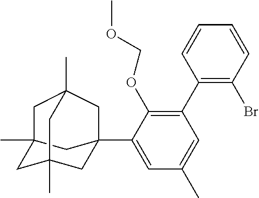 [SMILES: COCOc1c(-c2ccccc2Br)cc(C)cc1C12CC3(C)CC(C)(CC(C)(C3)C1)C2]

To a solution of 4.50 g (9.90 mmol) of 2-(5-methyl-2-(methoxymethoxy)-3-(3,5,7-trimethyladamantan-1-yl)phenyl)-4,4,5,5-tetramethyl-1,3,2-dioxaborolane in 20 ml of 1,4-dioxane, 2.80 g (9.90 mmol) of 2-bromoiodobenzene, 3.42 g (24.8 mmol) of potassium carbonate, and 10 ml of water were subsequently added. The mixture obtained was purged with argon for 10 minutes followed by addition of 286 mg (0.25 mmol) of Pd(PPh₃)₄. This mixture was stirred for 12 hours at 105° C., then cooled to room temperature and diluted with 100 ml of water. The crude product was extracted with dichloromethane (3×50 ml), the combined organic extract was dried over Na₂SO₄, and then evaporated to dryness. The residue was purified by flash chromatography on silica gel 60 (40-63 um, eluent:hexane-dichloromethane=10:1, vol.). Yield 3.90 g (82%) of a white solid. ¹H NMR (CDCl₃, 400 MHz): δ 7.73 (dd, J=8.0, 0.9 Hz, 1H), 7.38-7.46 (m, 2H), 7.24-7.28 (m, 1H), 7.23 (d, J=1.6 Hz, 1H), 6.97 (d, J=1.6 Hz, 1H), 4.56-4.58 (m, 1H), 4.47-4.48 (m, 1H), 3.31 (s, 3H), 2.41 (s, 3H), 1.80 (s, 6H), 1.17-1.29 (m, 6H), 0.98 (s, 9H). ¹³C NMR (CDCl₃, 100 MHz): δ 151.9, 141.8, 141.1, 134.5, 132.9, 132.2, 132.0, 130.0, 128.6, 127.8, 127.1, 124.0, 99.1, 57.1, 50.3, 46.8, 39.8, 32.2, 30.7, 21.1.

### 2-(2′-(Methoxymethoxy)-5′-methyl-3′-(3,5,7-trimethyladamantan-1-yl)-[1,1′-biphenyl]-2-yl)-4,4,5,5-tetramethyl-1,3,2-dioxaborolane

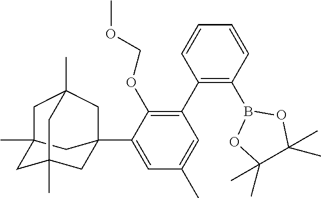

To a solution of 3.80 g (7.86 mmol) of 1-(2′-bromo-5-methyl-2-(methoxymethoxy)-[1,1′-biphenyl]-3-yl)-3,5,7-trimethyladamantane in 40 ml of dry THF, 4.10 ml (10.2 mmol) of 2.5 M ⁿBuLi in hexanes was added dropwise for 20 minutes at −80° C. The reaction mixture was stirred for 1 hour at this temperature followed by an addition of 2.57 ml (12.6 mmol) of 2-isopropoxy-4,4,5,5-tetramethyl-1,3,2-dioxaborolane. The obtained suspension was stirred for 1 hour at room temperature, then poured into 100 ml of water. The crude product was extracted with dichloromethane (3×100 ml), the combined organic extract was dried over Na₂SO₄, and then evaporated to dryness. The residue was purified by flash chromatography on silica gel 60 (40-63 um, eluent:hexane-diethyl ether=10:1, vol.). Yield 3.71 g (90%) of a colorless glassy solid. ¹H NMR (CDCl₃, 400 MHz): δ 7.78 (dd, J=7.4, 1.0 Hz, 1H), 7.32-7.45 (m, 3H), 7.11 (d, J=1.9 Hz, 1H), 6.89 (d, J=1.9 Hz, 1H), 4.41-4.48 (m, 2H), 3.32 (s, 3H), 2.33 (s, 3H), 1.79 (br.s, 6H), 1.13-1.25 (m, 18H), 0.94 (s, 9H). ¹³C NMR (CDCl₃, 100 MHz): δ 151.9, 145.6, 141.1, 136.6, 134.4, 131.5, 130.5, 130.3, 129.9, 126.7, 126.1, 98.9, 83.4, 57.2, 50.4, 47.0, 39.7, 32.2, 30.7, 25.2, 24.8, 24.1, 21.0.

### 2′,2′″-(4-(Pyrrolidin-1-yl)pyridine-2,6-diyl)bis(5-methyl-3-(3,5,7-trimethyladamantan-1-yl)-[1,1′-biphenyl]-2-ol)

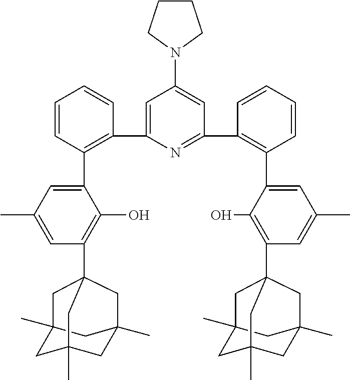

To a solution of 4.24 g (8.00 mmol) of 2-(3′-(3,5,7-trimethyladamantan-1-yl)-2′-(methoxymethoxy)-[1,1′-biphenyl]-2-yl)-4,4,5,5-tetramethyl-1,3,2-dioxaborolane in 20 ml of 1,4-dioxane, 1.22 g (4.00 mmol) of 2,6-dibromo-4-(pyrrolidin-1-yl)pyridine, 6.64 g (20.0 mmol) of cesium carbonate, and 10 ml of water were subsequently added. The mixture obtained was purged with argon for 10 minutes followed by addition of 460 mg (0.40 mmol) of Pd(PPh₃)₄. This mixture was stirred for 12 hours at 100° C., then cooled to room temperature and diluted with 50 ml of water. Thus obtained mixture was extracted with dichloromethane (3×50 ml), the combined organic extract was dried over Na₂SO₄, and then evaporated to dryness. To the resulting oil, 20 ml of THF, 20 ml of methanol, and 4 ml of 12 M HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent: dichloromethane-ethyl acetate=3:1, vol.). Yield 1.86 g (54%) of a mixture of two isomers as a white foam. ¹H NMR (CDCl₃, 400 MHz): δ 8.00 (s, 2H in A), 7.97 (s, 2H in B), 7.64 (d, J=7.2 Hz, 2H in A), 7.59-7.61 (m, 2H in B), 7.41-7.51 (m, 4H in A, 4H in B), 7.33 (d, J=7.5 Hz, 1H in A), 7.27-7.29 (m, 1H in B), 6.93 (s, 2H in A), 6.92 (s, 2H in B), 6.88 (s, 2H in A), 6.46 (s, 2H in B), 6.07 (s, 2H in B), 6.01 (s, 2H in A), 2.96-3.08 (in, 4H in B), 2.83 (br.s, 4H in A), 2.29 (s, 6H in A), 2.10 (s, 6H in B), 1.85-1.94 (m, 4H in A, 4H in B), 1.56 (br.s, 4H in A, 4H in B), 1.24-1.40 (m, 8H in A, 8H in B), 1.02-1.09 (in, 12H in B), 0.88-0.96 (m, 12H in A), 0.79 (s, 18H in B), 0.68 (s, 18H in A). ¹³C NMR (CDCl₃, 100 MHz, minor isomer resonances marked with asterisk): δ 157.5*, 157.3, 151.9*, 151.8, 150.3*, 149.8, 140.7*, 139.6, 137.2, 137.0*, 136.8, 132.2, 131.6, 131.2*, 130.6, 130.3, 130.2*, 129.2, 129.0, 128.9*, 128.6*, 128.5, 128.2*, 127.68*, 127.64, 126.6, 126.5*, 106.0*, 105.7, 50.5*, 50.2, 46.9*, 46.5, 46.3*, 46.0, 39.4*, 39.1, 32.0*, 31.9, 30.7*, 30.5, 25.3, 25.0*, 21.0, 20.7*.

### 2-(3,5-Dimethyladamantan-1-yl)-4-methylphenol

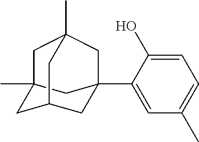

To a solution of 8.10 g (75.0 mmol) of 4-methylphenol and 13.5 g (75.0 mmol) of 3,5-dimethyladamantan-1-ol in 150 ml of dichloromethane, a solution of 4.90 ml (75.0 mmol) of methanesulfonic acid and 5 ml of acetic acid in 100 ml of dichloromethane was added dropwise for 1 hour at room temperature. The resulting mixture was stirred for 12 hours at room temperature and then carefully poured into 300 ml of 5% NaHCO₃. The obtained mixture was extracted with dichloromethane (3×50 ml), the combined organic extract was dried over Na₂SO₄, and then evaporated to dryness. The residue was purified using Kugelrohr apparatus (1 mbar, 70° C.) yielding 14.2 g (70%) of the title product as a light-yellow oil. ¹H NMR (CDCl₃, 400 MHz): δ 7.02 (s, 1H), 6.86 (dd, J=8.0, 1.5 Hz, 1H), 6.54 (d, J=8.0 Hz, 1H), 4.61 (s, 1H), 2.27 (s, 3H), 2.14-2.19 (m, 1H), 1.95 (br.s, 2H), 1.65-1.80 (m, 4H), 1.34-1.48 (m, 4H), 1.21 (br.s, 2H), 0.88 (s, 6H). ¹³C NMR (CDCl₃, 100 MHz): δ 152.0, 135.5, 129.7, 127.7, 127.0, 116.6, 51.1, 46.8, 43.2, 39.0, 38.3, 31.4, 30.9, 30.0, 20.8.

### 2-Bromo-6-(3,5-dimethyladamantan-1-yl)-4-methylphenol

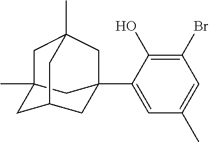 [SMILES: Cc1cc(Br)c(O)c(C23CC4CC(C)(CC(C)(C4)C2)C3)c1]

To a solution of 14.2 g (52.5 mmol) of 2-(3,5-dimethyladamantan-1-yl)-4-methylphenol in 200 ml of dichloromethane, a solution of 2.70 ml (52.5 mmol) of bromine in 100 ml of dichloromethane was added dropwise for 1 hour at room temperature. The resulting mixture was stirred for 12 hours at room temperature and then carefully poured into 200 ml of 5% NaHCO₃. The obtained mixture was extracted with dichloromethane (3×50 ml), the combined organic extract was dried over Na₂SO₄, and then evaporated to dryness. Yield 17.0 g (92%) of a light-yellow solid. ¹H NMR (CDCl₃, 400 MHz): δ 7.16 (d, J=2.0 Hz, 1H), 6.97 (d, J=1.8 Hz, 1H), 5.64 (s, 1H), 2.27 (s, 3H), 2.14-2.20 (m, 1H), 1.94 (br.s, 2H), 1.67-1.79 (m, 4H), 1.35-1.47 (m, 4H), 1.21 (br.s, 2H), 0.88 (s, 6H). ¹³C NMR (CDCl₃, 100 MHz): δ 148.2, 136.8, 130.3, 129.4, 127.3, 112.1, 51.0, 46.4, 43.1, 39.1, 38.7, 31.4, 30.9, 30.0, 20.6.

### 1-(3-Bromo-5-methyl-2-(methoxymethoxy)phenyl)-3,5-dimethyladamantane

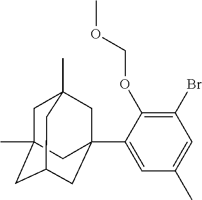

To a solution of 17.0 g (48.7 mmol) of 2-bromo-6-(3,5-dimethyladamantan-1-yl)-4-methylphenol in 200 ml of dry THF, 1.95 g (50.0 mmol, 60% wt. in mineral oil) of sodium hydride was added portionwise at room temperature. After that, 4.00 ml (53.0 mmol) of methoxymethyl chloride was added dropwise for 1 hour. The reaction mixture was heated for 24 hours at 60° C. and then poured into 300 ml of cold water. The crude product was extracted with 3×200 ml of dichloromethane. The combined organic extract was dried over Na₂SO₄, and then evaporated to dryness. Yield 17.2 g (90%) of a white solid. ¹H NMR (CDCl₃, 400 MHz): δ 7.22 (d, J=1.5 Hz, 1H), 7.04 (d, J=1.5 Hz, 1H), 5.21 (s, 2H), 3.69 (s, 3H), 2.26 (s, 3H), 2.11-2.19 (m, 1H), 1.92 (br.s, 2H), 1.65-1.80 (m, 4H), 1.34-1.43 (m, 4H), 1.20 (s, 2H), 0.87 (s. 6H). ¹³C NMR (CDCl₃, 100 MHz): δ 5151.21, 144.4, 134.4, 131.9, 127.5, 117.6, 99.8, 57.9, 50.9, 47.5, 43.0, 39.8, 39.5, 31.5, 31.0, 30.0, 20.7.

### 2-(3-(3,5-Dimethyladamantan-1-yl)-5-methyl-2-(methoxymethoxy)phenyl)-4,4,5,5-tetramethyl-1,3,2-dioxaborolane

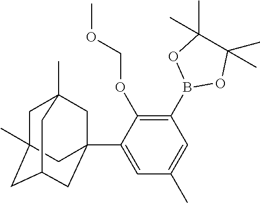

To a solution of 12.8 g (32.4 mmol) of 1-(3-bromo-5-methyl-2-(methoxymethoxy)phenyl)-3,5-dimethyladamantane in 200 ml of dry THF, 14.3 ml (35.6 mmol) of 2.5 M ⁿBuLi in hexanes was added dropwise for 20 minutes at −80° C. The reaction mixture was stirred for 1 hour at this temperature followed by addition of 10.0 ml (48.7 mmol) of 2-isopropoxy-4,4,5,5-tetramethyl-1,3,2-dioxaborolane. The obtained suspension was stirred for 1 hour at room temperature, then poured into 300 ml of water. The crude product was extracted with dichloromethane (3×100 ml), the combined organic extract was dried over Na₂SO₄, and then evaporated to dryness. The residue was recrystallized from isopropanol. Yield 11.1 g (78%) of a white solid. ¹H NMR (CDCl₃, 400 MHz): δ 7.37 (d, J=1.8 Hz, 1H), 7.20 (d, J=2.0 Hz, 1H), 5.14 (s, 2H), 3.60 (s, 3H), 2.29 (s, 3H), 2.11-2.18 (m, 1H), 1.97 (br.s, 2H), 1.69-1.84 (m, 4H), 1.34-1.47 (m, 4H), 1.36 (s, 12H), 1.20 (s, 2H), 0.87 (s, 6H). ¹³C NMR (CDCl₃, 100 MHz): δ 159.8, 140.7, 134.7, 131.7, 131.2, 101.1, 83.7, 57.9, 51.1, 47.4, 43.2, 39.7, 38.7, 31.5, 31.0, 30.1, 24.8, 20.8.

### 1-(2′-Bromo-2-(methoxymethoxy)-5-methyl-[1,1′-biphenyl]-3-yl)-3,5-dimethyladamantane

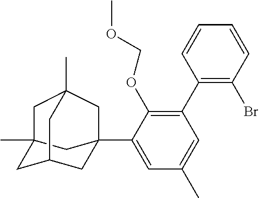 [SMILES: COCOc1c(-c2ccccc2Br)cc(C)cc1C12CC3CC(C)(CC(C)(C3)C1)C2]

To a solution of 3.02 g (6.86 mmol) of 2-(5-methyl-2-(methoxymethoxy)-3-(3,5-dimethyladamantan-1-yl)phenyl)-4,4,5,5-tetramethyl-1,3,2-dioxaborolane in 9 ml of 1,4-dioxane, 1.94 g (6.86 mmol) of 2-bromoiodobenzene, 5.59 g (17.1 mmol) of cesium carbonate, and 4 ml of water were subsequently added. The mixture obtained was purged with argon for 10 minutes followed by addition of 396 mg (0.343 mmol) of Pd(PPh₃)₄. This mixture was stirred for 12 hours at 105° C., then cooled to room temperature, and diluted with 100 ml of water. The crude product was extracted with dichloromethane (3×50 ml), the combined organic extract was dried over Na₂SO₄, and then evaporated to dryness. The residue was purified by flash chromatography on silica gel 60 (40-63 um, eluent:hexane-dichloromethane=10:1, vol.). Yield 1.64 g (51%) of a yellow oil. ¹H NMR (CDCl₃, 400 MHz): δ 7.72 (d, J=7.9 Hz, 1H), 7.42 (dt, J=7.6, 1.8 Hz, 1H), 7.39 (t, J=7.5 Hz, 1H), 7.20-7.26 (m, 1H), 7.21 (d, J=1.9 Hz, 1H), 6.95 (d, J=1.9 Hz, 1H), 4.55 (d, J=4.7 Hz, 1H AB), 4.48 (d, J=4.7 Hz, 1H AB), 3.28 (s, 3H), 2.39 (s, 3H), 2.21-2.26 (m, 1H), 2.01-2.08 (m, 2H), 1.77-1.95 (m, 4H), 1.40-1.54 (m, 4H), 1.28 (br.s, 2H), 0.95 (s, 6H). ¹³C NMR (CDCl₃, 100 MHz): δ 151.8, 142.1, 141.2, 134.5, 132.8, 132.2, 132.1, 130.0, 128.6, 127.8, 127.1, 124.0, 99.0, 57.0, 51.0, 47.5, 47.45, 43.2, 43.1, 39.7, 38.9, 31.5, 31.0, 30.1, 21.0.

### 2-(3′-(3,5-Dimethyladamantan-1-yl)-2′-(methoxymethoxy)-5′-methyl-[1,1′-biphenyl]-2-yl)-4,4,5,5-tetramethyl-1,3,2-dioxaborolane

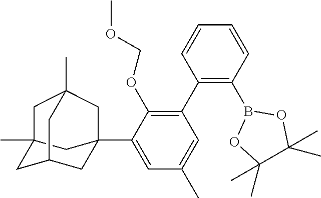

To a solution of 1.64 g (3.56 mmol) of 1-(2′-bromo-2-(methoxymethoxy)-5-methyl-[1,1′-biphenyl]-3-yl)-3,5-dimethyladamantane in 50 ml of dry THF, 1.71 ml (4.27 mmol) of 2.5 M ⁿBuLi in hexanes was added dropwise for 20 minutes at −80° C. The reaction mixture was stirred for 1 hour at this temperature followed by addition of 1.09 ml (5.34 mmol) of 2-isopropoxy-4,4,5,5-tetramethyl-1,3,2-dioxaborolane. The obtained suspension was stirred for 1 hour at room temperature, then poured into 100 ml of water. The crude product was extracted with dichloromethane (3×100 ml), the combined organic extract was dried over Na₂SO₄, and then evaporated to dryness. Yield 1.74 g (99%) of a colorless glassy solid. ¹H NMR (CDCl₃, 400 MHz): δ 7.76 (dd, J=7.4, 1.0 Hz, 1H), 7.41-7.45 (m, 1H), 7.35-7.38 (m, 1H), 7.32 (dt, J=7.4, 1.3 Hz, 1H), 7.08 (d, J=2.0 Hz, 1H), 6.85 (d, J=2.0 Hz, 1H), 4.38-4.47 (m, 2H), 3.29 (s, 3H), 2.31 (s, 3H), 2.18-2.22 (m, 1H), 1.73-2.05 (m, 6H), 1.35-1.52 (m, 4H), 1.17-1.22 (m, 12H), 0.91 (s, 6H). ¹³C NMR (CDCl₃, 100 MHz): δ 151.7, 145.6, 141.4, 136.7, 134.4, 131.6, 130.5, 130.3, 129.9, 126.7, 126.1, 98.9, 83.4, 57.3, 51.0, 47.8, 47.6, 43.2, 39.9, 38.9, 31.5, 31.0, 30.2, 25.1, 24.1, 21.0.

### 2′,2′″-(4-(Pyrrolidin-1-yl)pyridine-2,6-diyl)bis(3-(3,5-dimethyladamantan-1-yl)-5-methyl-[1,1′-biphenyl]-2-ol)

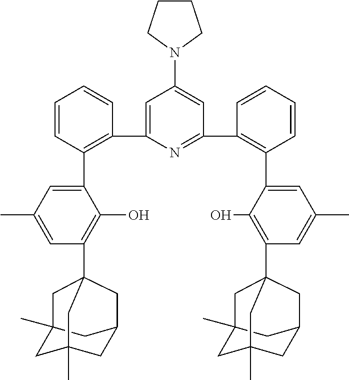

To a solution of 0.87 g (1.68 mmol) of 2-(3′-(3,5-dimethyladamantan-1-yl)-2′-(methoxymethoxy)-5′-methyl-[1,1′-biphenyl]-2-yl)-4,4,5,5-tetramethyl-1,3,2-dioxaborolane in 4 ml of 1,4-dioxane, 206 mg (0.674 mmol) of 2,6-dibromo-4-(pyrrolidin-1-yl)pyridine, 1.37 g (4.21 mmol) of cesium carbonate, and 2 ml of water were subsequently added. The mixture obtained was purged with argon for 1 minute followed by addition of 100 mg (0.0842 mmol) of Pd(PPh₃)₄. This mixture was stirred for 12 hours at 100° C., then cooled to room temperature, and diluted with 30 ml of water. Thus obtained mixture was extracted with dichloromethane (3×50 ml), the combined organic extract was dried over Na₂SO₄, and then evaporated to dryness. To the resulting oil, 20 ml of THF, 20 ml of methanol, and 2 ml of 12 N HCl were subsequently added. The reaction mixture was stirred overnight at 60° C. and then poured into 200 ml of water. The crude product was extracted with dichloromethane (3×70 ml), the combined organic extract was washed with 5% NaHCO₃, dried over Na₂SO₄, and then evaporated to dryness. The residue was purified by flash chromatography on silica gel 60 (40-63 um, eluent:hexane-ethyl acetate=10:1, vol.). Yield 0.49 g (87%) of a mixture of two isomers as a white foam. ¹H NMR (CDCl₃, 400 MHz): δ 8.53 (br.s, 2H in B), 8.28 (br.s, 2H in A), 7.56-7.66 (m, 2H in A, 2H in B), 7.28-7.46 (m, 9H in A and B), 6.85-6.88 (m, 4H in A and B), 6.30 (s, 2H in B), 6.07 (s, 2H in B), 5.98 (s, 2H in A), 2.98-3.12 (m, 4H in B), 2.80-2.90 (m, 4H in A), 2.26 (s, 6H in A), 2.02 (s, 6H in B), 1.84-1.94 (m, 6H in A and B), 1.50-1.80 (m, 6H in A and B), 1.35-1.47 (m, 4H in A and B), 1.10-1.30 (m, 10H in A and B), 0.91-1.05 (m, 4H in A and B), 0.81 (s, 6H in B), 0.79 (s, 6H in B), 0.71 (s, 6H in A), 0.70 (s, 6H in A). ¹³C NMR (CDCl₃, 100 MHz) (150.1, 139.2, 137.7, 137.2, 132.2, 131.5*, 131.4*, 130.8*, 130.2, 130.1*, 129.6*, 129.2, 129.1, 128.8*, 128.4*, 128.35, 127.6, 127.5*, 126.5, 126.3*, 125.8*, 105.9*, 105.8, 51.2*, 51.0, 47.6*, 47.0, 46.6, 46.2, 43.3*, 43.0, 42.8*, 42.7, 38.5*, 38.4, 38.2, 38.1, 31.4*, 31.2, 31.1, 30.9*, 30.2*, 30.1*, 25.3, 25.1*, 21.0, 20.7*.

### Preparation of Transition Metal Complexes

### Complex 3

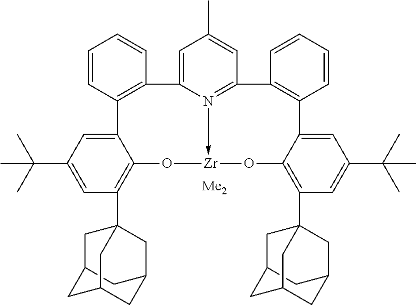

To a mixture of ZrCl₄(Et₂O)₂ (50 mg, 0.131 mmol) and 2′,2′″-(4-methylpyridine-2,6-diyl)bis(3-(1-adamantanyl)-5-(tert-butyl)-[1,1′-biphenyl]-2-ol) (100 mg, 0.123 mmol) in toluene (˜mL), MeMgBr (3.0 M, 0.18 mL, 0.54 mmol) was added dropwise. The reaction mixture was stirred at ambient temperature for 2 hours, then evaporated to dryness. The resulting solid was extracted with pentane, and the combined extracts were filtered through Celite on a glass fiber plug. The filtrate was concentrated under vacuum to a brown foam. The crude product was recrystallized from pentane at −40° C., allowing for slow evaporation. Yield 29.0 mg (product isolated with 1 equiv. pentane). ¹H NMR (C₆D₆, 400 MHz): δ 7.54 (d, J=2.4 Hz, 2H), 7.25-6.96 (m, 10H), 6.21 (s, 2H), 2.73-2.38 (m, 12H), 2.19 (br, 6H), 2.06-1.77 (m, 12H), 1.32 (d, J=1.3 Hz, 18H), 1.19 (s, 3H), 0.13 (s, 6H).

### Complex 4

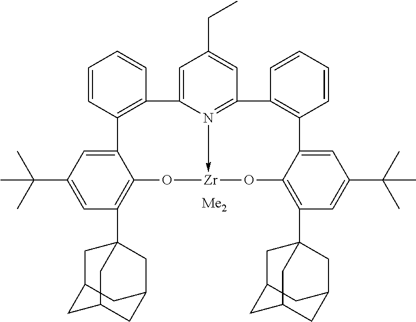

To a precooled, stirring suspension of zirconium chloride (0.142 g, 0.609 mmol, 1 equiv.) in toluene (2 mL), methylmaganesium bromide (0.82 mL, 3.0 M in diethyl ether, 2.5 mmol, 4.0 equiv.) was added. Then, a precooled solution of 2′,2′″-(4-ethylpyridine-2,6-diyl)bis(3-(1-adamantanyl)-5-(tert-butyl)-[1,1′-biphenyl]-2-ol) (0.502 g, 0.609 mmol) in toluene (3 mL) was added dropwise. The reaction was stirred at room temperature for 3 hours. The reaction was concentrated under a stream of nitrogen and then under high vacuum. The residue was stirred in hexane (20 mL) and heated to reflux. The mixture was filtered through Celite while hot. The filtride was extracted further with refluxing hexane (2×20 mL). The combined hexane filtrate was concentrated under a stream of nitrogen and then under high vacuum to afford the product as a tan-grey solid, containing hexane (0.18 equiv.) and toluene (0.96 equiv.) (0.424 g, 66% yield). ¹H NMR (C₆D₆, 400 MHz): δ 7.54 (d, 2H, J=2.6 Hz), 7.24-7.20 (m, 2H), 7.14-7.00 (m, 8H), 6.39 (s, 2H), 2.65-2.54 (m, 6H), 2.49-2.40 (m, 6H), 2.24-2.15 (m, 6H), 2.06-1.96 (m, 6H), 1.89-1.80 (m, 6H), 1.68 (q, 2H, J=7.6 Hz), 1.33 (s, 18H), 0.48 (t, 3H, J=7.6 Hz), 0.14 (s, 6H).

### Complex 5

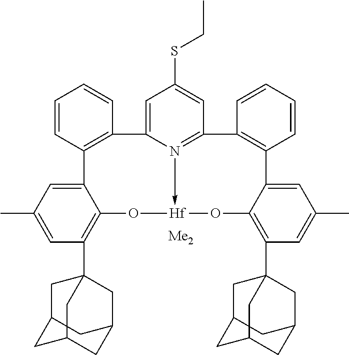

To a suspension of 98 mg (0.307 mmol) of hafnium tetrachloride in 20 mL of dry toluene, 476 uL (1.39 mmol) of 2.9 M MeMgBr in diethyl ether was added in one portion via syringe at 0° C. To the resulting suspension, 237 mg (0.307 mmol) of 2′,2′″-(4-(ethylthio)pyridine-2,6-diyl)bis(3-((3r,5r,7r)-adamantan-1-yl)-5-methyl-[1,1′-biphenyl]-2-ol) was immediately added in one portion. The reaction mixture was stirred for 4 hours at room temperature and then evaporated to near dryness. The solid obtained was extracted with 2×20 mL of hot toluene, and the combined organic extracts were filtered through a thin pad of Celite 503. Next, the filtrate was evaporated to dryness. Yield 217 mg (72%) of a white solid. Anal. Calc. for C₅₅H₆₁HfNSO₂: C, 67.50; H, 6.28; N, 1.43. Found: C, 67.88; H, 6.36; N, 1.27. ¹H NMR (C₆D₆, 400 MHz): δ 7.09-7.22 (m, 10H), 6.80 (d, J=1.7 Hz, 2H), 6.48 (s, 2H), 2.45-2.52 (m, 6H), 2.31-2.38 (m, 6H), 2.23 (s, 6H), 2.18 (br.s, 6H), 1.96-2.02 (m, 6H), 1.80-1.87 (m, 6H), 1.69-1.83 (m, 2H), 0.54 (t, J=7.4 Hz, 3H), −0.14 (s, 6H). ¹³C NMR (C₆D₆, 100 MHz) δ 160.0, 157.2, 155.7, 143.7, 139.2, 133.7, 133.3, 132.8, 131.6, 131.2, 129.3, 127.1, 120.9, 51.0, 41.9, 38.1, 37.9, 30.0, 24.7, 21.4, 12.6.

### Complex 6

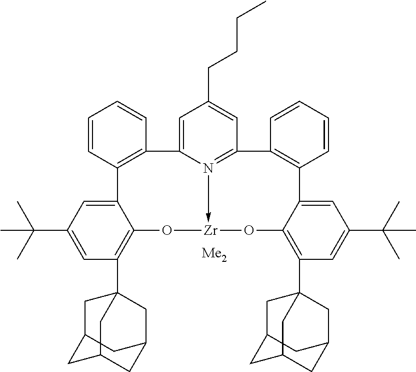

To a mixture of ZrCl₄ (115 mg, 0.493 mmol) and 2′,2′″-(4-butylpyridine-2,6-diyl)bis(3-(1-adamantanyl)-5-(tert-butyl)-[1,1′-biphenyl]-2-ol) (400 mg, 0.469 mmol) in toluene (˜5 mL), MeMgBr (3.0 M, 0.7 mL, 2.1 mmol) was added dropwise. The reaction mixture was stirred at ambient temperature for 2 hours, then evaporated to dryness. The resulting solid was extracted with isohexane, and the combined extracts were filtered through Celite on a glass fiber plug. The filtrate was concentrated under vacuum to a brown residue. The product was further purified by precipitation, by slow evaporation from a pentane solution, at ambient temperature and subsequently at −40° C. The brown supernatant was decanted from the precipitate, which was washed with cold pentane until washes were nearly colorless. Yield (64.1 mg) of a white solid containing 0.75 equiv. pentane. ¹H NMR (400 MHz, C₆D₆) δ 7.53 (s, 2H), 7.26-7.20 (m, 2H), 7.15-6.98 (m, 8H), 6.37 (s, 2H), 2.70-2.30 (m, 12H), 2.19 (s, 6H), 2.06-1.74 (m, 12H), 1.75 (dt, J=11.2, 7.4 Hz, 2H), 1.33 (s, 18H), 1.24 (m, 2H), 0.73 (m, 2H), 0.64 (t, 3H), 0.12 (s, 6H).

### Complex 7

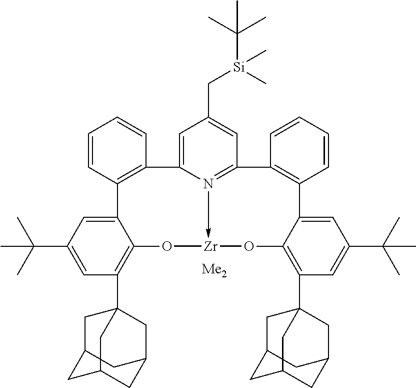

To a mixture of ZrCl₄ (60 mg, 0.257 mmol) and 2′,2′″-(4-((tert-butyldimethylsilyl)methyl)pyridine-2,6-diyl)bis(3-(1-adamantanyl)-5-(tert-butyl)-[1,1′-biphenyl]-2-ol) (200 mg, 0.216 mmol) in toluene (˜3 mL) chilled at −40° C., MeMgBr (3.0 M, 0.35 mL, 1.05 mmol) was added dropwise. The reaction mixture was stirred at ambient temperature for 16 hours, then evaporated to dryness. The resulting solid was extracted with isohexane (˜30 mL total), and the extracts were filtered through Celite on a glass fiber plug. The combined filtrated was concentrated under vacuum to a brown foam (183.5 mg). The product was further purified by precipitation, by slow evaporation from a pentane solution at −40° C. The brown supernatant was decanted from the precipitate, which was dried under vacuum. Yield (95.6 mg) of a brown solid. ¹H NMR (400 MHz, C₆D₆) δ 7.55 (d, J=2.5 Hz, 2H), 7.13 (d, J=18.0 Hz, 10H), 6.25 (s, 2H), 2.69-2.32 (m, 12H), 2.20 (s, 6H), 2.08-1.71 (m, 12H), 1.37 (s, 18H), 0.85 (dd, J=8.6, 6.3 Hz, 2H), 0.67 (s, 9H), 0.12 (s, 6H), −0.46 (s, 3H), −0.62 (s, 3H).

### Complex 8

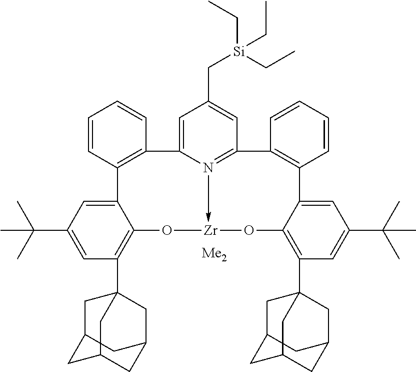

To a mixture of ZrCl₄(Et₂O)₂ (80.9 mg, 0.212 mmol) and 2′,2′″-(4-((triethylsilyl)methyl)pyridine-2,6-diyl)bis(3-(1-adamantanyl)-5-(tert-butyl)-[1,1′-biphenyl]-2-ol) (187 mg, 0.202 mmol) in toluene (˜3 mL) chilled at −40° C., MeMgBr (3.0 M, 0.3 mL, 0.9 mmol) was added dropwise. The reaction mixture was stirred at ambient temperature for 1 hour, then evaporated to dryness. The resulting solid was extracted with pentane (˜10 mL total), and the combined extracts were filtered through Celite on a glass fiber plug. The filtrated was concentrated under vacuum to a brown foam. The product was further purified by recrystallization from pentane at −40° C. Yield 31.9 mg (product isolated with 0.5 equiv. pentane). ¹H NMR (400 MHz, C₆D₆) δ 7.56 (d, J=2.5 Hz, 2H), 7.33-6.98 (m, 10H), 6.38 (s, 2H), 2.73-2.31 (m, 12H), 2.21 (s, 6H), 2.07-1.74 (m, 12H), 1.52 (s, 2H), 1.38 (s, 18H), 1.31-1.09 (m, 3H), 0.88 (t, J=7.0 Hz, 3H), 0.62 (t, J=7.9 Hz, 9H), 0.13 (s, 6H).

### Complex 9

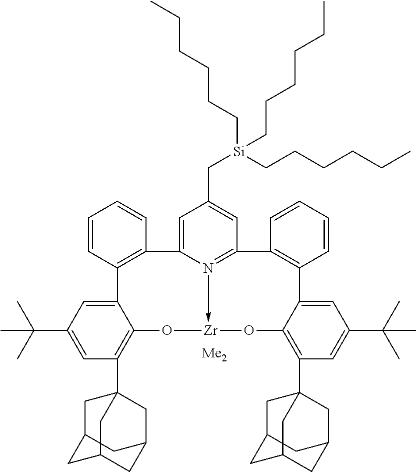

To a mixture of ZrCl₄(Et₂O)₂ (60 mg, 0.157 mmol) and 2′,2′″-(4-((trihexylsilyl)methyl)pyridine-2,6-diyl)bis(3-(1-adamantanyl)-5-(tert-butyl)-[1,1′-biphenyl]-2-ol) (155 mg, 0.142 mmol) in toluene (˜4 mL) chilled at −40° C., MeMgBr (3.0 M, 0.22 mL, 0.66 mmol) was added dropwise. The reaction mixture was stirred at ambient temperature for 14 hours, then evaporated to dryness. The resulting solid was extracted with pentane (˜10 ml total), and the combined extracts were filtered through Celite on a glass fiber plug. The filtrated was concentrated under vacuum to a brown foam. ¹H NMR (400 MHz, C₆D₆) δ 7.57 (d, J=2.6 Hz, 2H), 7.31-6.71 (m, 10H), 6.50 (s, 2H), 2.71-2.37 (m, 12H), 2.18 (s, 6H), 2.06-1.73 (m, 12H), 1.59-1.04 (m, 44H), 0.93 (t, J=7.0 Hz, 9H), 0.61 (s, 3H), 0.27 (dd, J=10.2, 6.4 Hz, 6H), 0.14 (s, 3H).

### Complex 10

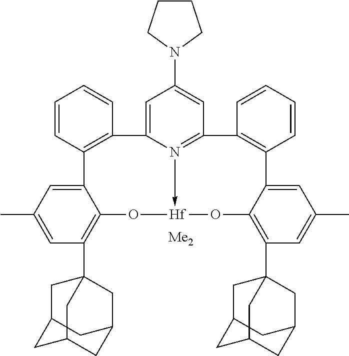

To a suspension of 184 mg (0.576 mmol) of hafnium tetrachloride in 60 mL of dry toluene, 834 uL (2.42 mmol) of 2.9 M MeMgBr in diethyl ether was added in one portion via syringe at 0° C. To the resulting suspension, 450 mg (0.576 mmol) of 2′,2′″-(4-(pyrrolidin-1-yl)pyridine-2,6-diyl)bis(3-((3r,5r,7r)-adamantan-1-yl)-5-methyl-[1,1′-biphenyl]-2-ol) was immediately added in one portion. The reaction mixture was stirred for 4 hours at room temperature and then evaporated to near dryness. The solid obtained was extracted with 2×20 mL of hot toluene, and the combined organic extracts were filtered through a thin pad of Celite 503. Next, the filtrate was evaporated to dryness. The residue was triturated with 5 mL of n-hexane, the obtained precipitate was filtered off (G4), washed two times with 5 mL of n-hexane, and then dried in vacuo. Yield 512 mg (90%) of a white-beige solid. Anal. Calc. for C₅₇H₆₄HfN₂O₂: C, 69.32; H, 6.53; N, 2.84. Found: C, 69.67; H, 6.82; N, 2.55. ¹H NMR (C₆D₆, 400 MHz): δ 7.39-7.41 (m, 2H), 7.18-7.30 (m, 8H), 6.92 (d, J=1.7 Hz, 2H), 5.64 (s, 2H), 2.53-2.60 (m, 6H), 2.39-2.46 (m, 6H), 2.27 (s, 6H), 2.21 (br.s, 6H), 2.00-2.06 (m, 6H), 1.93-1.98 (m, 4H), 1.82-1.89 (m, 6H), 0.87-0.91 (m, 4H), −0.08 (s, 6H). ¹³C NMR (C₆D₆, 100 MHz) δ 159.6, 157.0, 152.9, 143.2, 138.8, 133.4, 133.3, 133.28, 131.4, 130.9, 129.5, 127.9, 126.5, 107.3, 49.1, 48.0, 41.4, 37.7, 37.6, 29.8, 25.7, 21.0.

### Complex 11

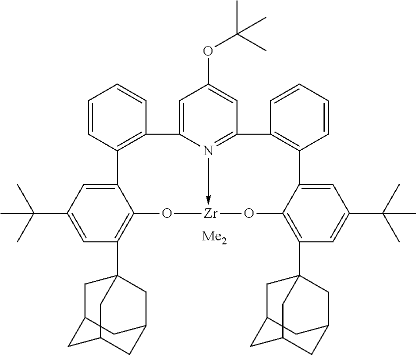

To a mixture of ZrCl₄(Et₂O)₂ (54 mg, 0.142 mmol) and 2′,2′″-(4-(tert-butoxy)pyridine-2,6-diyl)bis(3-(1-adamantanyl)-5-(tert-butyl)-[1,1′-biphenyl]-2-ol) (116 mg, 0.134 mmol) in toluene (˜3 mL) chilled at −40° C., MeMgBr (3.0 M, 0.2 mL, 0.6 mmol) was added dropwise. The reaction mixture was stirred at ambient temperature for 70 minutes, then evaporated to dryness. The solid was stirred with n-pentane (˜20 mL), and the resulting mixture was filtered through a plastic fritted funnel. The filtride was rinsed with additional pentane (2×5 mL). The combined filtrate was concentrated under vacuum to a solid. The resulting was re-dissolved in n-pentane (˜20 mL total) and filtered through a glass fiber plug. The resulting solution was concentrated under vacuum to a tan solid (69.3 mg, 52%).

### Complex 12

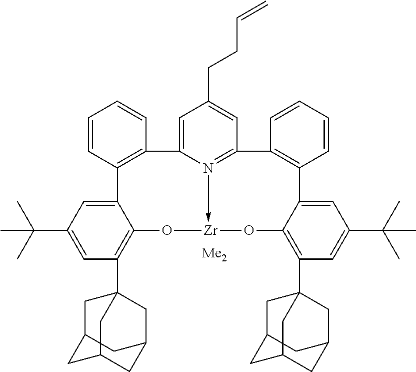

To a mixture of ZrCl₄(Et₂O)₂ (53 mg, 0.139 mmol) and 2′,2′″-(4-(3-butenyl)pyridine-2,6-diyl)bis(3-(1-adamantanyl)-5-(tert-butyl)-[1,1′-biphenyl]-2-ol) (114 mg, 0.134 mmol) in toluene (˜5 mL) chilled at −40° C., MeMgBr (3.0 M, 0.2 mL, 0.6 mmol) was added dropwise. The reaction mixture was stirred at ambient temperature for 1 hour, then evaporated to dryness. The resulting solid was extracted with n-hexane (˜10 mL×2), and the combined extracts were filtered through a medium glass fritted funnel. The filtrate was concentrated under vacuum to a brown solid. The resulting solid was dissolved in n-hexane (˜10 mL total) and filtered through a glass fiber plug. The resulting filtrate was concentrated under vacuum to a brown solid (110.5 mg, 85%). ¹H NMR (400 MHz, C₆D₆) δ 7.53 (d, J=2.7 Hz, 2H), 7.25-7.00 (m, 10H), 6.28 (s, 2H), 5.18 (ddt, J=17.1, 10.2, 6.7 Hz, 1H), 4.74 (d, J=9.5 Hz, 1H), 4.46 (d, J=17.1, 1H), 2.65-2.31 (m, 12H), 2.19 (s, 6H), 2.08-1.79 (m, 12H), 1.76-1.51 (m, 2H), 1.33 (s, 18H), 0.88 (t, J=6.9 Hz, 2H), 0.12 (s, 6H).

### Complex 13

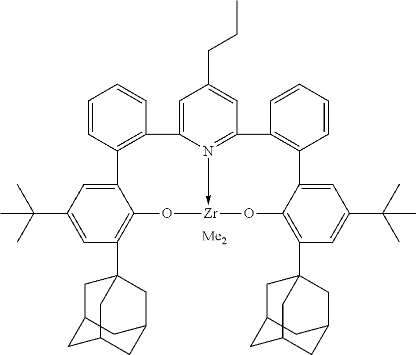

To a mixture of ZrCl₄(Et₂O)₂ (38 mg, 0.1 mmol) and 2′,2′″-(4-propylpyridine-2,6-diyl)bis(3-(1-adamantanyl)-5-(tert-butyl)-[1,1′-biphenyl]-2-ol) (81 mg, 0.097 mmol) in toluene (˜5 mL) chilled at −40° C., MeMgBr (3.0 M, 0.14 mL, 0.42 mmol) was added dropwise. The reaction mixture was stirred at ambient temperature for 70 minutes, then evaporated to dryness. The resulting solid was extracted with n-hexane (˜10 mL×2), and the combined extracts were filtered through a medium glass fritted funnel. The filtrate was concentrated under vacuum to a brown solid. The resulting solid was dissolved in n-hexane (˜10 mL total) and filtered through a glass fiber plug. The resulting filtrate was concentrated under vacuum to a tan solid (68.2 mg, 74%).

### Complex 14

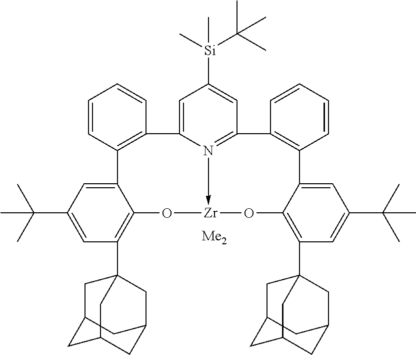

To a mixture of ZrCl₄(Et₂O)₂ (55 mg, 0.144 mmol) and 2′,2′″-(4-(tert-butyldimethylsilyl)pyridine-2,6-diyl)bis(3-(1-adamantanyl)-5-(tert-butyl)-[1,1′-biphenyl]-2-ol) (122 mg, 0.134 mmol) in toluene (˜5 mL) chilled at −40° C., MeMgBr (3.0 M, 0.2 mL, 0.6 mmol) was added dropwise. The reaction mixture was stirred at ambient temperature for 1 hour, then evaporated to dryness. The resulting solid was extracted with methylcyclohexane (˜20 mL total), and the combined extracts were filtered through a plastic fritted funnel. The filtride was rinsed with additional methylcyclohexane (2×5 mL). The combined filtrate was concentrated under vacuum to −5 mL, then filtered through a glass fiber plug. The resulting filtrate was concentrated under vacuum to a tan solid, which was subsequently recrystallized from hot isohexane to afford colorless crystals, which were dried under vacuum. Yield 87.5 mg of a white powder containing 1 equivalent of isohexane.

### Complex 15

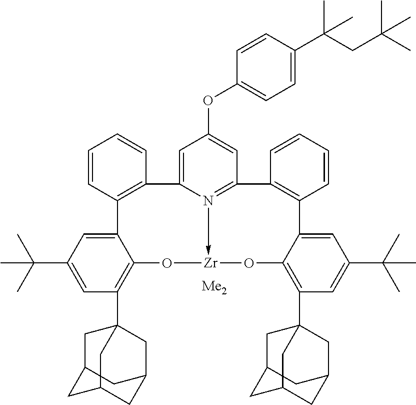

To a mixture of ZrCl₄(Et₂O)₂ (57 mg, 0.149 mmol) and 2′,2′″-(4-(4-(2,4,4-trimethylpentan-2-yl)phenoxy)pyridine-2,6-diyl)bis(3-(1-adamantanyl)-5-(tert-butyl)-[1,1′-biphenyl]-2-ol) (135 mg, 0.135 mmol) in toluene (˜5 mL) chilled at −40° C., MeMgBr (3.0 M, 0.2 mL, 0.6 mmol) was added dropwise. The reaction mixture was stirred at ambient temperature for 90 minutes, then evaporated to dryness. The resulting solid was extracted with pentane (˜20 mL total), and the combined extracts were filtered through a plastic fritted funnel. The filtride was rinsed with additional pentane (2×10 mL). The combined filtrate was concentrated under vacuum to a solid, which was then re-dissolved in pentane (10 mL total) and filtered through Celite on a glass fiber plug. The filtrate was concentrated under vacuum to a yellow-tan solid (132.4 mg). The solid was further purified by precipitation from pentane at −40° C., to afford a white solid.

### Complex 16: Synthesis of dimethylzirconium[2′,2′″-(4-(tert-butyl)-thiopyridine-2,6-diyl)bis(3-adamantan-1-yl)-5-(tert-butyl)-[1,1′-biphenyl]-2-olate)₁

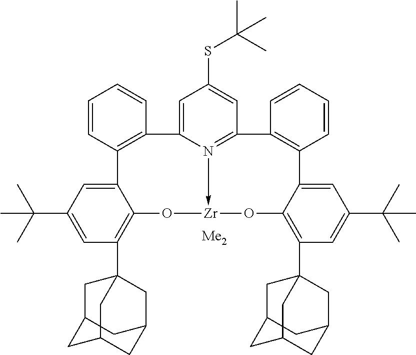

To a precooled, stirring suspension of zirconium tetrachloride (57 mg, 0.25 mmol, 1 equiv.) in toluene (3 mL), methylmagnesium bromide (0.33 mL, 3.0 M in diethyl ether, 0.99 mmol, 4.1 equiv.) was added. Then, a precooled solution of 2′,2′″-(4-(tert-butyl)-thiopyridine-2,6-diyl)bis(3-(1-adamantanyl)-5-(tert-butyl)-[1,1′-biphenyl]-2-ol) (214 mg, 0.24 mmol) in toluene (5 mL) was added. The reaction was stirred at room temperature for 1 hour. The reaction was concentrated under a stream of nitrogen and then under high vacuum. The residue was extracted with pentane (10 mL, then 5 mL) and filtered over Celite. The combined pentane extracts were cooled to −35° C. The resulting precipitate was collected and concentrated under high vacuum to afford the product as a white solid, containing toluene (0.39 equiv.) (104 mg, 41% yield). ¹H NMR (400 MHz, C₆D₆): δ 7.55 (d, 2H, J=2.6 Hz), 7.21 (d, 2H, J=7.3 Hz), 7.12-6.99 (m, 8H), 6.95 (s, 2H), 2.59-2.51 (m, 6H), 2.45-2.37 (m, 6H), 2.22-2.16 (m, 6H), 2.03-1.94 (m, 6H), 1.89-1.80 (m, 6H), 1.33 (s, 18H), 0.86 (s, 9H), 0.11 (s, 6H).

### Complex 17: Synthesis of dimethylzirconium[2′,2′″-(4-(butylthio)-pyridine-2,6-diyl)bis(3-adamantan-1-yl)-5-(tert-butyl)-[1,1′-biphenyl]-2-olate)]

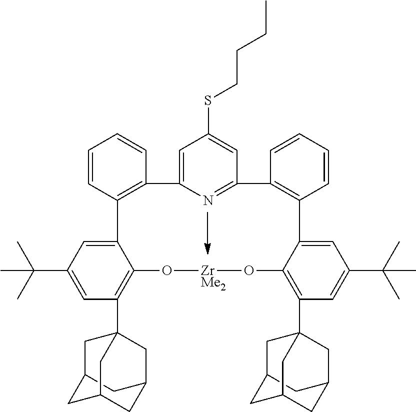

To a precooled, stirring suspension of zirconium tetrachloride (65 mg, 0.28 mmol, 1 equiv.) in toluene (2 mL), methylmagnesium bromide (0.38 mL, 3.0 M in diethyl ether, 1.1 mmol, 4.1 equiv.) was added. Then, a solution of 2′,2′″-(4-(butylthio)-pyridine-2,6-diyl)bis(3-(1-adamantanyl)-5-(tert-butyl)-[1,1′-biphenyl]-2-ol) (246 mg, 0.278 mmol) in toluene (2 mL) was added. The reaction was stirred at room temperature for 24 hours. The reaction was concentrated under a stream of nitrogen and then under high vacuum. The residue was extracted with pentane (2×10 mL) and filtered over Celite. The combined pentane extracts were cooled to −35° C. The resulting supernatant was collected and concentrated under a stream of nitrogen and then under high vacuum. The residue was dissolved in minimal pentane and cooled to −35° C. The resulting precipitate was collected and concentrated under high vacuum to afford the solid product, containing toluene (0.41 equiv.) (57 mg, 20% yield). ¹H NMR (400 MHz, C₆D₆): δ 7.56 (dd, 2H, J=10.3, 2.6 Hz), 7.24-7.18 (m, 2H), 7.14-6.99 (m, 8H), 6.53 (s, 1H), 6.23 (s, 1H), 2.65-2.55 (m, 6H), 2.50-2.41 (m, 6H), 2.24-2.16 (m, 6H), 2.09-1.91 (m, 8H), 1.89-1.80 (m, 6H), 1.36-1.16 (m, 22H), 0.61 (t, 3H, J=7.2 Hz), 0.14 (s, 3H), 0.13 (s, 3H).

### Complex 18: Synthesis of dimethylzirconium[2′,2′″-(4-(dodecylthio)-pyridine-2,6-diyl)bis(3-adamantan-1-yl)-5-(tert-butyl)-[1,1′-biphenyl]-2-olate)]

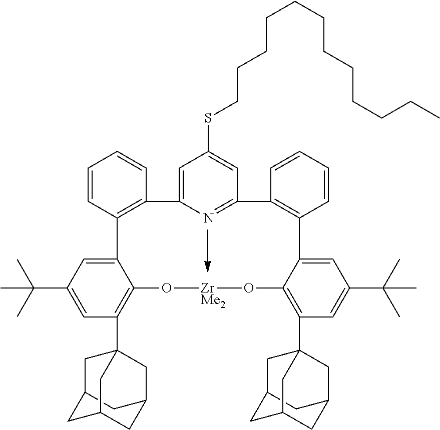

To a precooled, stirring suspension of zirconium tetrachloride (21 mg, 90 mol, 1 equiv.) in toluene (1 mL), methylmagnesium bromide (0.12 mL, 3.0 M in diethyl ether, 0.36 mmol, 4 equiv.) was added. Then, a precooled solution of 2′,2′″-(4-(dodecylthio)-pyridine-2,6-diyl)bis(3-(1-adamantanyl)-5-(tert-butyl)-[1,1′-biphenyl]-2-ol) (90 mg, 90 mol) in toluene (2 mL) was added. The reaction was stirred at room temperature for 15 minutes. The reaction was concentrated under a stream of nitrogen and then under high vacuum. The residue was extracted with pentane (2×3 mL) and filtered over Celite. The combined pentane extracts were cooled to −35° C. The resulting hazy mixture was filtered. The filtrate was concentrated under a stream of nitrogen and then under high vacuum to afford the product as a glassy solid, which, upon abrasion, forms a white solid (60 mg, 59% yield). ¹H NMR (400 MHz, C₆D₆): δ 7.58 (d, 2H, J=2.6 Hz), 7.22-7.18 (m, 2H), 7.13-7.01 (m, 8H), 6.56 (s, 2H), 2.65-2.56 (m, 6H), 2.51-2.43 (m, 6H) 2.23-2.16 (m, 6H), 2.15-2.08 (m, 2H), 2.06-1.97 (m, 6H), 1.90-1.81 (m, 6H), 1.39-1.07 (m, 38H), 0.92 (t, 3H, J=7.0 Hz), 0.13 (s, 6H).

### Complex 19

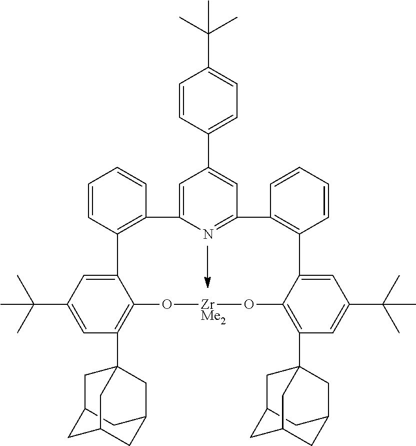

To a mixture of ZrCl₄(Et₂O)₂ (55.2 mg, 0.145 mmol) and 2′,2′″-(4-(4-tert-butylphenyl)pyridine-2,6-diyl)bis(3-(1-adamantanyl)-5-(tert-butyl)-[1,1′-biphenyl]-2-ol) (123 mg, 0.132 mmol) in toluene (˜3 mL) chilled at −40° C., MeMgBr (3.0 M, 0.2 mL, 0.6 mmol) was added dropwise. The reaction mixture was stirred at ambient temperature for 70 minutes, then evaporated to dryness. The resulting solid was extracted with methylcyclohexane (˜10 mL total), and the combined extracts were filtered through Celite. The filtrate was then concentrated under vacuum to a solid.

### Complex 20: Synthesis of dimethylzirconium[2′,2′″-(4-(diisopropylamino)methylpyridine-2,6-diyl)bis(3-adamantan-1-yl)-5-(tert-butyl)-[1,1′-biphenyl]-2-olate)]

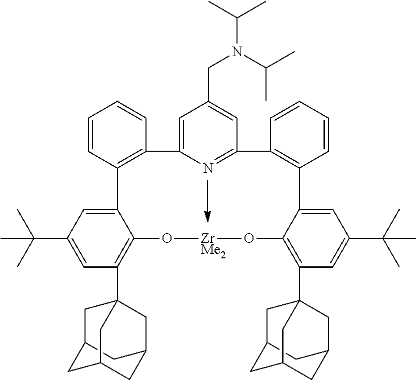

To a precooled, stirring suspension of zirconium tetrachloride (27 mg, 0.12 mmol, 1 equiv.) in toluene (2 mL), methylmagnesium bromide (0.16 mL, 3.0 M in diethyl ether, 0.48 mmol, 4.2 equiv.) was added. Then, a precooled solution of 2′,2′″-(4-((diisopropylamino)methyl)-pyridine-2,6-diyl)bis(3-(1-adamantanyl)-5-(tert-butyl)-[1,1′-biphenyl]-2-ol) (104 mg, 0.114 mmol) in toluene (2 mL) was added. The reaction was stirred at room temperature for 18.5 hours. The reaction was concentrated under a stream of nitrogen at 50° C. and then under high vacuum. The residue was extracted with pentane (15 mL) and then toluene (5 mL) and filtered over Celite. The combined extracts were concentrated under a stream of nitrogen and then under high vacuum. The residue was extracted further with hot hexane and filtered over Celite. The filtrate was concentrated under a stream of nitrogen and then under high vacuum to afford the product as a tan-brown solid, containing hexane (2.63 equiv.) and toluene (0.28 equiv.) (71.2 mg, 48% yield). ¹H NMR (400 MHz, C₆D₆): δ 7.53 (d, 2H, J=2.6 Hz), 7.26-7.23 (m, 2H), 7.14-7.09 (m, 8H), 6.93 (s, 2H), 2.97-2.80 (m, 2H), 2.60-2.50 (m, 8H), 2.47-2.38 (m, 6H), 2.24-2.16 (m, 6H), 2.05-1.95 (m, 6H), 1.89-1.81 (m, 6H), 1.34 (s, 18H), 0.63 (d, 6H, J=6.7), 0.55 (d, 6H, J=6.5 Hz), 0.14 (s, 6H).

### Complex 21: Synthesis of dimethylzirconium[2′,2′″-(4-[4-methyl-2,6,7-trioxabicyclo[2.2.2]octan-1-yl]pyridine-2,6-diyl)bis(3-adamantan-1-yl)-5-(tert-butyl)-[1,1′-biphenyl]-2-olate)]

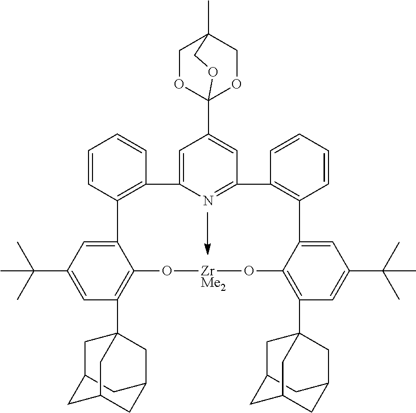

To a precooled, stirring suspension of zirconium tetrachloride (25 mg, 0.11 mmol, 1 equiv.) in toluene (2 mL), a solution of methylmagnesium bromide (0.15 mL, 3.0 M in diethyl ether, 0.45 mmol, 4.2 equiv.) was added. Then, a precooled solution of 2′,2′″-(4-(4-methyl-2,6,7-trioxabicyclo[2.2.2]octan-1-yl)-pyridine-2,6-diyl)bis(3-(1-adamantanyl)-5-(tert-butyl)-[1,1′-biphenyl]-2-ol) (99 mg, 0.11 mmol, 1 equiv.) in toluene (2 mL) was added. The reaction was stirred at room temperature for 19 hours. The reaction was concentrated under a stream of nitrogen at 50° C. and then under high vacuum. The residue was extracted with pentane (15 mL) and then toluene (5 mL) and filtered over Celite. The combined filtrate was collected and concentrated under a stream of nitrogen and then under high vacuum. The residue was extracted with hot hexane and filtered over Celite. The filtrate was cooled to −35° C., leading to precipitation of crystals. The colorless crystals were collected and concentrated under high vacuum to afford the product as clear, colorless crystals (52.1 mg, 46% yield). ¹H NMR (400 MHz, C₆D₆): δ 7.57 (d, 2H, J=2.6 Hz), 7.50 (s, 2H), 7.20-7.17 (m, 2H), 7.10-7.02 (m, 4H), 6.95 (td, 2H, J=7.5, 1.3 Hz), 6.80 (dd, 2H, J=7.6, 1.3 Hz), 3.34 (s, 6H), 2.59-2.50 (m, 6H), 2.45-2.36 (m, 6H), 2.21-2.13 (m, 6H), 2.05-1.95 (m, 6H), 1.87-1.78 (m, 6H), 1.34 (s, 18H), 0.13 (s, 6H), −0.12 (s, 3H).

### Complex 22

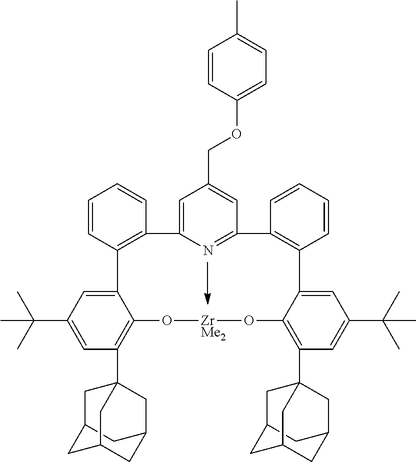

To a mixture of ZrCl₄(Et₂O)₂ (55.0 mg, 0.144 mmol) and 2′,2′″-(4-((p-tolyloxy)methyl)pyridine-2,6-diyl)bis(3-(1-adamantanyl)-5-(tert-butyl)-[1,1′-biphenyl]-2-ol) (125 mg, 0.136 mmol) in toluene (˜3 mL) chilled at −40° C., MeMgBr (3.0 M, 0.2 mL, 0.6 mmol) was added dropwise. The reaction mixture was stirred at ambient temperature for 21 hours, then concentrated under vacuum to a solid.

### Prophetic Synthesis of Complex 23

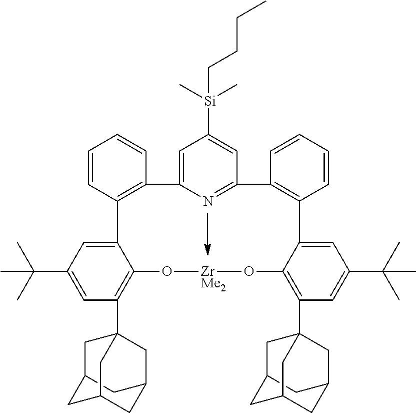

To a mixture of ZrCl₄(Et₂O)₂ (55.0 mg, 0.144 mmol) and 2′,2′″-(4-(n-butyldimethylsilyl)pyridine-2,6-diyl)bis(3-(1-adamantanyl)-5-(tert-butyl)-[1,1′-biphenyl]-2-ol) (124 mg, 0.136 mmol) in toluene (˜3 mL) chilled at −40° C., MeMgBr (3.0 M, 0.2 mL, 0.6 mmol) is added dropwise. The reaction mixture is stirred at ambient temperature for 70 minutes, then evaporated to dryness. The resulting solid is extracted with isohexane (˜10 mL total), and the combined extracts are filtered through Celite. The filtrate is then concentrated under vacuum to a solid, which can subsequently be recrystallized from hexane.

### Complex 24: Synthesis of dimethylzirconium[2′,2′″-(4-(((1S,2R,5S)-2-isopropyl-5-methylcyclohexyl)oxy)pyridine-2,6-diyl)bis(3-adamantan-1-yl)-5-(tert-butyl)-[1,1′-biphenyl]-2-olate)]

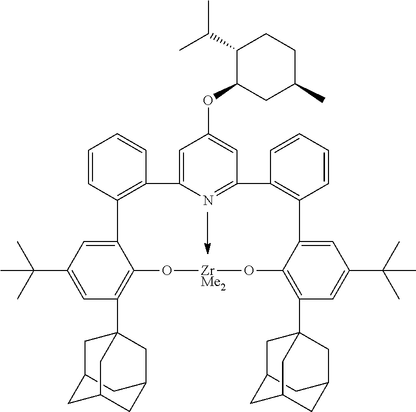

To a precooled, stirring suspension of zirconium tetrachloride (49 mg, 0.21 mmol, 1 equiv.) in toluene (2 mL), methylmagnesium bromide (0.28 mL, 3.0 M in diethyl ether, 0.84 mmol, 4 equiv.) was added. Then, a precooled solution of 2′,2′″-((4-(((1R,2S,5R)-2-isopropyl-5-methylcyclohexyl)oxy)pyridine)-2,6-diyl)bis(3-(1-adamantanyl)-5-(tert-pentyl)-[1,1′-biphenyl]-2-ol) (200 mg, 0.210 mmol) in toluene (2 mL) was added. The reaction was stirred at room temperature for 30 minutes. The reaction was concentrated under a stream of nitrogen and then under high vacuum. The residue was extracted with hexane (15 mL) and filtered over Celite. The hexane extract was concentrated under a stream of nitrogen and then under high vacuum to afford the product as a tan solid, containing hexane (0.69 equiv.) (156 mg, 66% yield). ¹H NMR (400 MHz, C₆D₆): δ 7.56 (d, 2H, J=2.6 Hz), 7.25-7.21 (m, 2H), 7.14-7.04 (m, 8H), 6.47 (d, 2H, J=12.0 Hz), 3.80-3.52 (m, 1H), 2.64-2.54 (m, 6H), 2.50-2.41 (m, 6H), 2.23-2.15 (m, 6H), 2.05-1.96 (m, 6H), 1.89-1.80 (m, 6H), 1.39-1.30 (m, 24H), 0.77-0.68 (m, 6H), 0.57 (d, 2H, J=6.5 Hz), 0.52-0.44 (m, 4H), 0.12 (s, 6H).

### Complex 25: Synthesis of dimethylzirconium[2′,2′″-(4-ethoxypyridine-2,6-diyl)bis(3-adamantan-1-yl)-5-(tert-butyl)-[1,1′-biphenyl]-2-olate)]

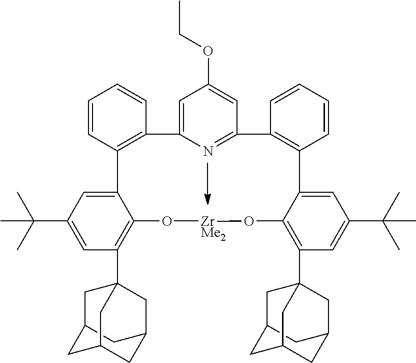

To a precooled, stirring suspension of zirconium tetrachloride (24 mg, 0.10 mmol, 1 equiv.) in toluene (5 mL), methylmagnesium bromide (0.14 mL, 3.0 M in diethyl ether, 0.42 mmol, 4.2 equiv.) was added. Then, a precooled solution of 2′,2′″-(4-ethoxypyridine-2,6-diyl)bis(3-(1-adamantanyl)-5-(tert-butyl)-[1,1′-biphenyl]-2-ol) (84 mg, 0.10 mmol) in toluene was added. The reaction was stirred at room temperature for 1 hour. The reaction was concentrated under a stream of nitrogen while heating to 70° C. and then under high vacuum. The residue was extracted with pentane (15 mL) and filtered over Celite. The pentane extract was cooled to −35° C. The resulting precipitated colorless crystals were collected and concentrated under high vacuum to afford the product as a white solid, containing hexane (1.14 equiv.) (39 mg, 37% yield). ¹H NMR (400 MHz, C₆D₆): δ 7.57 (d, 1H, J=2.6 Hz), 7.23-7.18 (m, 2H), 7.13-7.07 (m, 8H), 6.08 (s, 2H), 2.89-2.73 (m, 2H), 2.67-2.57 (m, 6H), 2.53-2.43 (m, 6H), 2.25-2.16 (m, 6H), 2.07-1.98 (m, 6H), 1.90-1.81 (m, 6H), 1.33 (s, 18H), 0.66 (t, 3H, J=7.0 Hz), 0.14 (s, 6H).

### Prophetic Synthesis of Complex 26

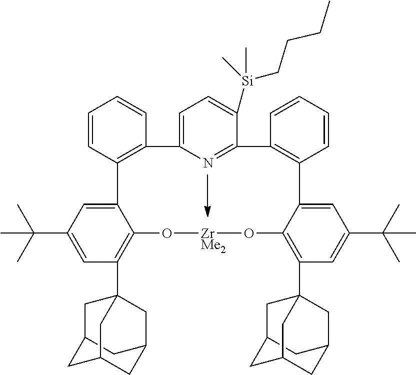

To a mixture of ZrCl₄(Et₂O)₂ (55.0 mg, 0.144 mmol) and 2′,2′″-(3-(n-butyldimethylsilyl)pyridine-2,6-diyl)bis(3-(1-adamantanyl)-5-(tert-butyl)-[1,1′-biphenyl]-2-ol) (124 mg, 0.136 mmol) in toluene (˜3 mL) chilled at −40° C., MeMgBr (3.0 M, 0.2 mL, 0.6 mmol) is added dropwise. The reaction mixture is stirred at ambient temperature for 70 minutes, then evaporated to dryness. The resulting solid is extracted with methylcyclohexane (˜10 mL total), and the combined extracts are filtered through Celite. The filtrate is then concentrated under vacuum to a solid.

### Prophetic Synthesis of Complex 27

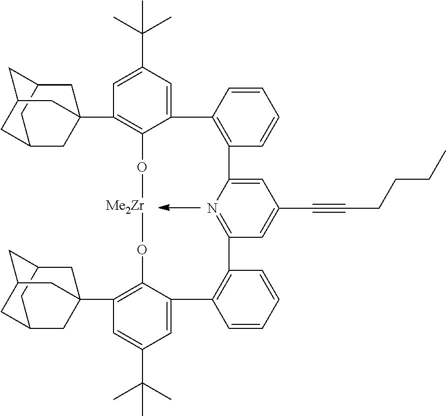

To a mixture of ZrCl₄(Et₂O)₂ (55.0 mg, 0.144 mmol) and 2′,2′″-(4-(hept-1-yn-1-yl)pyridine-2,6-diyl)bis(3-(1-adamantanyl)-5-(tert-butyl)-[1,1′-biphenyl]-2-ol) (121 mg, 0.136 mmol) in toluene (˜3 mL) chilled at −40° C., MeMgBr (3.0 M, 0.2 mL, 0.6 mmol) is added dropwise. The reaction mixture is stirred at ambient temperature for 70 minutes, then evaporated to dryness. The resulting solid is extracted with methylcyclohexane (˜10 mL total), and the combined extracts are filtered through Celite. The filtrate is then concentrated under vacuum to a solid.

### Prophetic Synthesis of Complex 28

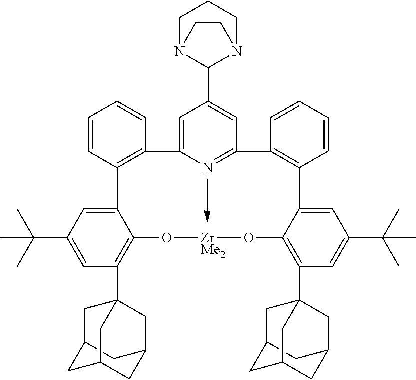

To a mixture of ZrCl₄(Et₂O)₂ (55.0 mg, 0.144 mmol) and 2′,2′″-(4-(1,5-diazabicyclo[3.2.1]octan-8-yl)pyridine-2,6-diyl)bis(3-(1-adamantanyl)-5-(tert-butyl)-[1,1′-biphenyl]-2-ol) (124 mg, 0.136 mmol) in toluene (˜3 mL) chilled at −40° C., MeMgBr (3.0 M, 0.2 mL, 0.6 mmol) is added dropwise. The reaction mixture is stirred at ambient temperature for 70 minutes, then evaporated to dryness. The resulting solid is extracted with methylcyclohexane (˜10 mL total), and the combined extracts are filtered through Celite. The filtrate is then concentrated under vacuum to a solid.

### Complex 29: Dimethylhafnium[2′,2′″-(4-(Pyrrolidin-1-yl)pyridine-2,6-diyl)bis(5-methyl-3-(3,5,7-trimethyladamantan-1-yl)-[1,1′-biphenyl]-2-olate)]

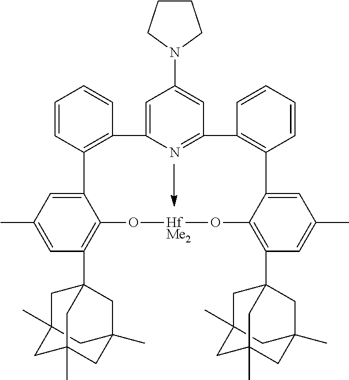

To a suspension of 111 mg (0.346 mmol) of hafnium tetrachloride in 40 ml of dry toluene, 540 ul (1.56 mmol) of 2.9 M MeMgBr in diethyl ether was added (via a syringe) in one portion at 0° C. To the resulting suspension 300 mg (0.346 mmol) of 2′,2′″-(4-(pyrrolidin-1-yl)pyridine-2,6-diyl)bis(5-methyl-3-(3,5,7-trimethyladamantan-1-yl)-[1,1′-biphenyl]-2-ol) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Next, the filtrate was evaporated to dryness. Yield 271 mg (73%) of a white solid. Anal. Calc. for C₆₃H₇₆HfN₂O₂: C, 70.60; H, 7.15; N, 2.61. Found: C, 70.92; H, 7.37; N, 2.94. ¹H NMR (C₆D₆, 400 MHz): δ 7.48 (t, J=7.4 Hz, 2H), 7.39 (d, J=7.1 Hz, 2H), 7.24-7.31 (m, 4H), 7.00-7.02 (m, 2H), 6.90 (d, J=1.5 Hz, 2H), 5.67 (s, 2H), 2.24 (s, 6H), 2.10-2.16 (m, 6H), 1.93-2.04 (m, 10H), 1.37-1.40 (m, 6H), 1.06-1.11 (m, 6H), 1.03 (s, 18H), 0.89-0.93 (m, 4H), −0.11 (s, 6H). ¹³C NMR (C₆D₆, 100 MHz) (160.7, 157.4, 143.9, 138.4, 134.7, 133.8, 133.4, 130.8, 130.1, 129.7, 129.4, 129.2, 128.9, 126.3, 126.0, 107.3, 51.2, 50.8, 47.3, 46.6, 40.9, 32.9, 31.6, 24.7, 21.8.

### Complex 30: Dimethylhafnium[2′,2′″-(4-(pyrrolidin-1-yl)pyridine-2,6-diyl)bis(3-(3,5-dimethyladamantan-1-yl)-5-methyl-[1,1′-biphenyl]-2-olate)]

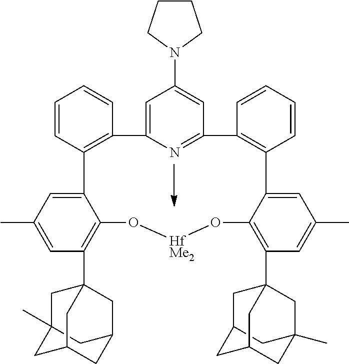

To a suspension of 96 mg (0.299 mmol) of hafnium tetrachloride in 40 ml of dry toluene, 470 ul (1.35 mmol) of 2.9 M MeMgBr in diethyl ether was added (via a syringe) in one portion at 0° C. To the resulting suspension 250 mg (0.301 mmol) of 2′,2′″-(4-(pyrrolidin-1-yl)pyridine-2,6-diyl)bis(3-(3,5-dimethyladamantan-1-yl)-5-methyl-[1,1′-biphenyl]-2-ol) was immediately added in one portion. The reaction mixture was stirred for 4 hours at room temperature and then evaporated to near dryness. The solid obtained was extracted with 2×20 ml of hot toluene, and the combined organic extract was filtered through a thin pad of Celite 503. Further on, the filtrate was evaporated to dryness. The residue was triturated with 5 ml of n-hexane, the obtained precipitate was filtered off, washed two times with 5 ml of n-hexane, and then dried in vacuo. Yield 219 mg (70%) of a white-beige solid. Anal. Calc. for C₆₁H₇₂HfN₂O₂: C, 70.20; H, 6.95; N, 2.68. Found: C, 70.55; H, 7.04; N, 2.87. ¹H NMR (C₆D₆, 400 MHz): δ 7.29-7.40 (m, 6H), 7.24-7.26 (m, 2H), 7.01-7.03 (m, 2H), 6.92 (s, 2H), 5.66 (s, 2H), 2.90-2.97 (m, 2H), 2.80-2.85 (m, 2H), 2.36 (br.s, 2H), 2.25 (s, 6H), 1.88-1.98 (m, 10H), 1.50-1.66 (m, 6H), 1.36-1.40 (m, 2H), 1.19-1.27 (m, 6H), 1.01 (s, 6H), 0.99 (s, 6H), 0.89-0.91 (m, 4H), −0.11 (s, 6H). ¹³C NMR (C₆D₆, 100 MHz) (160.5, 157.5, 144.0, 138.7, 134.2, 133.9, 133.7, 131.1, 131.0, 129.7, 129.4, 126.5, 126.0, 107.3, 52.1, 50.8, 49.5, 46.6, 44.5, 43.1, 40.3, 39.9, 32.5, 32.2, 32.0, 31.6, 31.0, 24.7, 21.5.

### Solubility of Complexes

General considerations: Solubility studies for complexes 2 were performed using recrystallized material. Solubility studies for all other complexes were performed using material as synthesized. Complex 2 was cocrystallized with 1.4 equivalents of methycyclohexane. Complex 3 was isolated with 1 equiv. pentane. Complex 4 was isolated with 0.18 equiv. hexane and 0.96 equiv. toluene. Complex 6 was isolated with 0.75 equiv. pentane. Complex 8 was isolated with 0.5 equiv. pentane. Complex 14 was isolated with 1 equiv. isohexane. Complex 16 was isolated with 0.39 equivalents toluene. Complex 20 was isolated with 2.63 equivalents of hexane and 0.28 equivalents of toluene. Complex 24 was isolated with 0.69 equivalents of hexane. Complex 25 was isolated with 1.14 equivalents of hexane. Solvents used were sparged with nitrogen (30-60 minutes) and dried over 3 Å mole sieves. Unless stated otherwise all measurements were performed at ambient temperature (20° C.-25° C.).

General procedure: Solubility was determined using the following Method 1 or Method 2. For calculations, a value of 0.672 g/mL was used for the density of isohexane.

Method 1: A tared vial was loaded with a small amount of the complex (actual mass recorded, including any residual solvent as noted above, typically 5-30 mg). Then a small stir bar (8 mm) was added. Solvent was then added and the mixture was stirred rapidly (1000 rpm). If a homogeneous mixture did not form within 30 minutes, then additional solvent was added and mixture was stirred for an additional 30 minutes. This process was repeated until either a clear solution was obtained (no visible solids or murkiness) or the vial was full. As the mixture approached homogeneity (i.e., few remaining solids observed) the volume of the solvent additions was kept small (<1 mL) to minimize excess beyond the solvent required to achieve homogeneity. The stir bar was then removed and the mass of the mixture was measured. If a clear solution had formed then the solubility of the complex was calculated as a single value, based on the mass of complex and the amount of solvent added to achieve a homogeneous solution. If the mixture remained heterogeneous (visible solids or murky), then the value reported is given as being “less than” the calculated value.

Method 2: A measured amount of complex (actual mass recorded, including any residual solvent as noted above) was added to a tared vial, followed by a stir bar. Dry isohexanes were added in small portions and the resulting mixture was stirred after each portion of isohexanes. If a clear solution had formed then the solubility was reported as a range, the lower bound of solubility calculated using the total solvent added to achieve a homogenous solution and the upper bound of solubility calculated using the total solvent measured prior to achieving a homogenous solution. If the mixture remained heterogeneous (visible solids or murky), the upper bound of solubility was calculated using the total solvent added. Formula used to calculate solubility are listed below. Solvent present in the complex is included in the mass and formula weight of the complexes.

$$Solubility ( in mM ) = [ {10}^{6} ] * [ ( grams of complex ) \text{} / ( formula wt . of complex in g / mol ) ] \text{} / [ \text{} ( total volume of solvent in mL ) ] , or$$

$$Solubility ( in mM ) = [ \text{} {10}^{6} ] * [ \text{} ( grams of complex ) \text{} / ( formula wt . of complex in g / mol ) ] \text{} / [ \text{} ( grams of solvent ) \text{} / ( density of solvent in g / mL ) ]$$

$$Solubility ( in wt \% ) = [ 100 ] * [ ( grams of complex ) \text{} / [ ( grams of complex ) + ( total volume of solvent in mL ) * ( density of solvent in g / mL ) ] ] , or \\ Solubility ( in wt \% ) = [ 100 ] * [ ( weight of complex ) \text{} / ( weight of solution ) ] .$$

TABLE 1
Solubility of select complexes in isohexane at ambient temperature.

| | Solubility (s) in | Solubility (s) in |
|---|---|---|
| Complex | Isohexane (mM) | Isohexane (wt %) |
| 1* | <0.6 | <0.08 |
| 2* | 0.52 | 0.081 |
| 3* | <3.2 | <0.5 |
| 4 | <3.1 | <0.5 |
| 6 | 12 | 1.85 |
| 8 | ≥10 | ≥1.6 |
| 14 | 3.4 | 0.56 |
| 16 | <1.5 | <0.23 |
| 18 | ≥19 | ≥3.1 |
| 20 | 3.2 ≤ s < 4.8 | 0.61 ≤ s < 0.91 |
| 21 | <2.5 | <0.39 |
| 24 | ≥10.9 | ≥1.80 |
| 25 | <3.9 | <0.62 |

*Comparative complexes

### Polymerization Examples

Solutions of the pre-catalysts were made using toluene (ExxonMobil Chemical—anhydrous, stored under N₂) (98%) or isohexane (ExxonMobil Chemical—polymerization grade, and purified as described below). Pre-catalyst solutions were typically 0.25 mmol/L.

Solvents, polymerization grade toluene and/or isohexanes were supplied by ExxonMobil Chemical Co. and are purified by passing through a series of columns: two 500 cc Oxyclear cylinders in series from Labclear (Oakland, Calif), followed by two 500 cc columns in series packed with dried 3 mole sieves (8-12 mesh; Aldrich Chemical Company), and two 500 cc columns in series packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Å mole sieves (8-12 mesh; Aldrich Chemical Company), then two 500 cc columns in series packed with 5 Å mole sieves (8-12 mesh; Aldrich Chemical Company), then a 500 cc column packed with Selexsorb CD (BASF), and finally a 500 cc column packed with Selexsorb COS (BASF).

Activation of the pre-catalysts was either by dimethylanilinium tetrakisperfluorophenylborate (Boulder Scientific or Albemarle Corp; Act ID=A) or is (hydrogenated tallow alkyl)methylammonium tetrakis(pentafluorophenyl)borate supplied as a 10 wt % solution in methylcyclohexane (Boulder Scientific; Act ID=B). Activators were typically used as a 0.25 mmol/L solution in toluene or isohexane.

Tri-n-octylaluminum (TnOAl or TNOA, Neat, AkzoNobel) was also used as a scavenger prior to introduction of the activator and pre-catalyst into the reactor. TNOA was typically used as a 5 mmol/L solution in toluene or isohexane.

### Reactor Description and Preparation:

Polymerizations were conducted in an inert atmosphere (N₂) drybox using autoclaves equipped with an external heater for temperature control, glass inserts (internal volume of reactor=23.5 mL for C₂ and C₂/C₈; 22.5 mL for C₃ runs), septum inlets, regulated supply of nitrogen, ethylene and propylene, and equipped with disposable PEEK mechanical stirrers (800 RPM). The autoclaves were prepared by purging with dry nitrogen at 110° C. or 115° C. for 5 hours and then at 25° C. for 5 hours.

### Propylene Polymerization (PP):

The reactor was prepared as described above, then heated to 40° C., and then purged with propylene gas at atmospheric pressure. Toluene or isohexanes, liquid propylene (1.0 mL) and scavenger (TNOA, 0.5 μmol) were added via syringe. The reactor was then brought to process temperature (70° C. or 100° C.) while stirring at 800 RPM. The activator solution, followed by the pre-catalyst solution, were injected via syringe to the reactor at process conditions. Reactor temperature was monitored and typically maintained within +/−1° C. Polymerizations were halted by addition of approximately 50 psi compressed dry air gas mixture to the autoclaves for approximately 30 seconds. The polymerizations were quenched based on a predetermined pressure loss (maximum quench value) or for a maximum of 30 minutes. The reactors were cooled and vented. The polymers were isolated after the solvent was removed in-vacuo. The actual quench time (s) is reported as quench time (s). Yields reported include total weight of polymer and residual catalyst. Catalyst activity is reported as grams of polymer per mmol transition metal compound per hour of reaction time (g/mmol·hr). Propylene homopolymerization examples are reported in Table 2.

### Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn) and z average molecular weight (Mz)) and molecular weight distribution (MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 pm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Table 2 under the headings Mn, Mw, Mz and PDI as defined above.

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Table 2 under the heading, Tm (° C.).

Polymerization results are collected in Tables 2 below. “Ex #” stands for example number. Example numbers starting with a “C” are comparative examples. “Cat ID” identifies the pre-catalyst used in the experiment. Corresponding numbers identifying the pre-catalyst (also referred to as pre-catalyst, catalyst, complex or compound) are located in the synthetic experimental section. T(° C.) is the polymerization temperature which was typically maintained within +/−1° C. “Yield” is polymer yield, and is not corrected for catalyst residue. “Quench time (s)” is the actual duration of the polymerization run in seconds. For propylene homopolymerization runs, quench value indicates the maximum set pressure loss (conversion) of propylene (for PP runs) during the polymerization. Activity is reported at grams polymer per mmol of catalyst per hour.

Standard polymerization conditions include 0.015 umol catalyst complex, 1.1 equivalents of activator, 0.5 umol TNOA scavenger, 1.0 mL propylene, 4.1 mL total solvent, with quench value at 8 psi pressure loss, or a maximum reaction time of 30 minutes. Activator A is N,N-dimethylanilinium tetrakis(pentafluorophenyl)borate activator and activator B is (hydrogenated tallow alkyl)methylammonium tetrakis(pentafluorophenyl)borate. When activator A was used, the pre-catalyst solution was in either isohexane or toluene and the activator solution was in toluene. When activator B was used, both pre-catalyst and activator solutions were in isohexane. Small amounts of methylcyclohexane result from activator B being supplied by the manufacturer as a 10 wt % solution in methylcyclohexane.

TABLE 2
Propylene Polymerization

| | | | Methyl- | | | | | | | | | | | |
|---|---|---|---|---|---|---|---|---|---|---|---|---|---|---|
| | | | cyclo- | Iso- | Tol- | | quench | | Activity | | | | | |
| | Cat | Act | hexane | hexane | uene | T | time | yield | (g P/mmol | | | | | Tm |
| Ex # | ID | ID | (uL) | (uL) | (uL) | (° C.) | (s) | (g) | cat • hr) | Mn | Mw | Mz | PDI | (° C.) |
| 1 | 3 | A | 0.00 | 4034 | 66 | 70 | 50 | 0.3382 | 1,623,360 | 151,894 | 555,461 | 2,204,591 | 3.66 | 150.4 |
| 2 | 3 | A | 0.00 | 4034 | 66 | 70 | 36 | 0.3518 | 2,345,333 | 189,341 | 618,660 | 1,998,977 | 3.27 | 150.9 |
| 3 | 3 | A | 0.00 | 4034 | 66 | 70 | 70 | 0.3651 | 1,251,771 | 206,080 | 676,784 | 2,471,266 | 3.28 | 150.7 |
| 4 | 3 | A | 0.00 | 4034 | 66 | 100 | 30 | 0.1677 | 1,341,600 | 97,418 | 211,821 | 590,904 | 2.17 | 149.4 |
| 5 | 3 | A | 0.00 | 4034 | 66 | 100 | 71 | 0.28 | 946,479 | 70,184 | 182,436 | 640,309 | 2.60 | 148.1 |
| 6 | 3 | A | 0.00 | 4034 | 66 | 100 | 37 | 0.1897 | 1,230,486 | 116,079 | 245,630 | 691,819 | 2.12 | 150.1 |
| 7 | 3 | B | 0.24 | 4100 | 0 | 70 | 75 | 0.322 | 1,030,400 | 251,087 | 611,739 | 1,641,465 | 2.44 | 150.5 |
| 8 | 3 | B | 0.24 | 4100 | 0 | 70 | 75 | 0.3359 | 1,074,880 | 247,428 | 605,320 | 1,654,930 | 2.45 | 150.9 |
| 9 | 3 | B | 0.24 | 4100 | 0 | 70 | 77 | 0.3318 | 1,034,182 | 294,324 | 723,438 | 2,228,894 | 2.46 | 150.5 |
| 10 | 3 | B | 0.24 | 4100 | 0 | 100 | 51 | 0.1794 | 844,235 | 136,672 | 263,279 | 693,703 | 1.93 | 148.9 |
| 11 | 3 | B | 0.24 | 4100 | 0 | 100 | 116 | 0.2302 | 476,276 | 115,932 | 217,696 | 504,146 | 1.88 | 149.8 |
| 12 | 3 | B | 0.24 | 4100 | 0 | 100 | 65 | 0.2075 | 766,154 | 136,724 | 285,817 | 859,182 | 2.09 | 148.9 |
| 13 | 5 | A | 0.00 | 3874 | 226 | 70 | 53 | 0.3608 | 1,633,811 | 111,704 | 413,967 | 1,860,388 | 3.71 | 160.5 |
| 14 | 5 | A | 0.00 | 3874 | 226 | 70 | 58 | 0.3468 | 1,435,034 | 112,081 | 370,623 | 1,344,549 | 3.31 | 161.5 |
| 15 | 5 | A | 0.00 | 3874 | 226 | 70 | 43 | 0.2401 | 1,340,093 | 158,204 | 369,419 | 1,065,481 | 2.34 | 160.5 |
| 16 | 5 | A | 0.00 | 3874 | 226 | 100 | 35 | 0.2745 | 1,882,286 | 38,830 | 97,204 | 311,943 | 2.50 | 158.2 |
| 17 | 5 | A | 0.00 | 3874 | 226 | 100 | 32 | 0.2133 | 1,599,750 | 51,958 | 108,523 | 294,920 | 2.09 | 159.2 |
| 18 | 5 | A | 0.00 | 3874 | 226 | 100 | 36 | 0.2134 | 1,422,667 | 55,842 | 131,473 | 456,860 | 2.35 | 159.0 |
| 19 | 6 | A | 0.00 | 4034 | 66 | 70 | 28 | 0.13 | 1,114,286 | 123,989 | 522,872 | 1,969,542 | 4.22 | 149.3 |
| 20 | 6 | A | 0.00 | 4034 | 66 | 70 | 16 | 0.1412 | 2,118,000 | 224,838 | 699,351 | 2,125,817 | 3.11 | 150.4 |
| 21 | 6 | A | 0.00 | 4034 | 66 | 70 | 27 | 0.2756 | 2,449,778 | 151,444 | 627,023 | 2,291,210 | 4.14 | 150.4 |
| 22 | 6 | A | 0.00 | 4034 | 66 | 70 | 51 | 0.383 | 1,802,353 | 211,091 | 680,855 | 2,346,686 | 3.23 | 149.4 |
| 23 | 6 | A | 0.00 | 4034 | 66 | 70 | 37 | 0.4007 | 2,599,135 | 207,509 | 660,935 | 2,088,549 | 3.19 | 150.3 |
| 24 | 6 | A | 0.00 | 4034 | 66 | 70 | 55 | 0.4102 | 1,789,964 | 117,329 | 548,977 | 2,732,744 | 4.68 | 150.1 |
| 25 | 6 | A | 0.00 | 4034 | 66 | 100 | 23 | 0.1954 | 2,038,957 | 95,894 | 238,471 | 799,127 | 2.49 | 149.3 |
| 26 | 6 | A | 0.00 | 4034 | 66 | 100 | 27 | 0.1923 | 1,709,333 | 124,370 | 267,934 | 702,625 | 2.15 | 149.3 |
| 27 | 6 | A | 0.00 | 4034 | 66 | 100 | 34 | 0.1831 | 1,292,471 | 130,728 | 279,702 | 781,270 | 2.14 | 149.6 |
| 28 | 6 | A | 0.00 | 4034 | 66 | 100 | 61 | 0.29 | 1,140,984 | 42,276 | 160,530 | 684,767 | 3.80 | 148.0 |
| 29 | 6 | A | 0.00 | 4034 | 66 | 100 | 58 | 0.3239 | 1,340,276 | 64,171 | 175,470 | 605,527 | 2.73 | 148.0 |
| 30 | 6 | A | 0.00 | 4034 | 66 | 100 | 25 | 0.2254 | 2,163,840 | 68,593 | 224,635 | 810,426 | 3.27 | 148.8 |
| 31 | 6 | B | 0.24 | 4100 | 0 | 70 | 47 | 0.3827 | 1,954,213 | 185,568 | 551,204 | 1,755,579 | 2.97 | 149.8 |
| 32 | 6 | B | 0.24 | 4100 | 0 | 70 | 38 | 0.379 | 2,393,684 | 158,167 | 583,411 | 2,014,124 | 3.69 | 149.6 |
| 33 | 6 | B | 0.24 | 4100 | 0 | 70 | 44 | 0.384 | 2,094,545 | 167,025 | 618,532 | 2,126,513 | 3.70 | 150.1 |
| 34 | 6 | B | 0.24 | 4100 | 0 | 100 | 1800 | 0.0068 | 907 | | | | | |
| 35 | 6 | B | 0.24 | 4100 | 0 | 100 | 1800 | 0.0086 | 1,147 | | | | | |
| 36 | 6 | B | 0.24 | 4100 | 0 | 100 | 44 | 0.2401 | 1,309,636 | 130,066 | 282,895 | 791,500 | 2.18 | 149.1 |
| 37 | 7 | A | 0.00 | 4034 | 66 | 70 | 24 | 0.3772 | 3,772,000 | 177,826 | 600,525 | 1,791,498 | 3.38 | 152.1 |
| 38 | 7 | A | 0.00 | 4034 | 66 | 70 | 50 | 0.4305 | 2,066,400 | 135,592 | 568,975 | 2,195,923 | 4.20 | 150.9 |
| 39 | 7 | A | 0.00 | 4034 | 66 | 70 | 40 | 0.3964 | 2,378,400 | 173,326 | 649,414 | 2,167,559 | 3.75 | 151.1 |
| 40 | 7 | A | 0.00 | 4034 | 66 | 100 | 24 | 0.1997 | 1,997,000 | 94,905 | 220,734 | 633,170 | 2.33 | 149.4 |
| 41 | 7 | A | 0.00 | 4034 | 66 | 100 | 46 | 0.2489 | 1,298,609 | 65,050 | 161,969 | 564,881 | 2.49 | 149.6 |
| 42 | 7 | A | 0.00 | 4034 | 66 | 100 | 25 | 0.2029 | 1,947,840 | 69,283 | 187,908 | 644,787 | 2.71 | 150.5 |
| 43 | 7 | B | 0.24 | 4100 | 0 | 70 | 26 | 0.2088 | 1,927,385 | 254,489 | 619,313 | 1,758,601 | 2.43 | 151.1 |
| 44 | 7 | B | 0.24 | 4100 | 0 | 70 | 24 | 0.3178 | 3,178,000 | 194,554 | 674,589 | 2,118,376 | 3.47 | 151.6 |
| 45 | 7 | B | 0.24 | 4100 | 0 | 70 | 24 | 0.2606 | 2,606,000 | 208,467 | 674,454 | 1,983,466 | 3.24 | 152.8 |
| 46 | 7 | B | 0.24 | 4100 | 0 | 100 | 43 | 0.2928 | 1,634,233 | 63,607 | 180,326 | 652,407 | 2.84 | 149.6 |
| 47 | 7 | B | 0.24 | 4100 | 0 | 100 | 28 | 0.2274 | 1,949,143 | 70,063 | 210,365 | 785,982 | 3.00 | 150.0 |
| 48 | 7 | B | 0.24 | 4100 | 0 | 100 | 53 | 0.3084 | 1,396,528 | 66,779 | 181,592 | 640,587 | 2.72 | 149.8 |
| 49 | 8 | A | 0.0 | 4034 | 66 | 70 | 42 | 0.2664 | 1,522,286 | 190,532 | 567,286 | 2,000,014 | 2.98 | 151.7 |
| 50 | 8 | A | 0.00 | 4034 | 66 | 70 | 28 | 0.1997 | 1,711,714 | 224,429 | 613,787 | 2,172,915 | 2.73 | 152.0 |
| 51 | 8 | A | 0.00 | 4034 | 66 | 70 | 45 | 0.2104 | 1,122,133 | 243,860 | 704,959 | 2,559,037 | 2.89 | 152.9 |
| 52 | 8 | A | 0.0 | 4034 | 66 | 100 | 33 | 0.1695 | 1,232,727 | 99,171 | 207,378 | 563,795 | 2.09 | 149.2 |
| 53 | 8 | A | 0.00 | 4034 | 66 | 100 | 38 | 0.1615 | 1,020,000 | 104,077 | 202,382 | 490,505 | 1.94 | 150.2 |
| 54 | 8 | A | 0.00 | 4034 | 66 | 100 | 46 | 0.1647 | 859,304 | 116,371 | 237,711 | 684,918 | 2.04 | 151.2 |
| 55 | 8 | B | 0.24 | 4100 | 0 | 70 | 122 | 0.2973 | 584,852 | 320,568 | 736,515 | 2,017,228 | 2.30 | 151.9 |
| 56 | 8 | B | 0.24 | 4100 | 0 | 70 | 125 | 0.2857 | 548,544 | 391,021 | 809,819 | 1,999,782 | 2.07 | 152.4 |
| 57 | 8 | B | 0.24 | 4100 | 0 | 70 | 1800 | 0 | | | | | | |
| 58 | 8 | B | 0.24 | 4100 | 0 | 100 | 306 | 0.1341 | 105,176 | 212,899 | 359,916 | 756,588 | 1.69 | 151.4 |
| 59 | 8 | B | 0.24 | 4100 | 0 | 100 | 90 | 0.1041 | 277,600 | 182,559 | 328,355 | 722,265 | 1.80 | 151.2 |
| 60 | 8 | B | 0.24 | 4100 | 0 | 100 | 157 | 0.093 | 142,166 | 225,460 | 372,409 | 749,115 | 1.65 | 150.2 |
| 61 | 10 | A | 0.00 | 3874 | 226 | 70 | 154 | 0.2425 | 377,922 | 276,325 | 484,221 | 985,302 | 1.75 | 165.4 |
| 62 | 10 | A | 0.00 | 3874 | 226 | 70 | 155 | 0.2525 | 390,968 | 246,374 | 440,261 | 968,010 | 1.79 | 162.7 |
| 63 | 10 | A | 0.00 | 3874 | 226 | 70 | 204 | 0.1916 | 225,412 | 285,174 | 518,479 | 1,014,592 | 1.82 | 164.7 |
| 64 | 10 | A | 0.00 | 3874 | 226 | 100 | 117 | 0.2054 | 421,333 | 71,485 | 117,806 | 246,167 | 1.65 | 161.5 |
| 65 | 10 | A | 0.00 | 3874 | 226 | 100 | 102 | 0.1149 | 270,353 | 67,151 | 126,498 | 332,212 | 1.88 | 162.4 |
| 66 | 10 | A | 0.0 | 3874 | 226 | 100 | 112 | 0.1513 | 324,214 | 79,019 | 135,287 | 309,176 | 1.71 | 162.3 |
| 67 | 11 | A | 0.0 | 3874 | 226 | 70 | 12 | 0.2696 | 5,392,000 | 85,345 | 418,001 | 2,092,346 | 4.90 | 148.2 |
| 68 | 11 | A | 0.00 | 3874 | 226 | 70 | 12 | 0.4107 | 8,214,000 | 78,796 | 421,062 | 1,759,176 | 5.34 | 148.5 |
| 69 | 11 | A | 0.00 | 3874 | 226 | 70 | 14 | 0.4284 | 7,344,000 | 80,113 | 451,170 | 1,886,804 | 5.63 | 148.0 |
| 70 | 11 | A | 0.00 | 3874 | 226 | 100 | 30 | 0.3229 | 2,583,200 | 35,171 | 129,815 | 506,993 | 3.69 | 145.6 |
| 71 | 11 | A | 0.00 | 3874 | 226 | 100 | 13 | 0.235 | 4,338,462 | 42,251 | 161,310 | 732,091 | 3.82 | 146.9 |
| 72 | 11 | A | 0.00 | 3874 | 226 | 100 | 41 | 0.3807 | 2,228,488 | 23,993 | 137,525 | 755,452 | 5.73 | 144.2 |
| 73 | 12 | A | 0.00 | 3874 | 226 | 70 | 9 | 0.4294 | 11,450,667 | 96,781 | 454,705 | 2,044,751 | 4.70 | 148.2 |
| 74 | 12 | A | 0.00 | 3874 | 226 | 70 | 10 | 0.4165 | 9,996,000 | 68,493 | 431,490 | 1,855,447 | 6.30 | 148.2 |
| 75 | 12 | A | 0.00 | 3874 | 226 | 70 | 13 | 0.4245 | 7,836,923 | 73,553 | 442,396 | 1,697,041 | 6.01 | 147.7 |
| 76 | 12 | A | 0.00 | 3874 | 226 | 100 | 9 | 0.2375 | 6,333,333 | 39,509 | 147,311 | 686,788 | 3.73 | 147.4 |
| 77 | 12 | A | 0.00 | 3874 | 226 | 100 | 1800 | 0.0153 | 2,040 | 288,159 | 492,385 | 1,081,315 | 1.71 | 151.9 |
| 78 | 12 | A | 0.00 | 3874 | 226 | 100 | 18 | 0.3588 | 4,784,000 | 30,897 | 139,863 | 555,053 | 4.53 | 145.2 |
| 79 | 13 | A | 0.00 | 3874 | 226 | 70 | 19 | 0.3867 | 4,884,632 | 98,474 | 424,865 | 1,475,812 | 4.31 | 148.2 |
| 80 | 13 | A | 0.00 | 3874 | 226 | 70 | 11 | 0.4058 | 8,853,818 | 104,653 | 453,006 | 1,656,967 | 4.33 | 148.4 |
| 81 | 13 | A | 0.00 | 3874 | 226 | 70 | 11 | 0.4163 | 9,082,909 | 112,685 | 492,704 | 1,932,058 | 4.37 | 148.2 |
| 82 | 13 | A | 0.00 | 3874 | 226 | 100 | 10 | 0.2421 | 5,810,400 | 45,122 | 148,444 | 544,224 | 3.29 | 147.0 |
| 83 | 13 | A | 0.00 | 3874 | 226 | 100 | 13 | 0.2773 | 5,119,385 | 39,188 | 153,229 | 585,696 | 3.91 | 146.1 |
| 84 | 13 | A | 0.00 | 3874 | 226 | 100 | 11 | 0.2706 | 5,904,000 | 45,817 | 166,142 | 628,372 | 3.63 | 146.1 |
| 85 | 14 | A | 0.00 | 3874 | 226 | 70 | 14 | 0.3776 | 6,473,143 | 103,660 | 368,787 | 1,230,137 | 3.56 | 146.2 |
| 86 | 14 | A | 0.00 | 3874 | 226 | 70 | 9 | 0.3834 | 10,224,000 | 88,726 | 416,071 | 1,496,103 | 4.69 | 146.6 |
| 87 | 14 | A | 0.00 | 3874 | 226 | 70 | 12 | 0.423 | 8,460,000 | 84,277 | 368,723 | 1,352,000 | 4.38 | 146.0 |
| 88 | 14 | A | 0.00 | 3874 | 226 | 100 | 9 | 0.2729 | 7,277,333 | 62,035 | 205,423 | 930,879 | 3.31 | 144.9 |
| 89 | 14 | A | 0.00 | 3874 | 226 | 100 | 28 | 0.3492 | 2,993,143 | 38,362 | 146,814 | 600,250 | 3.83 | 142.6 |
| 90 | 14 | A | 0.00 | 3874 | 226 | 100 | 20 | 0.247 | 2,964,000 | 85,959 | 210,714 | 672,654 | 2.45 | 146.2 |
| 91 | 15 | A | 0.00 | 3874 | 226 | 70 | 14 | 0.2886 | 4,947,429 | 114,448 | 405,000 | 1,445,675 | 3.54 | 146.9 |
| 92 | 15 | A | 0.00 | 3874 | 226 | 70 | 9 | 0.4053 | 10,808,000 | 73,621 | 445,221 | 1,728,655 | 6.05 | 147.9 |
| 93 | 15 | A | 0.00 | 3874 | 226 | 70 | 16 | 0.3677 | 5,515,500 | 65,344 | 383,592 | 1,516,444 | 5.87 | 147.2 |
| 94 | 15 | A | 0.00 | 3874 | 226 | 100 | 9 | 0.2368 | 6,314,667 | 44,505 | 146,094 | 569,991 | 3.28 | 146.9 |
| 95 | 15 | A | 0.00 | 3874 | 226 | 100 | 28 | 0.3628 | 3,109,714 | 30,964 | 131,217 | 558,466 | 4.24 | 144.4 |
| 96 | 15 | A | 0.00 | 3874 | 226 | 100 | 17 | 0.3115 | 4,397,647 | 53,425 | 184,745 | 764,854 | 3.46 | 146.7 |
| 97 | 16 | A | 0.00 | 3874 | 226 | 70 | 18 | 0.409 | 5,453,333 | 144,102 | 425,254 | 1,410,377 | 2.95 | 146.6 |
| 98 | 16 | A | 0.00 | 3874 | 226 | 70 | 20 | 0.4158 | 4,989,600 | 184,989 | 553,873 | 1,651,269 | 2.99 | 146.6 |
| 99 | 16 | A | 0.00 | 3874 | 226 | 70 | 23 | 0.3951 | 4,122,783 | 120,303 | 417,368 | 1,326,635 | 3.47 | 148.0 |
| 100 | 16 | A | 0.00 | 3874 | 226 | 70 | 21 | 0.3933 | 4,494,857 | 101,965 | 390,733 | 1,395,599 | 3.83 | 146.4 |
| 101 | 16 | A | 0.00 | 3874 | 226 | 70 | 21 | 0.3986 | 4,555,429 | 86,349 | 363,588 | 1,311,440 | 4.21 | 146.2 |
| 102 | 16 | A | 0.00 | 3874 | 226 | 70 | 16 | 0.3745 | 5,617,500 | 99,327 | 426,781 | 1,767,513 | 4.30 | 147.2 |
| 103 | 16 | A | 0.00 | 3874 | 226 | 100 | 11 | 0.2431 | 5,304,000 | 49,994 | 140,291 | 421,146 | 2.81 | 145.6 |
| 104 | 16 | A | 0.00 | 3874 | 226 | 100 | 11 | 0.2329 | 5,081,455 | 67,947 | 169,515 | 529,657 | 2.49 | 146.5 |
| 105 | 16 | A | 0.00 | 3874 | 226 | 100 | 16 | 0.3247 | 4,870,500 | 73,709 | 163,976 | 455,386 | 2.22 | 144.8 |
| 106 | 16 | A | 0.00 | 3874 | 226 | 100 | 23 | 0.2716 | 2,834,087 | 43,772 | 140,129 | 512,768 | 3.20 | 144.7 |
| 107 | 16 | A | 0.00 | 3874 | 226 | 100 | 26 | 0.3115 | 2,875,385 | 43,483 | 129,598 | 437,495 | 2.98 | 144.4 |
| 108 | 16 | A | 0.00 | 3874 | 226 | 100 | 25 | 0.3195 | 3,067,200 | 36,686 | 129,487 | 421,721 | 3.53 | 143.9 |
| 109 | 17 | A | 0.00 | 3874 | 226 | 70 | 10 | 0.3476 | 8,342,400 | 147,068 | 519,899 | 1,904,286 | 3.54 | 149.3 |
| 110 | 17 | A | 0.00 | 3874 | 226 | 70 | 12 | 0.4134 | 8,268,000 | 138,313 | 555,872 | 1,886,653 | 4.02 | 149.3 |
| 111 | 17 | A | 0.00 | 3874 | 226 | 70 | 13 | 0.4127 | 7,619,077 | 119,485 | 482,578 | 1,403,518 | 4.04 | 149.6 |
| 112 | 17 | A | 0.00 | 3874 | 226 | 100 | 11 | 0.253 | 5,520,000 | 39,218 | 105,137 | 276,982 | 2.68 | 147.6 |
| 113 | 17 | A | 0.00 | 3874 | 226 | 100 | 13 | 0.2571 | 4,746,462 | 41,767 | 141,661 | 495,175 | 3.39 | 148.1 |
| 114 | 17 | A | 0.00 | 3874 | 226 | 100 | 12 | 0.2623 | 5,246,000 | 48,101 | 146,027 | 462,866 | 3.04 | 148.1 |
| 115 | 18 | A | 0.00 | 3874 | 226 | 70 | 17 | 0.2278 | 3,216,000 | 125,786 | 418,790 | 1,328,961 | 3.33 | 150.1 |
| 116 | 18 | A | 0.00 | 3874 | 226 | 70 | 24 | 0.3645 | 3,645,000 | 133,289 | 539,464 | 1,938,247 | 4.05 | 150.3 |
| 117 | 18 | A | 0.00 | 3874 | 226 | 70 | 53 | 0.4093 | 1,853,434 | 147,593 | 527,502 | 1,763,934 | 3.57 | 151.8 |
| 118 | 18 | A | 0.00 | 3874 | 226 | 100 | 15 | 0.218 | 3,488,000 | 53,899 | 178,265 | 698,518 | 3.31 | 149.3 |
| 119 | 18 | A | 0.00 | 3874 | 226 | 100 | 19 | 0.2268 | 2,864,842 | 78,096 | 175,499 | 485,432 | 2.25 | 149.6 |
| 120 | 18 | A | 0.00 | 3874 | 226 | 100 | 24 | 0.2281 | 2,281,000 | 82,032 | 190,272 | 586,937 | 2.32 | 150.3 |
| 121 | 20 | A | 0.00 | 3974 | 126 | 70 | 23 | 0.3244 | 3,385,043 | 158,713 | 548,995 | 1,800,285 | 3.46 | 149.6 |
| 122 | 20 | A | 0.00 | 3974 | 126 | 70 | 35 | 0.2923 | 2,004,343 | 127,497 | 494,739 | 1,558,815 | 3.88 | 149.9 |
| 123 | 20 | A | 0.00 | 3974 | 126 | 70 | 27 | 0.4063 | 3,611,556 | 119,662 | 478,805 | 1,693,000 | 4.00 | 149.9 |
| 124 | 20 | A | 0.00 | 3974 | 126 | 100 | 19 | 0.2743 | 3,464,842 | 43,824 | 182,286 | 731,617 | 4.16 | 147.9 |
| 125 | 20 | A | 0.00 | 3974 | 126 | 100 | 24 | 0.3124 | 3,124,000 | 39,343 | 165,972 | 607,705 | 4.22 | 147.8 |
| 126 | 20 | A | 0.00 | 3974 | 126 | 100 | 18 | 0.2412 | 3,216,000 | 47,768 | 181,664 | 651,150 | 3.80 | 148.3 |
| 127 | 20 | B | 0.24 | 4100 | 0 | 70 | 43 | 0.3357 | 1,873,674 | 165,786 | 520,313 | 1,653,454 | 3.14 | 152.0 |
| 128 | 20 | B | 0.24 | 4100 | 0 | 70 | 30 | 0.2811 | 2,248,800 | 168,482 | 593,392 | 2,215,668 | 3.52 | 154.9 |
| 129 | 20 | B | 0.24 | 4100 | 0 | 70 | 64 | 0.2524 | 946,500 | 236,275 | 676,326 | 2,449,226 | 2.86 | 151.9 |
| 130 | 20 | B | 0.24 | 4100 | 0 | 100 | 22 | 0.2018 | 2,201,455 | 65,498 | 217,114 | 784,482 | 3.31 | 149.9 |
| 131 | 20 | B | 0.24 | 4100 | 0 | 100 | 24 | 0.2249 | 2,249,000 | 67,623 | 214,229 | 732,187 | 3.17 | 150.7 |
| 132 | 20 | B | 0.24 | 4100 | 0 | 100 | 34 | 0.1973 | 1,392,706 | 88,790 | 243,728 | 891,050 | 2.74 | 150.2 |
| 133 | 21 | A | 0.00 | 3974 | 126 | 70 | 41 | 0.2378 | 1,392,000 | 220,976 | 617,413 | 1,885,701 | 2.79 | 151.9 |
| 134 | 21 | A | 0.00 | 3974 | 126 | 70 | 90 | 0.3464 | 923,733 | 220,811 | 584,640 | 1,708,962 | 2.65 | 150.1 |
| 135 | 21 | A | 0.00 | 3974 | 126 | 70 | 88 | 0.2736 | 746,182 | 349,117 | 774,167 | 2,273,239 | 2.22 | 149.9 |
| 136 | 21 | A | 0.00 | 3974 | 126 | 100 | 62 | 0.1821 | 704,903 | 127,983 | 256,863 | 588,711 | 2.01 | 148.9 |
| 137 | 21 | A | 0.00 | 3974 | 126 | 100 | 92 | 0.1804 | 470,609 | 148,774 | 313,400 | 836,647 | 2.11 | 148.9 |
| 138 | 21 | A | 0.00 | 3974 | 126 | 100 | 104 | 0.1882 | 434,308 | 160,799 | 339,956 | 828,216 | 2.11 | 148.8 |
| 139 | 21 | B | 0.24 | 4100 | 0 | 70 | 1800 | 0.0096 | 1,280 | | | | | |
| 140 | 21 | B | 0.24 | 4100 | 0 | 70 | 586 | 0.0818 | 33,502 | 539,968 | 1,304,227 | 3,600,940 | 2.42 | 148.2 |
| 141 | 21 | B | 0.24 | 4100 | 0 | 70 | 812 | 0.0811 | 23,970 | 600,754 | 1,315,649 | 3,187,408 | 2.19 | 148.8 |
| 142 | 21 | B | 0.24 | 4100 | 0 | 100 | 898 | 0.1523 | 40,704 | 224,904 | 453,590 | 1,056,100 | 2.02 | 148.5 |
| 143 | 21 | B | 0.24 | 4100 | 0 | 100 | 452 | 0.0694 | 36,850 | 193,556 | 423,974 | 1,099,584 | 2.19 | 147.5 |
| 144 | 21 | B | 0.24 | 4100 | 0 | 100 | 431 | 0.0689 | 38,367 | 203,210 | 432,138 | 1,035,183 | 2.13 | 147.2 |
| 145 | 24 | A | 0.00 | 3974 | 126 | 70 | 20 | 0.3567 | 4,280,400 | 54,134 | 432,322 | 2,118,819 | 7.99 | 152.4 |
| 146 | 24 | A | 0.00 | 3974 | 126 | 70 | 18 | 0.2734 | 3,645,333 | 77,716 | 409,239 | 1,708,015 | 5.27 | 152.5 |
| 147 | 24 | A | 0.00 | 3974 | 126 | 100 | 13 | 0.2217 | 4,092,923 | 28,497 | 148,028 | 896,618 | 5.19 | 150.4 |
| 148 | 24 | A | 0.00 | 3974 | 126 | 100 | 42 | 0.3446 | 1,969,143 | 30,325 | 139,800 | 749,177 | 4.61 | 149.7 |
| 149 | 24 | A | 0.00 | 3974 | 126 | 100 | 18 | 0.2544 | 3,392,000 | 29,678 | 133,797 | 655,420 | 4.51 | 150.9 |
| 150 | 24 | A | 0.24 | 4100 | 0 | 70 | 56 | 0.3859 | 1,653,857 | 82,659 | 520,772 | 2,783,835 | 6.30 | 152.3 |
| 151 | 24 | B | 0.24 | 4100 | 0 | 70 | 65 | 0.4094 | 1,511,631 | 77,691 | 466,449 | 2,207,710 | 6.00 | 152.0 |
| 152 | 24 | B | 0.24 | 4100 | 0 | 70 | 58 | 0.3768 | 1,559,172 | 135,808 | 616,963 | 3,408,557 | 4.54 | 154.3 |
| 153 | 24 | B | 0.24 | 4100 | 0 | 100 | 27 | 0.2201 | 1,956,444 | 60,653 | 160,317 | 536,864 | 2.64 | 151.9 |
| 154 | 24 | B | 0.24 | 4100 | 0 | 100 | 24 | 0.1909 | 1,909,000 | 49,656 | 166,508 | 619,964 | 3.35 | 151.4 |
| 155 | 24 | B | 0.24 | 4100 | 0 | 100 | 28 | 0.2224 | 1,906,286 | 70,848 | 185,918 | 652,967 | 2.62 | 152.0 |
| 156 | 25 | B | 0.00 | 3974 | 126 | 70 | 14 | 0.2985 | 5,117,143 | 46,581 | 352,775 | 1,725,891 | 7.57 | 151.2 |
| 157 | 25 | A | 0.00 | 3974 | 126 | 70 | 13 | 0.3284 | 6,062,769 | 47,507 | 392,343 | 1,633,339 | 8.26 | 153.4 |
| 158 | 25 | A | 0.00 | 3974 | 126 | 70 | 13 | 0.3994 | 7,373,538 | 45,138 | 500,639 | 3,073,484 | 11.09 | 152.8 |
| 159 | 25 | A | 0.00 | 3974 | 126 | 100 | 27 | 0.3185 | 2,831,111 | 20,236 | 101,918 | 516,138 | 5.04 | 148.9 |
| 160 | 25 | A | 0.00 | 3974 | 126 | 100 | 28 | 0.3314 | 2,840,571 | 20,604 | 108,343 | 568,877 | 5.26 | 149.2 |
| 161 | 25 | A | 0.00 | 3974 | 126 | 100 | 14 | 0.2447 | 4,194,857 | 32,005 | 127,643 | 578,295 | 3.99 | 149.9 |
| 162 | 25 | A | 0.24 | 4100 | 0 | 70 | 36 | 0.3599 | 2,399,333 | 114,361 | 562,792 | 2,138,163 | 4.92 | 151.6 |
| 163 | 25 | B | 0.24 | 4100 | 0 | 70 | 27 | 0.2591 | 2,303,111 | 120,821 | 559,569 | 2,172,280 | 4.63 | 153.6 |
| 164 | 25 | B | 0.24 | 4100 | 0 | 70 | 45 | 0.3468 | 1,849,600 | 147,226 | 610,359 | 2,414,481 | 4.15 | 153.4 |
| 165 | 25 | B | 0.24 | 4100 | 0 | 100 | 24 | 0.2138 | 2,138,000 | 53,850 | 194,338 | 766,237 | 3.61 | 151.3 |
| 166 | 25 | B | 0.24 | 4100 | 0 | 100 | 24 | 0.2134 | 2,134,000 | 64,885 | 190,034 | 709,026 | 2.93 | 151.4 |
| 167 | 25 | B | 0.24 | 4100 | 0 | 100 | 27 | 0.2056 | 1,827,556 | 71,586 | 209,295 | 793,125 | 2.92 | 150.4 |
| 168 | 29 | A | | 3874 | 226 | 70 | 166 | 0.1232 | 178,120 | 530,963 | 842,973 | 1,545,448 | 1.59 | 166.3 |
| 169 | 29 | A | | 3874 | 226 | 70 | 220 | 0.1709 | 186,436 | 561,086 | 875,606 | 1,608,291 | 1.56 | 165.1 |
| 170 | 29 | A | 0.00 | 3874 | 226 | 70 | 200 | 0.1892 | 227,040 | 561,631 | 885,361 | 1,625,761 | 1.58 | 164.0 |
| 171 | 29 | A | 0.00 | 3874 | 226 | 100 | 1802 | 0.0063 | 839 | | | | | |
| 172 | 29 | A | 0.00 | 3874 | 226 | 100 | 156 | 0.1203 | 185,077 | 140,879 | 229,658 | 460,674 | 1.63 | 162.0 |
| 173 | 29 | A | 0.00 | 3874 | 226 | 100 | 140 | 0.1116 | 191,314 | 137,710 | 237,988 | 518,507 | 1.73 | 161.8 |
| 174 | 30 | A | 0.00 | 3874 | 226 | 70 | 1801 | 0.0533 | 7,103 | 186,851 | 346,587 | 762,107 | 1.85 | 163.3 |
| 175 | 30 | A | 0.00 | 3874 | 226 | 70 | 1801 | 0.0513 | 6,836 | 187,906 | 346,773 | 711,356 | 1.85 | 163.5 |
| 176 | 30 | A | 0.00 | 3874 | 226 | 70 | 1800 | 0.0640 | 8,533 | 245,411 | 427,041 | 871,754 | 1.74 | 164.8 |
| 177 | 30 | A | 0.00 | 3874 | 226 | 100 | 1800 | 0.0334 | 4,453 | 86,554 | 147,732 | 301,600 | 1.71 | 158.0 |
| 178 | 30 | A | 0.00 | 3874 | 226 | 100 | 1800 | 0.0503 | 6,707 | 106,308 | 177,827 | 354,753 | 1.67 | 158.7 |
| 179 | 30 | A | 0.00 | 3874 | 226 | 100 | 1613 | 0.0584 | 8,689 | 121,006 | 199,815 | 438,188 | 1.65 | 159.0 |
| C-1 | 1 | A | 0.00 | 3874 | 226 | 70 | 15 | 0.3543 | 5,668,800 | 57,753 | 372,797 | 1,464,190 | 6.46 | 147.5 |
| C-2 | 1 | A | 0.00 | 3874 | 226 | 70 | 13 | 0.4127 | 7,619,077 | 64,376 | 502,821 | 2,141,863 | 7.81 | 147.3 |
| C-3 | 1 | A | 0.00 | 3874 | 226 | 70 | 14 | 0.4037 | 6,920,571 | 67,290 | 428,075 | 1,753,319 | 6.36 | 148.1 |
| C-4 | 1 | A | 0.00 | 3874 | 226 | 100 | 16 | 0.2621 | 3,931,500 | 28,762 | 152,087 | 646,646 | 5.29 | 145.8 |
| C-5 | 1 | A | 0.00 | 3874 | 226 | 100 | 17 | 0.3151 | 4,448,471 | 34,553 | 155,815 | 665,846 | 4.51 | 145.8 |
| C-6 | 1 | A | 0.00 | 3874 | 226 | 100 | 20 | 0.2204 | 2,644,800 | 48,560 | 169,007 | 624,200 | 3.48 | 147.0 |
| C-7 | 2 | A | 0.00 | 3974 | 126 | 70 | 17 | 0.3777 | 5,332,235 | 51,771 | 409,655 | 1,643,708 | 7.91 | 147.1 |
| C-8 | 2 | A | 0.00 | 3974 | 126 | 70 | 22 | 0.431 | 4,701,818 | 73,251 | 422,884 | 1,794,768 | 5.77 | 147.1 |
| C-9 | 2 | A | 0.00 | 3974 | 126 | 70 | 10 | 0.4143 | 9,943,200 | 79,137 | 427,915 | 1,704,507 | 5.41 | 148.3 |
| C-10 | 2 | A | 0.00 | 3974 | 126 | 100 | 19 | 0.2842 | 3,589,895 | 41,269 | 157,755 | 608,816 | 3.82 | 147.6 |
| C-11 | 2 | A | 0.00 | 3974 | 126 | 100 | 21 | 0.3363 | 3,843,429 | 20,519 | 118,735 | 547,511 | 5.79 | 145.6 |
| C-12 | 2 | A | 0.00 | 3974 | 126 | 100 | 8 | 0.2458 | 7,374,000 | 31,384 | 149,968 | 649,731 | 4.78 | 146.6 |
| C-13 | 2 | B | 0.24 | 4100 | 0 | 70 | 41 | 0.3535 | 2,069,268 | 142,243 | 528,329 | 1,786,121 | 3.71 | 148.8 |
| C-14 | 2 | B | 0.24 | 4100 | 0 | 70 | 20 | 0.3501 | 4,201,200 | 146,842 | 583,343 | 2,112,818 | 3.97 | 149.3 |
| C-15 | 2 | B | 0.24 | 4100 | 0 | 70 | 22 | 0.2818 | 3,074,182 | 153,727 | 515,347 | 1,774,716 | 3.35 | 148.6 |
| C-16 | 2 | B | 0.24 | 4100 | 0 | 100 | 24 | 0.2345 | 2,345,000 | 63,491 | 180,083 | 621,548 | 2.84 | 148.0 |
| C-17 | 2 | B | 0.24 | 4100 | 0 | 100 | 22 | 0.2459 | 2,682,545 | 54,833 | 161,679 | 531,840 | 2.95 | 147.3 |
| C-18 | 2 | B | 0.24 | 4100 | 0 | 100 | 31 | 0.2874 | 2,225,032 | 47,288 | 169,722 | 733,298 | 3.59 | 148.0 |

Polymerizations were also carried out in a continuous stirred tank reactor system. A 1-liter Autoclave reactor was equipped with a stirrer, a pressure controller, and a water cooling/steam heating element with a temperature controller. The reactor was operated in liquid fill condition at a reactor pressure in excess of the bubbling point pressure of the reactant mixture, keeping the reactants in liquid phase. Isohexane and propylene were pumped into the reactors by Pulsa feed pumps. All flow rates of liquid were controlled using Coriolis mass flow controller (Quantim series from Brooks). Ethylene flowed as a gas under its own pressure through a Brooks flow controller. Ethylene and propylene feeds were combined into one stream and then mixed with a pre-chilled isohexane stream that had been cooled to at least 0° C. The mixture was then fed to the reactor through a single line. Solutions of tri(n-octyl)aluminum were added to the combined solvent and monomer stream just before they entered the reactor. Catalyst solution was fed to the reactor using an ISCO syringe pump through a separated line.

Isohexane (used as solvent), and monomers (e.g., propylene and ethylene) were purified over beds of alumina and molecular sieves. Toluene and isohexane used for preparing catalyst solutions were purified by the same technique.

The polymer produced in the reactor exited through a back pressure control valve that reduced the pressure to atmospheric. This caused the unconverted monomers in the solution to flash into a vapor phase which was vented from the top of a vapor liquid separator. The liquid phase, comprising mainly polymer and solvent, was collected for polymer recovery. The collected samples were first air-dried in a hood to evaporate most of the solvent, and then dried in a vacuum oven at a temperature of about 90° C. for about 12 hours. The vacuum oven dried samples were weighed to obtain yields. All the reactions were carried out at a pressure of about 2.4 MPa/g unless otherwise mentioned.

The detailed polymerization process conditions and physical properties of the polymers produced are listed in Table C₁ below. N,N-dimethylanilinium tetrakis(pentafluorophenyl)borate was used as the activator for all polymerization. Catalyst solution was prepared by combining the catalyst with the activator in toluene. Examples G01 to G06 are propylene-ethylene copolymer made from Catalyst 6. Examples G07 to G11 are propylene-ethylene copolymer made from Catalyst 15. Examples G12 to G13 are propylene-ethylene copolymer made from Catalyst 14.

Ethylene content is determined using FTIR according the ASTM D3900.

Peak melting point, Tm, (also referred to as melting point), peak crystallization temperature, Tc, (also referred to as crystallization temperature), and glass transition temperature (Tg), and heat of fusion (ΔHf or Hf) were determined using a differential scanning calorimetric (DSC) from TA Instruments (model Q200) according to procedure of ASTM D3418-03.

MFR is melt flow rate in g/10 min measured at a temperature of 230° C. and a weight of 2.16 kg according to ASTM D1238. HL MFR is melt flow rate in g/10 min. measured at a temperature of 230° C. and a weight of 21.6 kg according to ASTM D1238.

TABLE C1

| Example # | G01 | G02 | G03 | G04 | G05 |
|---|---|---|---|---|---|
| Polymerization | 70 | 90 | 120 | 140 | 70 |
| temperature (° C.) | | | | | |
| Ethylene feed rate | 1.92 | 1.92 | 1.92 | 1.92 | 1.92 |
| (g/min) | | | | | |
| Propylene feed rate | 14 | 14 | 14 | 14 | 14 |
| (g/min) | | | | | |
| Isohexane feed rate | 49.5 | 58.5 | 58.5 | 49.5 | 58.7 |
| (g/min) | | | | | |
| Catalyst feed rate | 1.144E−08 | 1.144E−08 | 1.601E−08 | 2.287E−08 | 1.830E−08 |
| (mol/min) | | | | | |
| Activator feed rate | 1.167E−08 | 1.167E−08 | 1.634E−08 | 2.334E−08 | 1.867E−08 |
| (mol/min) | | | | | |
| TNOA feed rate | 6.172E−06 | 6.172E−06 | 6.172E−06 | 6.172E−06 | 3.703E−06 |
| (mol/min) | | | | | |
| Yield (g/min) | 7.8 | 7.1 | 12.0 | 13.0 | 7.3 |
| Conversion (%) | 48.7% | 44.5% | 75.4% | 81.8% | 45.7% |
| Catalyst Efficiency | 697,500 | 637,200 | 772,071 | 586,050 | 409,826 |
| (kg polymer/kg | | | | | |
| catalyst) | | | | | |
| MFR (g/10 min) | 2.55 | 6.99 | 193.18 | >300 | 1.35 |
| HL MFR (g/10 min) | 111.55 | 296.90 | >300 | >300 | 59.47 |
| Ethylene content | 17.1% | 18.3% | 13.0% | 59.5% | 16.6% |
| (FTIR) (wt %) | | | | | |
| Tg (° C.) | | | | | −31.5 |
| Example # | G06 | G07 | G08 | G09 | G10 |
| Polymerization | 120 | 70 | 120 | 120 | 70 |
| temperature (° C.) | | | | | |
| Ethylene feed rate | 1.92 | 1.92 | 1.92 | 1.92 | 1.92 |
| (g/min) | | | | | |
| Propylene feed rate | 14 | 14 | 14 | 14 | 14 |
| (g/min) | | | | | |
| Isohexane feed rate | 56.7 | 47.7 | 47.7 | 56.7 | 57.8 |
| (g/min) | | | | | |
| Catalyst feed rate | 2.287E−08 | 1.389E−08 | 2.977E−08 | 9.923E−08 | 5.954E−09 |
| (mol/min) | | | | | |
| Activator feed rate | 2.334E−08 | 1.418E−08 | 3.038E−08 | 1.013E−07 | 6.075E−09 |
| (mol/min) | | | | | |
| TNOA feed rate | 3.703E−06 | 3.703E−06 | 3.703E−06 | 3.703E−06 | 5.212E−06 |
| (mol/min) | | | | | |
| Yield (g/min) | 14.4 | 9.2 | 12.6 | 13.4 | 8.6 |
| Conversion (%) | 90.7% | 57.6% | 79.3% | 83.9% | 54.1% |
| Catalyst Efficiency | 649,778 | 589,489 | 378,629 | 120,222 | 1,293,046 |
| (kg polymer/kg | | | | | |
| catalyst) | | | | | |
| MFR (g/10 min) | 284.69 | 1.42 | 38.34 | 84.93 | 2.00 |
| HL MFR (g/10 min) | | 61.53 | 1964.34 | 3728.05 | 76.34 |
| Ethylene content | 12.6% | 15.7% | 13.3% | 12.3% | 15.0% |
| (FTIR) (wt %) | | | | | |
| Tc (° C.) | 12.5 | | | | |
| Tm (° C.) | 69.1 | | | | |
| Tg (° C.) | −29.2 | | | | |
| Heat of fusion (J/g) | 36.6 | | | | |

| Example # | G11 | G12 | G13 |
|---|---|---|---|
| Polymerization | 120 | 80 | 120 |
| temperature (° C.) | | | |
| Ethylene feed rate | 1.92 | 1.92 | 1.92 |
| (g/min) | | | |
| Propylene feed rate | 14 | 14 | 14 |
| (g/min) | | | |
| Isohexane feed rate | 57.8 | 57.8 | 57.8 |
| (g/min) | | | |
| Catalyst feed rate | 3.969E−08 | 5.974E−09 | 1.593E−08 |
| (mol/min) | | | |
| Activator feed rate | 4.050E−08 | 6.096E−09 | 1.626E−08 |
| (mol/min) | | | |
| TNOA feed rate | 5.212E−06 | 5.212E−06 | 5.212E−06 |
| (mol/min) | | | |
| Yield (g/min) | 15.5 | 12.8 | 14.0 |
| Conversion (%) | 97.6% | 80.1% | 88.2% |
| Catalyst Efficiency | 349,775 | 1,912,580 | 789,816 |
| (kg polymer/kg | | | |
| catalyst) | | | |
| MFR (g/10 min) | >300 | | |
| HL MFR (g/10 min) | | | |
| Ethylene content | 11.5% | 12.4% | 11.8% |
| (FTIR) (wt %) | | | |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art. Any of the values in the tables can provide the end points for ranges that define their respective measurement or property, with an additional+/−10%.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

While the present disclosure has been described with respect to a number of embodiments and examples, those skilled in the art, having benefit of this disclosure, will appreciate that other embodiments can be devised which do not depart from the scope and spirit of the present disclosure.

1. A catalyst compound represented by Formula (I): 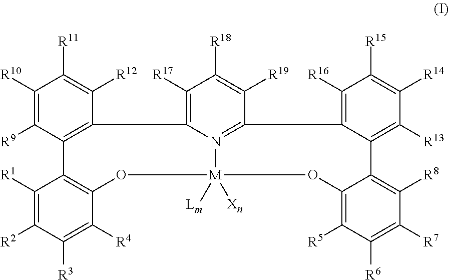
wherein:
M is a group 3, 4, or 5 metal;
L is a Lewis base;
X is an anionic ligand;
n is 1, 2, or 3;
m is 0, 1, or 2;
n+m is not greater than 4;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₄₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R¹⁵, and R¹⁶ is independently hydrogen, C₁-C₄₀ hydrocarbyl, C₁-C₄₀ substituted hydrocarbyl, a heteroatom or a heteroatom-containing group, or one or more of R¹³ and R¹⁴, R¹⁴ and R¹⁵, or R¹⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups are optionally joined together to form a bidentate Lewis base;
an X group are optionally joined to an L group to form a monoanionic bidentate group; and
any two X groups are optionally joined together to form a dianionic ligand group,
with the proviso that at least one of R¹⁷, R¹⁸, and R¹⁹ contains at least two or more saturated or unsaturated carbon atoms.

2. The catalyst compound of claim 1, wherein R¹⁸ or R¹⁹ is a C₂-C₄₀ hydrocarbyl, C₂-C₄₀ substituted hydrocarbyl, or a C₂-C₄₀ heteroatom-containing group containing one or more heteroatoms.

3. The catalyst compound of claim 1, wherein R¹⁸ or R¹⁹ contains a linear chain that is at least three non-hydrogen atoms in length and terminally bound to pyridine.

4. The catalyst compound of claim 2, wherein the C₂-C₄₀ hydrocarbyl is selected from ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, tricontyl, propenyl, butenyl, pentenyl, hexenyl, heptenyl, octenyl, nonenyl, decenyl, undecenyl, dodecenyl, propynyl, butynyl, pentynyl, hexynyl, heptynyl, octynyl, nonynyl, decynyl, undecynyl, dodecynyl, and isomers thereof.

5. The catalyst compound of claim 4, wherein the C₂-C₄₀ hydrocarbyl is selected from ethyl, propyl, butyl, butenyl, hexynyl, butylphenyl, and isomers thereof.

6. The catalyst compound of claim 2, wherein the C₂-C₄₀ substituted hydrocarbyl is selected from hydrocarbylenetrihydrocarbylsilane, hydrocarbylenetrihydrocarbylgermane, (dihydrocarbylamino)hydrocarbylene, (dihydrocarbylphosphino)hydrocarbylene, (hydrocarbyloxy)hydrocarbylene, and (hydrocarbylthio)hydrocarbylene.

7. The catalyst compound of claim 6, wherein the C₂-C₄₀ substituted hydrocarbyl is selected from methylenedimethylbutylsilane, methylenetriethylsilane, methylenetrihexylsilane, (dipropylamino)methylene, 1,5-diazabicyclo[3.2.1]octan-8-yl, 4-methyl-2,6,7-trioxabicyclo[2.2.2]octan-1-yl, (tolyloxy)methylene, and isomers thereof.

8. The catalyst compound of claim 2, wherein the C₂-C₄₀ heteroatom-containing group containing one or more heteroatoms is selected from hydrocarbyloxy, hydrocarbylthio, trihydrocarbylsilyl, trihydrocarbylgermyl, dihydrocarbylamino and dihydrocarbylphosphino.

9. The catalyst compound of claim 8, wherein the C₂-C₄₀ heteroatom-containing group containing one or more heteroatoms is selected from ethylthio, butylthio, dodeceylthio, ethoxy, butoxy, phenoxy-4-(2,4,4-trimethylpentan-2-yl), (1R,2S,5R)-2-isopropyl-5-methylcyclohexan-1-oxy, pyrrolidinyl, dimethylbutylsilyl, and isomers thereof.

10. The catalyst compound of claim 1, where in R⁴ and R⁵ are adamantanyl or substituted adamantanyl.

11. The catalyst compound of claim 1, wherein R⁴ and R⁵ are adamantanyl or substituted adamantanyl, R¹⁸ contains a silyl or germyl group of the formula A(R^{a})(R^{b})(R^{c}), where A is Si or Ge and each of R^{a}, R^{b}, and R^{c} is independently C₁-C₄₀ hydrocarbyl or C₁-C₄₀ substituted hydrocarbyl, or one or more of R^{a} and R^{b}, R^{a} and R^{c}, or R^{b} and R^{c} may be joined to form one or more substituted hydrocarbyl rings or unsubstituted hydrocarbyl rings.

12. The catalyst compound of claim 1, wherein the catalyst compound is one of the following:

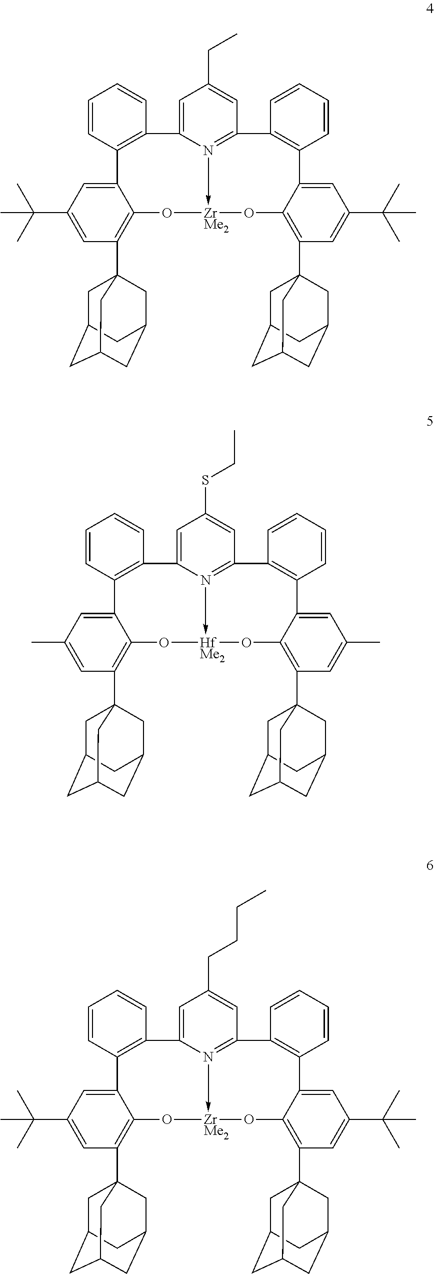

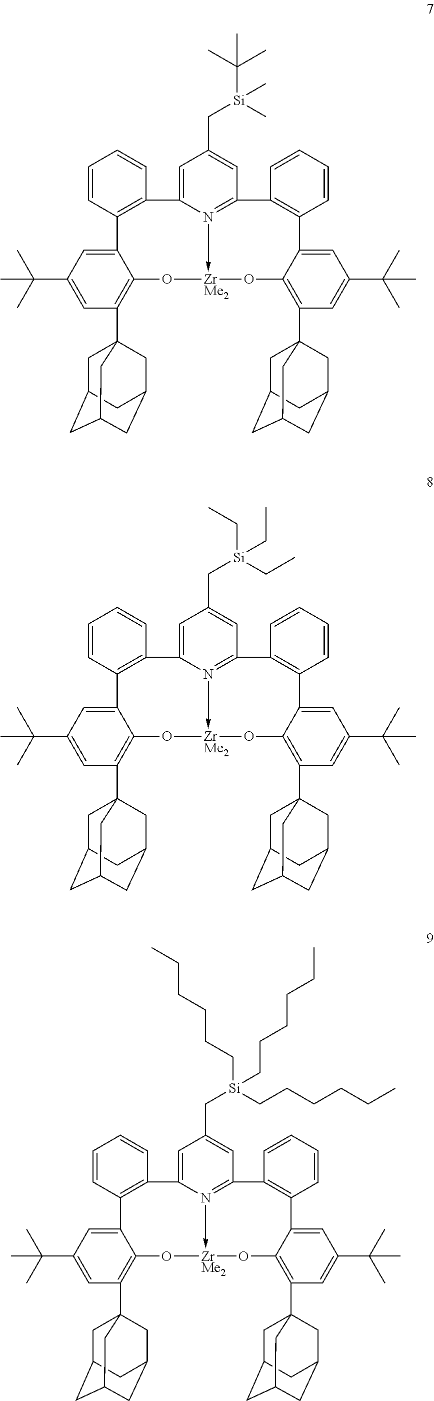

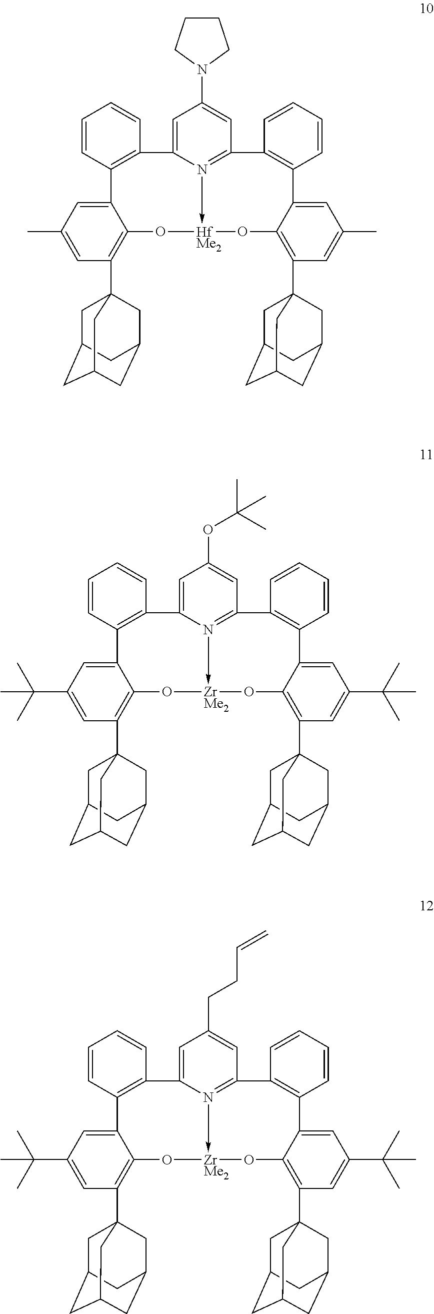

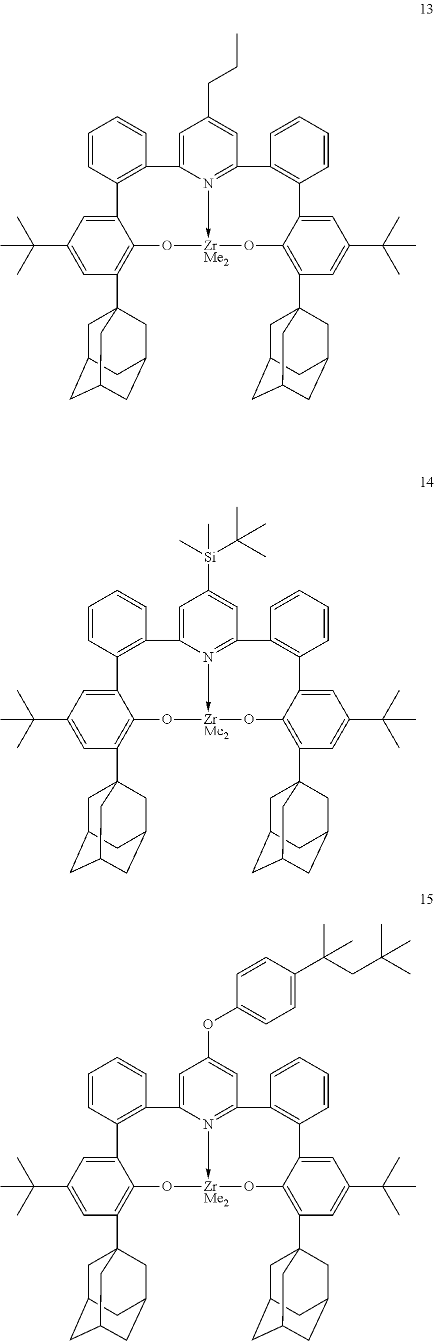

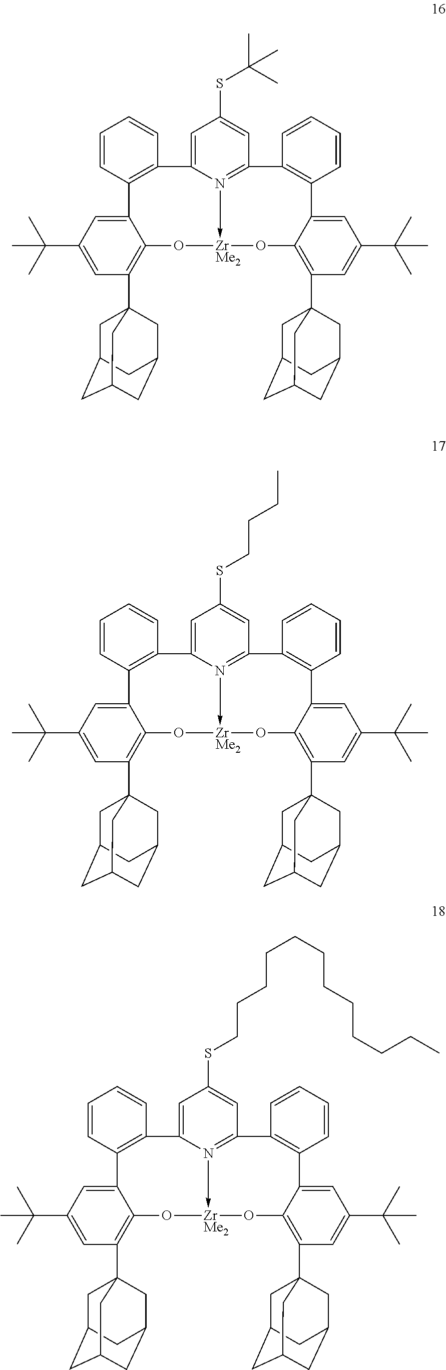

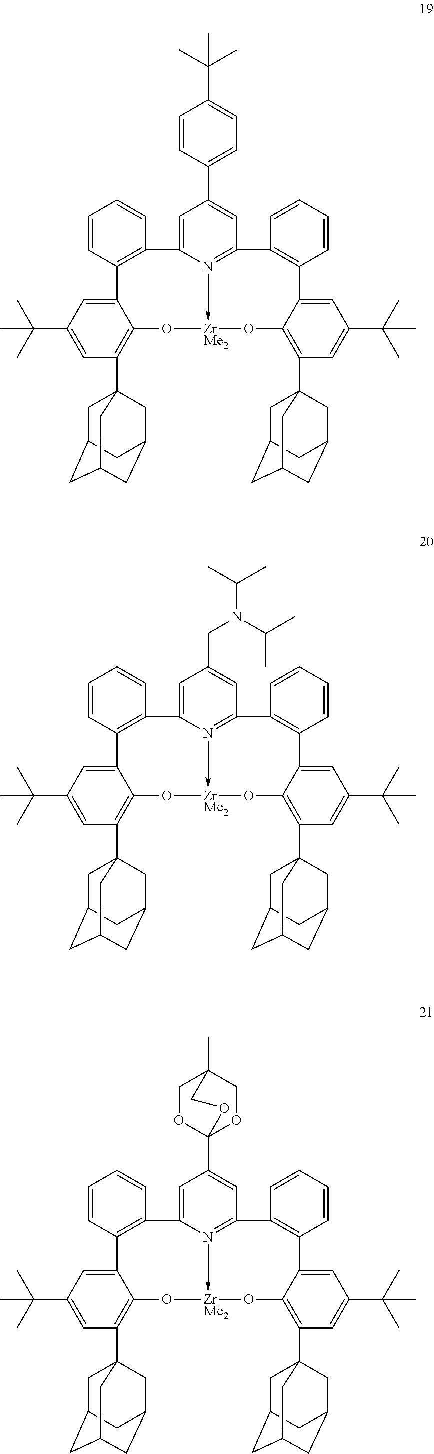

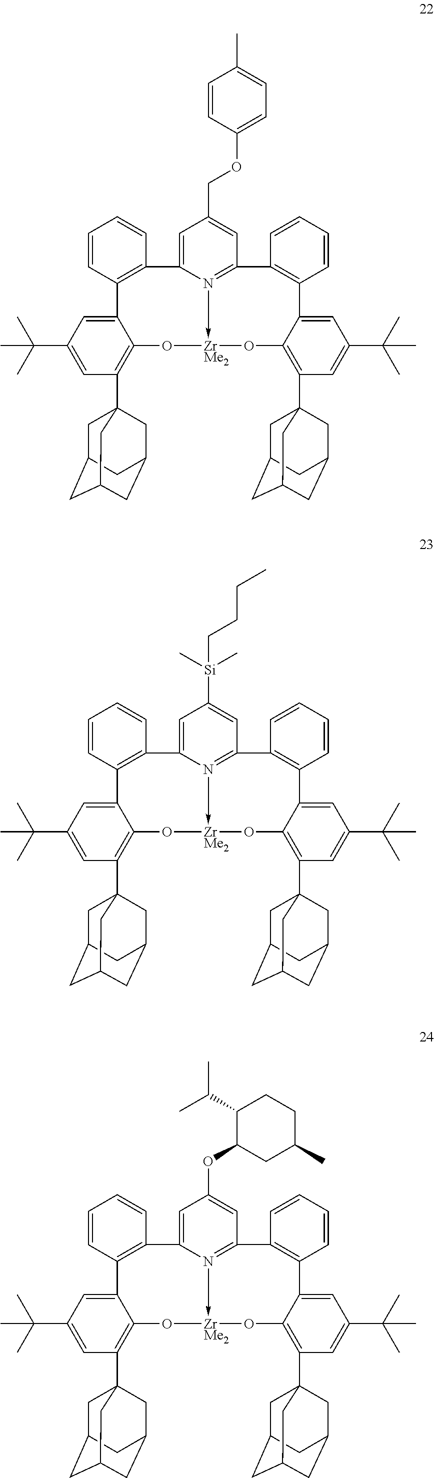

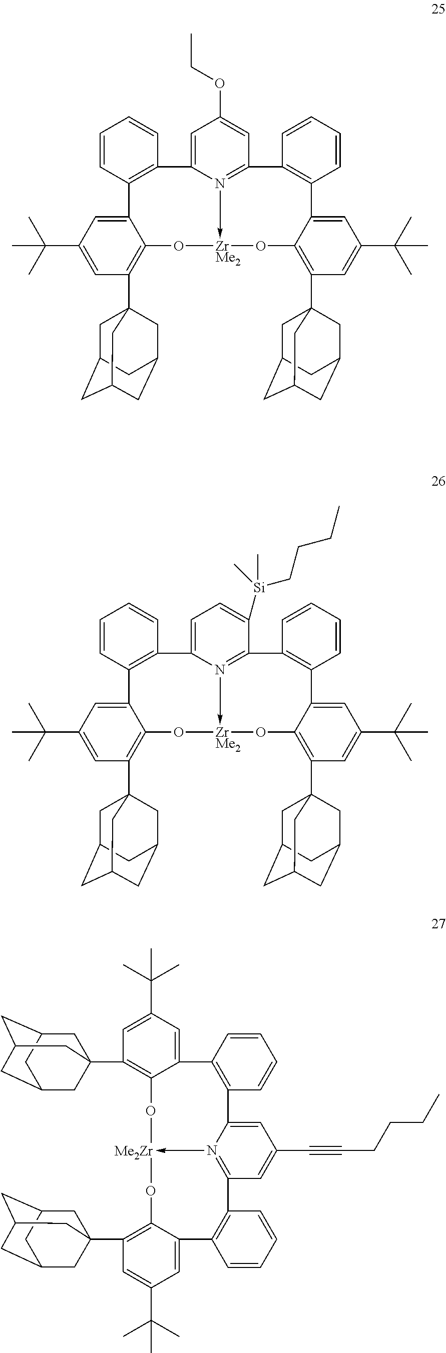

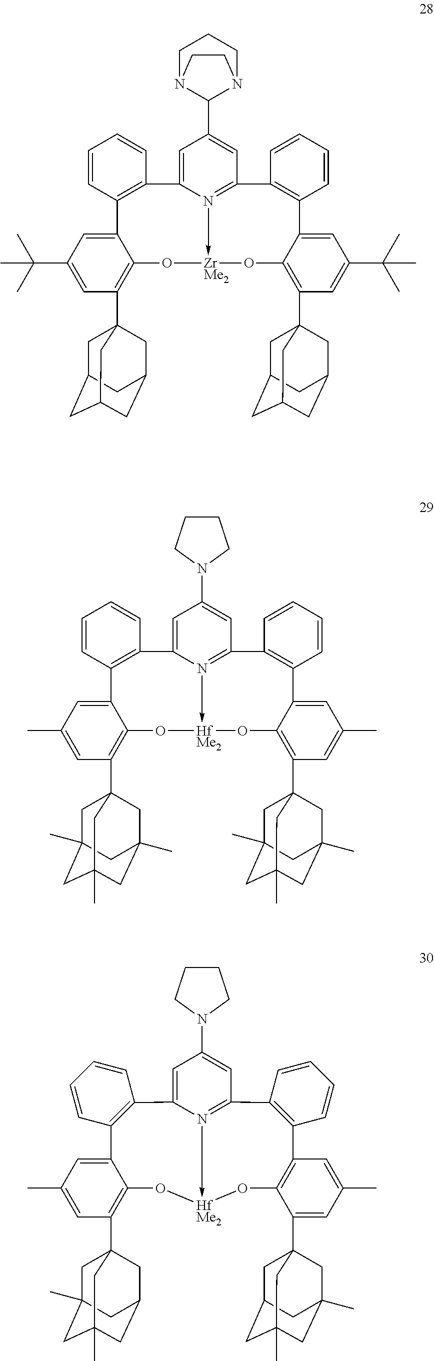

13. A catalyst system comprising an activator, and optionally a support material, and the catalyst compound of claim 1.

14. A homogeneous solution, comprising:
an aliphatic hydrocarbon solvent; and
at least one catalyst compound of claim 1 with a concentration of the at least one catalyst compound being 0.20 wt % or.

15. The homogeneous solution of claim 14, wherein the aliphatic hydrocarbon solvent is isohexane, cyclohexane, methylcyclohexane, pentane, isopentane, heptane, an isoparaffin solvent, a non-aromatic cyclic solvent, or combinations thereof.

16. A process for the production of a propylene or ethylene based polymer or copolymer, comprising: polymerizing propylene, ethylene, or ethylene and 1-octene by contacting the propylene, the ethylene, or the ethylene and 1-octene with a catalyst system of claim 13, in one or more continuous stirred tank reactors or loop reactors, in series or in parallel, at a reactor pressure of from 0.05 MPa to 1,500 MPa and a reactor temperature of from 30° C. to 230° C. to form the propylene or ethylene based polymer or copolymer.

17. The process of claim 16, wherein the catalyst system and the activator are fed into the reactor(s) separately.

18. The process of claim 16, wherein the catalyst system and the activator are pre-mixed prior to being fed into the reactor(s).
